(19) United States
(12) Patent Application Publication
(10) Pub. No.: US 2016/0234498 A1
(43) Pub. Date: Aug. 11, 2016

(54) METHODS AND SYSTEMS FOR PALETTE TABLE CODING

(71) Applicant: Sharp Laboratories of America, Inc., Camas, WA (US)

(72) Inventors: Kiran Mukesh Misra, Camas, WA (US); Sachin G. Deshpande, Camas, WA (US); Seung-Hwan Kim, Vancouver, WA (US); Christopher Andrew Segall, Vancouver, WA (US)

(21) Appl. No.: 15/016,145

(22) Filed: Feb. 4, 2016

Related U.S. Application Data
(60) Provisional application No. 62/112,601, filed on Feb. 5, 2015.
(60) Provisional application No. 62/141,770, filed on Apr. 1, 2015.

(51) Int. Cl. H04N 19/13; H04N 19/93; H04N 19/50; H04N 19/70; H04N 19/91; H04N 19/186; H04N 19/176; H04N 19/46

(52) U.S. Cl. CPC H04N 19/13; H04N 19/176; H04N 19/93; H04N 19/46; H04N 19/70; H04N 19/91; H04N 19/186; H04N 19/50

(57) ABSTRACT

Apparatuses, methods and storage medium associated with palette table coding are disclosed herein. In embodiments, an apparatus may include one or more processors, devices, mod/or circuitry to decode palette escape value present flag, to decode palette predictor initializer values, to decode palette predictor initializer present flag to decode a conforming bitstream, to decode palette predictor initializer present flag, or the like, or combinations thereof.

### CROSS REFERENCE TO RELATED APPLICATIONS

This application claims priority to U.S. Provisional Application No. 62/112,601, filed Feb. 5, 2015 and U.S. Provisional Application No. 62/141,770, filed Apr. 1, 2015, the entire disclosures of which are incorporated herein by reference.

### BACKGROUND OF THE INVENTION

The present invention relates to video encoding and/or decoding.

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and/or displaying digital media. For example, portable electronic devices now allow for digital media to be produced and/or consumed at almost any location where a consumer may be. Furthermore, some electronic devices may provide download or streaming of digital media content for the use and enjoyment of a consumer.

Digital video is typically represented as a series of images or frames, each of which contains an array of pixels. Each pixel includes information, such as intensity and/or color information. In many cases, each pixel is represented as a set of three colors, each of which is defined by eight bit color values.

Some video coding techniques provide higher coding efficiency at the expense of increasing complexity. Increasing image quality requirements and increasing image resolution requirements for video coding techniques also increase the coding complexity. Video decoders that are suitable for parallel decoding may improve the speed of the decoding process and reduce memory requirements; video encoders that are suitable for parallel encoding may improve the speed of the encoding process and reduce memory requirements.

The increasing popularity of digital media has presented several problems. For example, efficiently representing high-quality digital media for storage, transmittal, and playback presents several challenges. Systems and methods that represent digital media more efficiently is beneficial.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block diagram illustrating one configuration of an electronic device including a HEVC encoder.

FIG. 2 is a block diagram illustrating one configuration of an electronic device including a HEVC, decoder.

FIG. 3 is a block diagram illustrating one example of a coder and a decoder.

FIG. 4 illustrates various components that may be utilized in an electronic device.

FIG. 5 illustrates an exemplary slice structure.

FIG. 6 illustrates another exemplary slice structure.

FIG. 7 illustrates a frame with a slice and 9 tiles.

FIG. 8 illustrates a frame with three slices and 3 tiles.

FIG. 9 illustrates a screen with content thereon.

FIG. 10 illustrates another computing environment.

FIG. 11 illustrates a palette table.

FIG. 12 illustrates a palette table and a set of flags.

FIG. 13 illustrates a previous palette table, a predicted palette table, and an updated palette table.

FIG. 14 illustrates a selection process for escape mode, index mode, and copy above mode.

FIG. 15 illustrates a set of tiles, coding units, and prediction of palette tables.

FIG. 16 illustrates a set of slices, coding units, and prediction of palette tables.

FIG. 17 illustrates a set of wavefronts, coded tree blocks, and prediction of palette tables.

FIG. 18 illustrates a set of dependent slices and prediction of palette tables.

FIG. 19 illustrates a set of coding units and prediction of palette tables.

FIG. 20A illustrates an exemplary palette table prediction process.

FIG. 20B illustrates an example where previous palette table and current palette table predictor may use the same storage.

FIG. 21 illustrates an example where a part of palette table predictor is stored and used for synchronization.

FIG. 22 illustrates an example where palette table size is zero, the decoder infers that all the samples are escape mode coded and sets to 1 the value of flag indicating presence of samples coded in escape mode.

FIG. 23 illustrates an example where the palette table maximum size is checked.

FIG. 24 illustrates an example where the maximum palette table allowed size is checked.

FIG. 25 illustrates example subsets of: start of slice, start of tile, start of wavefront, and start of dependent slice.

FIG. 26 illustrates an example where the presence of a palette predictor initializer in a bitstream is checked.

FIG. 27 illustrates an example for decoding palette escape value present flag.

FIG. 28 illustrates an example for decoding palette predictor initializer values.

FIG. 29 illustrates an example for decoding palette predictor initializer present flag.

FIG. 30 illustrates an example for decoding a conforming bitstream.

FIG. 31 illustrates another example for decoding palette predictor initializer present flag.

### DETAILED DESCRIPTION OF EXAMPLE

The Joint Collaborative Team on Video Coding (JCT-VC) of the International Telecommunication Union Telecommunication Standardization Sector (ITU-T) Study Group 16 (SG16) Working Party 3 (WP3) and International Organization for Standardization/International Electrotechnical Commission (ISO/IEC) Joint Technical Committee 1/Subcommittee 29/Working Group 11 (JTC1/SC29/WG11) has launched a standardization effort for a video coding standard called the High Efficiency Video Coding standard (HEVC). HEVC uses block-based coding.

In video coding, two entropy coding techniques (e.g., Context-Adaptive Variable Length Coding (CAVLC) and Context-Adaptive Binary Arithmetic Coding (CABAC)) may be used to compress Transformed and Quantized Coefficients (TQCs) without loss. TQCs may be from different block sizes according to transform sizes (e.g., 4×4, 8×8, 16×16, 32×32).

Two-dimensional (21)) TQCs may be converted into a one-dimensional (1D) array before entropy coding. In one example, 2D arrayed TQCs in a 4×4 block may be arranged as illustrated in Table (1).

TABLE (1)

| | | | |
|---|---|---|---|
| 4 | 0 | 1 | 0 |
| 3 | 2 | −1 | . . . |
| −3 | 0 | . . . | . . . |
| 0 | . . . | . . . | . . . |

When converting the 2D TQCs into a 1D array, the block may be scanned in a diagonal zig-zag fashion. Continuing with the example, the 21) arrayed TQCs illustrated in Table (1) may be converted into 1D arrayed TQCs [4, 0, 3, −3, 2, 1, 0, −1, 0, . . . ] by scanning the first row and first column, first row and second column, second row and first column, third row and first column, second row and second column, first row and third column, first row and fourth column, second row and third column, third row and second column, fourth row and first column and so on.

The CAVLC coding procedure may proceed, for example, as follows. The TQCs in the 1D array may be ordered according to scanning position. The scanning position of the last significant coefficient and the last coefficient level may be determined. The last significant coefficient may be coded. It should be noted that coefficients are typically coded in reverse scanning order. Run-level coding may be performed, which is activated directly after the last coefficient coding. Then, level coding may be performed. The term significant coefficient refers to a coefficient that has a coefficient level value that is greater than zero. A coefficient level value refers to a unique indicator of the magnitude (or absolute value) of a Transformed and Quantized Coefficient (TQC) value.

This procedure may be illustrated in Table (2) as a continuation of the example above (with the 1D arrayed TQCs [4, 0, 3, −3, 2, 1, 0, −1, 0, . . . ]).

TABLE (2)

| | Scanning Position | | | | | | | | |
|---|---|---|---|---|---|---|---|---|---|
| | 0 | 1 | 2 | 3 | 4 | 5 | 6 | 7 | . . . |
| Coefficient Level | 4 | 0 | 3 | −3 | 2 | 1 | 0 | −1 | . . . |
| Last Position | | | | | | | | 7 | |
| Last Coefficient Level | | | | | | | | −1 | |
| Run-Level Coding | | | | | 2 | 1 | 0 | | |
| Level Coding | 4 | 0 | 3 | −3 | | | | | |

In Table (2), for example, the coefficient level −1 at scanning position 7 may be the last non-zero coefficient. Thus, the last position is scanning position 7 and the last coefficient level is −1. Run-level coding may be performed for coefficients 0, 1 and 2 at scanning positions 6, 5 and 4 (where coefficients are coded in reverse scanning order). Then, level coding may be performed for the coefficient levels −3, 3, 0 and 4.

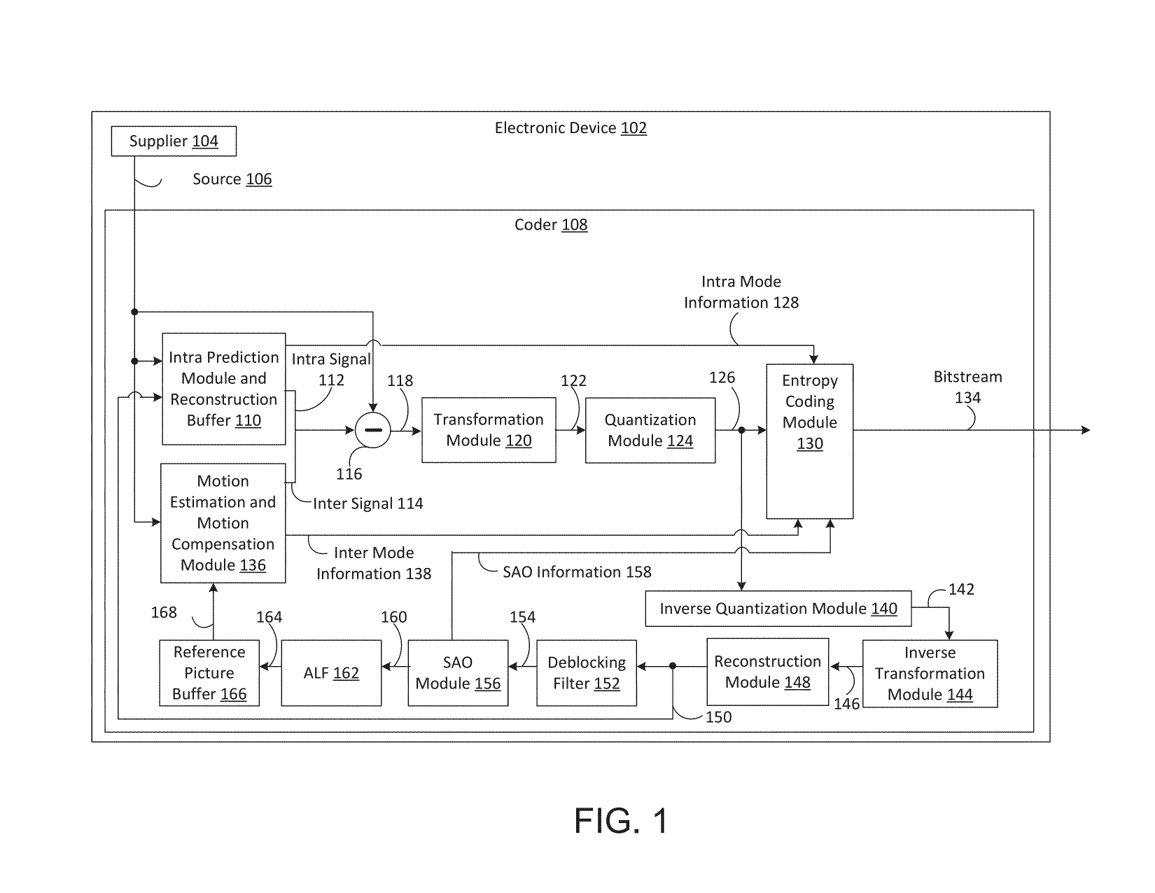

FIG. 1 is a block diagram illustrating one configuration of an electronic device 102 in which video may be coded. It should be noted that one or more of the elements illustrated as included within the electronic device 102 may be implemented in hardware, software or a combination of both. For example, the electronic device 102 includes a coder 108, which may be implemented in hardware, software or a combination of both. For instance, the coder 108 may be implemented as a circuit, integrated circuit, application-specific integrated circuit (ASIC), processor in electronic communication with memory with executable instructions, firmware, field-programmable gate array (FPGA), etc., or a combination thereof. In some configurations, the coder 108 may be a high efficiency video coding (HEVC) coder.

The electronic device 102 may include a supplier 104. The supplier 104 may provide picture or image data (e.g., video) as a source 106 to the coder 108. Examples of the supplier 104 include image sensors, memory, communication interfaces, network interfaces, wireless receivers, ports, etc.

The source 106 may be provided to an intra-frame prediction module and reconstruction buffer 110. The source 106 may also be provided to a motion estimation and motion compensation module 136 and to a subtraction module 116.

The intra-frame prediction module and reconstruction buffer 110 may generate intra mode information 128 and an intra signal 112 based on the source 106 and reconstructed data 150. The motion estimation and motion compensation module 136 may generate inter mode information 138 and an inter signal 114 based on the source 106 and a reference picture buffer 166 signal 168. The reference picture buffer 166 signal 168 may include data from one or more reference pictures stored in the reference picture buffer 166.

The coder 108 may select between the intra signal 112 and the inter signal 114 in accordance with a mode. The intra signal 112 may be used in order to exploit spatial characteristics within a picture in an intra coding mode. The inter signal 114 may be used in order to exploit temporal characteristics between pictures in an inter coding mode. While in the intra coding mode, the intra signal 112 may be provided to the subtraction module 116 and the intra mode information 128 may be provided to an entropy coding module 130. While in the inter coding mode, the inter signal 114 may be provided to the subtraction module 116 and the inter mode information 138 may be provided to the entropy coding module 130.

Either the intra signal 112 or the inter signal 114 (depending on the mode) is subtracted from the source 106 at the subtraction module 116 in order to produce a prediction residual 118. The prediction residual 118 is provided to a transformation module 120. The transformation module 120 may compress the prediction residual 118 to produce a transformed signal 122 that is provided to a quantization module 124. The quantization module 124 quantizes the transformed signal 122 to produce transformed and quantized coefficients (TQCs) 126.

The TQCs 126 are provided to an entropy coding module 130 and an inverse quantization module 140. The inverse quantization module 140 performs inverse quantization on the TQCs 126 to produce an inverse quantized signal 142 that is provided to an inverse transformation module 144. The inverse transformation module 144 decompresses the inverse quantized signal 142 to produce a decompressed signal 146 that is provided to a reconstruction module 148.

The reconstruction module 148 may produce reconstructed data 150 based on the decompressed signal 146. For example, the reconstruction module 148 may reconstruct (modified) pictures. The reconstructed data 150 may be provided to a deblocking filter 152 and to the intra prediction module and reconstruction buffer 110. The deblocking filter 152 may produce a filtered signal 154 based on the reconstructed data 150.

The filtered signal 154 may be provided to a sample adaptive offset (SAO) module 156. The SAO module 156 may produce SAO information 158 that is provided to the entropy coding module 130 and an SAO signal 160 that is provided to an adaptive loop filter (ALF) 162. The ALF 162 produces an ALF signal 164 that is provided to the reference picture buffer 166. The ALF signal 164 may include data from one or more pictures that may be used as reference pictures. In sonic cases the ALF 162 may be omitted.

The entropy coding module 130 may code the TQCs 126 to produce a bitstream 134. As described above, the TQCs 126 may be converted to a 1D array before entropy coding. Also, the entropy coding module 130 may code the TQCs 126 using CAVLC or CABAC. In particular, the entropy coding module 130 may code the TQCs 126 based on one or more of intra mode information 128, inter mode information 138 and SAO information 158. The bitstream 134 may include coded picture data.

Quantization, involved in video compression such as HEVC, is a lossy compression technique achieved by compressing a range of values to a single quantum value. The quantization parameter (QP) is a predefined scaling parameter used to perform the quantization based on both the quality of reconstructed video and compression ratio. The block type is defined in HEVC to represent the characteristics of a given block based on the block size and its color information. QP, resolution information and block type may be determined before entropy coding. For example, the electronic device 102 (e.g., the coder 108) may determine the QP, resolution information and block type, which may be provided to the entropy coding module 130.

The entropy coding module 130 may determine the block size based on a block of TQCs 126. For example, block size may be the number of TQCs 126 along one dimension of the block of TQCs. In other words, the number of TQCs 126 in the block of TQCs may be equal to block size squared. For instance, block size may be determined as the square root of the number of TQCs 126 in the block of TQCs. Resolution may be defined as a pixel width by a pixel height. Resolution information may include a number of pixels for the width of a picture, for the height of a picture or both. Block size may be defined as the number of TQCs along one dimension of a 2D block of TQCs.

In some configurations, the bitstream 134 may be transmitted to another electronic device. For example, the bitstream 134 may be provided to a communication interface, network interface, wireless transmitter, port, etc. For instance, the bitstream 134 may be transmitted to another electronic device via a Local Area Network (LAN), the Internet, a cellular phone base station, etc. The bitstream 134 may additionally or alternatively be stored in memory on the electronic device 102.

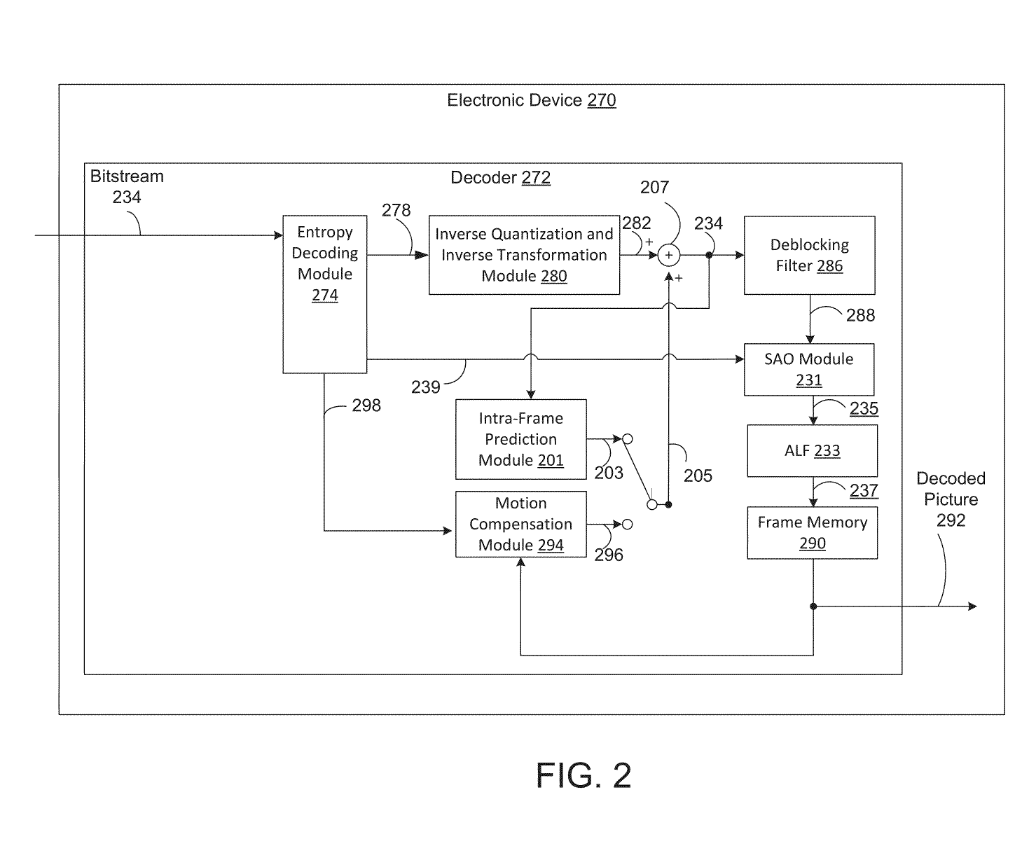

FIG. 2 is a block diagram illustrating one configuration of an electronic device 270 including a decoder 272 that may be a high-efficiency video coding (HEVC) decoder. The decoder 272 and one or more of the elements illustrated as included in the decoder 272 may be implemented in hardware, software or a combination of both. The decoder 272 may receive a bitstream 234 (e.g., one or more coded pictures included in the bitstream 234) for decoding. In some configurations, the received bitstream 234 may include received overhead information, such as a received slice header, received picture parameter set (PPS), received buffer description information, classification indicator, etc.

Received symbols (e.g., encoded TQCs) from the bitstream 234 may be entropy decoded by an entropy decoding module 274. This may produce a motion information signal 298 and decoded transformed and quantized coefficients (TQCs) 278.

The motion information signal 298 may be combined with a portion of a decoded picture 292 from a frame memory 290 at a motion compensation module 294, which may produce an inter-frame prediction signal 296. The decoded transformed and quantized coefficients (TQCs) 278 may be inverse quantized and inverse transformed by an inverse quantization and inverse transformation module 280, thereby producing a decoded residual signal 282. The decoded residual signal 282 may be added to a prediction signal 205 by a summation module 207 to produce a combined signal 284. The prediction signal 205 may be a signal selected from either the inter-frame prediction signal 296 produced by the motion compensation module 294 or an intra-frame prediction signal 203 produced by an intra-frame prediction module 201. In some configurations, this signal selection may be based on (e.g., controlled by) the bitstream 234.

The intra-frame prediction signal 203 may be predicted from previously decoded information from the combined signal 284 (in the current frame, for example). The combined signal 284 may also be filtered by a deblocking filter 286. The resulting filtered signal 288 may be provided to a sample adaptive offset (SAO) module 231. Based on the filtered signal 288 and information 239 from the entropy decoding module 274, the SAO module 231 may produce an SAO signal 235 that is provided to an adaptive loop filter (ALF) 233. The ALF 233 produces an ALF signal 237 that is provided to the frame memory 290. The ALF signal 237 may include data from one or more pictures that may be used as reference pictures. The ALF signal 237 may be written to frame memory 290. The resulting ALF signal 237 may include a decoded picture. In some cases the ALF 233 may be omitted.

The frame memory 290 may include a decoded picture buffer (DPB). The frame memory 290 may also include overhead information corresponding to the decoded pictures. For example, the frame memory 290 may include slice headers, picture parameter set (PPS) information, cycle parameters, buffer description information, etc. One or more of these pieces of information may be signaled from a coder (e.g., coder 108).

The frame memory 290 may provide one or more decoded pictures 292 to the motion compensation module 294. Furthermore, the frame memory 290 may provide one or more decoded pictures 292, which may be output from the decoder 272. The one or more decoded pictures 292 may be presented on a display, stored in memory or transmitted to another device, for example.

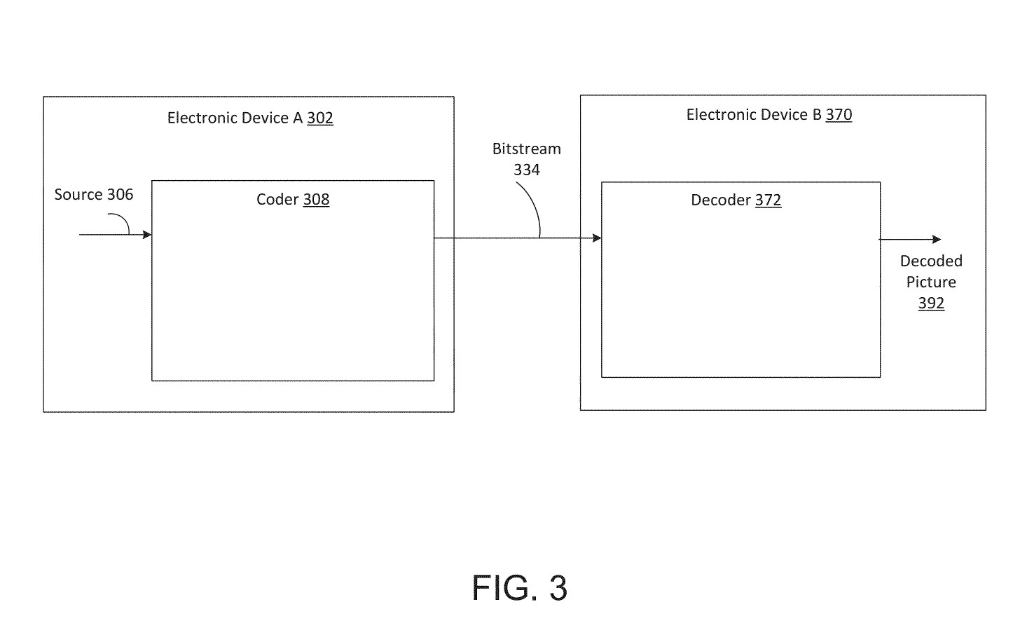

FIG. 3 is a block diagram illustrating one example of a coder 308 and a decoder 372. In this example, electronic device A 302 and electronic device B 370 are illustrated. However, it should be noted that the features and functionality described in relation to electronic device A 302 and electronic device B 370 may be combined into a single electronic device in some configurations.

Electronic device A 302 includes a coder 308. The coder 308 may be implemented in hardware, software or a combination of both. In one configuration, the coder 308 may be a high-efficiency video coding (HEVC) coder. Electronic device A 302 may obtain a source 306. In some configurations, the source 306 may be captured on electronic device A 302 using an image sensor, retrieved from memory or received from another electronic device.

The coder 308 may code the source 306 to produce a bitstream 334. For example, the coder 308 may code a series of pictures (e.g., video) in the source 306. The coder 308 may he similar to the coder 108 described above in connection with FIG. 1.

The bitstream 334 may include coded picture data based on the source 306. In some configurations, the bitstream 334 may also include overhead data, such as slice header information, PPS information, etc. As additional pictures in the source 306 are coded, the bitstream 334 may include one or more coded pictures.

The bitstream 334 may be provided to a decoder 372. In one example, the bitstream 334 may be transmitted to electronic device B 370 using a wired or wireless link. In some cases, this may be done over a network, such as the Internet or a Local Area Network (LAN). As illustrated in FIG. 3, the decoder 372 may be implemented on electronic device B 370 separately from the coder 308 on electronic device A 302. However, it should be noted that the coder 308 and decoder 372 may be implemented on the same electronic device in some configurations. In an implementation where the coder 308 and decoder 372 are implemented on the same electronic device, for instance, the bitstream 334 may be provided over a bus to the decoder 372 or stored in memory for retrieval by the decoder 372.

The decoder 372 may be implemented in hardware, software or a combination of both. In one configuration, the decoder 372 may be a high-efficiency video coding (HEVC) decoder. The decoder 372 may be similar to the decoder 272 described above in connection with FIG. 2.

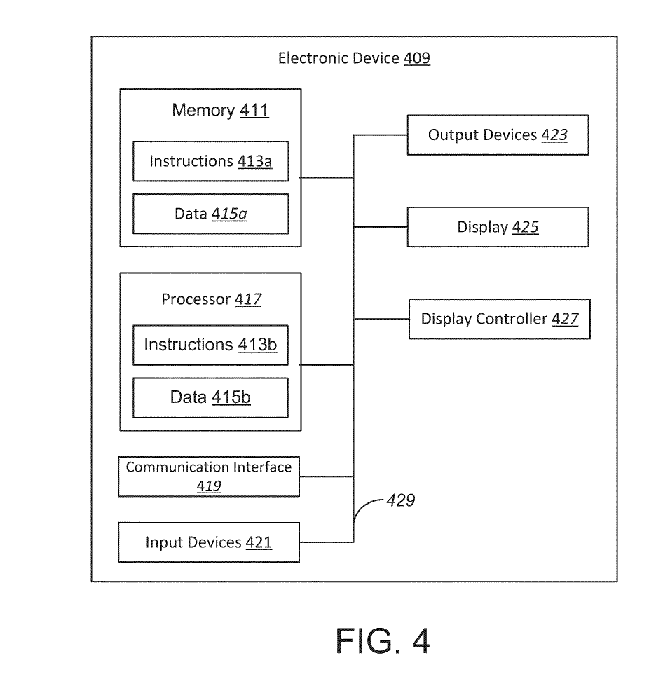

FIG. 4 illustrates various components that may be utilized in an electronic device 409. The electronic device 409 may be implemented as one or more of the electronic devices. For example, the electronic device 409 may be implemented as the electronic device 102 described above in connection with FIG. 1, as the electronic device 270 described above in connection with FIG. 2 or both.

The electronic device 409 includes a processor 417 that controls operation of the electronic device 409. The processor 417 may also be referred to as a central processing unit (CPU). Memory 411, which may include both read-only memory (ROM), random access memory (RAM) or any type of device that may store information, provides instructions 413a (e.g., executable instructions) and data 415a to the processor 417. A portion of the memory 411 may also include non-volatile random access memory (NVRAM). The memory 411 may be in electronic communication with the processor 417.

Instructions 413b and data 413b may also reside in the processor 417. Instructions 413b and/or data 413b loaded into the processor 417 may also include instructions 413a and/or data 415a from memory 411 that were loaded for execution or processing by the processor 417. The instructions 413b may be executed by the processor 417 to implement one or more techniques disclosed herein.

The electronic device 409 may include one or more communication interfaces 419 for communicating with other electronic devices. The communication interfaces 419 may be based on wired communication technology, wireless communication technology, or both. Examples of communication interfaces 419 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 409 may include one or more output devices 423 and one or more input devices 421. Examples of output devices 423 include a speaker, printer, etc. One type of output device that may be included in an electronic device 409 is a display device 425. Display devices 425 used with configurations disclosed herein may utilize any suitable image projection technology, such as a cathode ray tube (CRT), liquid crystal display (LCD), light-emitting diode (LED), gas plasma, electroluminescence or the like. A display controller 427 may be provided for converting data stored in the memory 411 into text, graphics, and/or moving images (as appropriate) shown on the display device 425. Examples of input devices 421 include a keyboard, mouse, microphone, remote control device, button, joystick, trackball, touchpad, touchscreen, light pen, etc.

The various components of the electronic device 409 are coupled together by a bus system 429, which may include a power bus, a control signal bus and a status signal bus, in addition to a data bus. However, for the sake of clarity, the various buses are illustrated in FIG. 4 as the bus system 429. The electronic device 409 illustrated in FIG. 4 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. The code for the decoder and/or encoder may be stored on a computer readable medium.

coding block: An N×N block of samples for some value of N such that the division of a coding tree block into coding blocks is a partitioning.

coding tree block: An N×N block of samples for some value of N such that the division of a component into coding tree blocks is a partitioning.

coding tree unit: A coding tree block of luma samples, two corresponding coding tree blocks of chroma samples of a picture that has three sample arrays, or a coding tree block of samples of a monochrome picture or a picture that is coded using three separate colour planes and syntax structures used to code the samples.

coding unit: A coding block of luma samples, two corresponding coding blocks of chroma samples of a picture that has three sample arrays, or a coding block of samples of a monochrome picture or a picture that is coded using three separate colour planes and syntax structures used to code the samples.

component: An array or single sample from one of the three arrays (luma and two chroma) that compose a picture in 4:2:0, 4:2:2, or 4:4:4 colour format or the array or a single sample of the array that compose a picture in monochrome format.

network abstraction layer (NAL) unit: A syntax structure containing an indication of the type of data to follow and bytes containing that data in the form of a raw byte sequence payload (RBSP) interspersed as necessary with emulation prevention bytes.

network abstraction layer (NAL) unit stream: A sequence of NAL units.

picture: An array of luma samples in monochrome format or an array of luma samples and two corresponding arrays of chroma samples in 4:2:0, 4:2:2, and 4:4:4 colour format. A picture may be either a frame or a field. However, in one CVS, either all pictures are frames or all pictures are fields.

picture parameter set (PPS): A syntax structure containing syntax elements that apply to zero or more entire coded pictures as determined by a syntax element found in each slice segment header.

prediction block: A rectangular M×N block of samples on which the same prediction is applied.

prediction process: The use of a predictor to provide an estimate of the data element (e.g. sample value or motion vector) currently being decoded.

prediction unit: A prediction block of luma samples, two corresponding prediction blocks of chroma samples of a picture that has three sample arrays, or a prediction block of samples of a monochrome picture or a picture that is coded using three separate colour planes and syntax structures used to predict the prediction block samples.

predictor: A combination of specified values or previously decoded data elements (e.g. sample value or motion vector) used in the decoding process of subsequent data elements.

quadtree: A tree in which a parent node can be split into four child nodes, each of which may become parent node for another split into four child nodes.

quantization parameter: A variable used by the decoding process for scaling of transform coefficient levels.

raster scan: A mapping of a rectangular two-dimensional pattern to a one-dimensional pattern such that the first entries in the one-dimensional pattern are from the first top row of the two-dimensional pattern scanned from left to right, followed similarly by the second, third, etc., rows of the pattern (going down) each scanned from left to right.

scaling: The process of multiplying transform coefficient levels by a factor, resulting in transform coefficients.

sequence parameter set (SPS): A syntax structure containing syntax elements that apply to zero or more entire CVSs as determined by the content of a syntax element found in the PPS referred to by a syntax element found in each slice segment header.

slice header: The slice segment header of the independent slice segment that is a current slice segment or the most recent independent slice segment that precedes a current dependent slice segment in decoding order.

slice segment: An integer number of coding tree units ordered consecutively in the tile scan and contained in a single NAL unit.

slice segment header: A part of a coded slice segment containing the data elements pertaining to the first or all coding tree units represented in the slice segment.

tile scan: A specific sequential ordering of coding tree blocks partitioning a picture in which the coding tree blocks are ordered consecutively in coding tree block raster scan in a tile whereas tiles in a picture are ordered consecutively in a raster scan of the tiles of the picture.

transform block: A rectangular M×N block of samples on which the same transform is applied.

transform coefficient: A scalar quantity, considered to be in a frequency domain, that is associated with a particular one-dimensional or two-dimensional frequency index in an inverse transform part of the decoding process.

transform coefficient level: An integer quantity representing the value associated with a particular two-dimensional frequency index in the decoding process prior to scaling for computation of a transform coefficient value.

transform unit: A transform block of luma samples of size 8×8, 16×16, or 32×32 or four transform blocks of luma samples of size 4×4, two corresponding transform blocks of chroma samples of a picture in 4:2:0 colour format; or a transform block of luma samples of size 8×8, 16×16, or 32×32, and four corresponding transform blocks of chroma samples, or four transform blocks of luma samples of size 4×4, and four corresponding transform blocks of chroma samples of a picture in 4:2:2 colour format; or a transform block of luma samples of size 4×4, 8×8, 16×16, or 32×32, and two corresponding transform blocks of chroma samples of a picture in 4:4:4 colour format that is not coded using three separate colour planes and syntax structures used to transform the transform block samples; or a transform block of luma samples of size 8×8, 16×16, or 32×32 or four transform blocks of luma samples of size 4×4 of a monochrome picture or a picture in 4:4:4 colour format that is coded using three separate colour planes; and associated syntax structures used to transform the transform block samples.

z-scan order: A specified sequential ordering of blocks partitioning a picture, where the order is identical to coding tree block raster scan of the picture when the blocks are of the same size as coding tree blocks, and, when the blocks are of a smaller size than coding tree blocks, i.e. coding tree blocks are further partitioned into smaller coding blocks, the order traverses from coding tree block to coding tree block in coding tree block raster scan of the picture, and inside each coding tree block, which may be divided into quadtrees hierarchically to lower levels, the order traverses from quadtree to quadtree of a particular level in quadtree-of-the-particular-level raster scan of the quadtree of the immediately higher level. An input picture comprising a plurality of coded tree blocks (e.g., generally referred to herein as blocks) may be partitioned into one or several slices. The values of the samples in the area of the picture that a slice represents may be properly decoded without the use of data from other slices provided that the reference pictures used at the encoder and the decoder are the same and that de-blocking filtering does not use information across slice boundaries. Therefore, entropy decoding and block reconstruction for a slice does not depend on other slices. In particular, the entropy coding state may be reset at the start of each slice. The data in other slices may be marked as unavailable when defining neighborhood availability for both entropy decoding and reconstruction. The slices may be entropy decoded and reconstructed in parallel. In an example, no intra prediction and motion-vector prediction is allowed across the boundary of a slice. In contrast, de-blocking filtering may use information across slice boundaries.

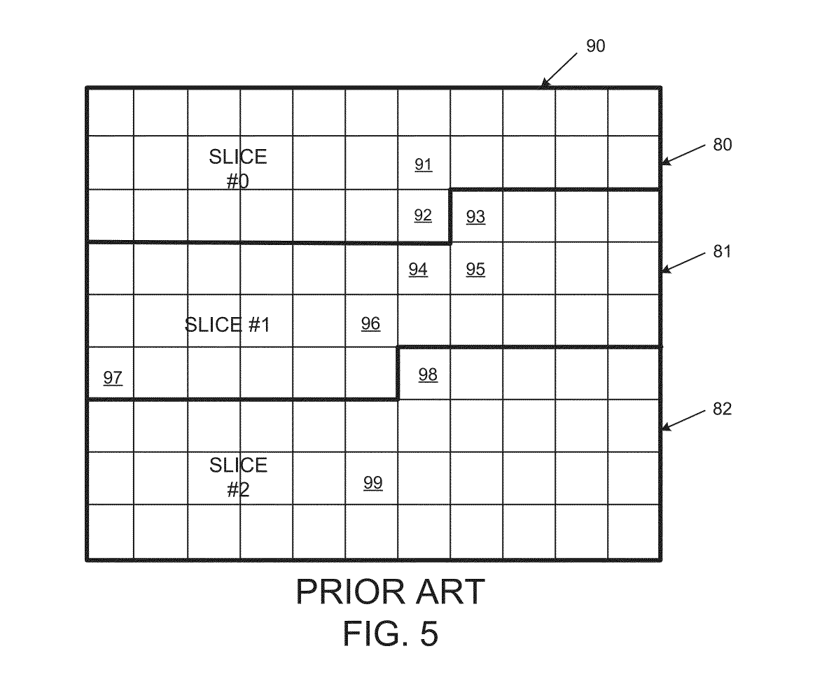

FIG. 5 illustrates an exemplary video picture 90 comprising eleven blocks in the horizontal direction and nine blocks in the vertical direction (nine exemplary blocks labeled 91-99). FIG. 5 illustrates three exemplary slices: a first slice denoted “SLICE 40” 80, a second slice denoted “SLICE #1” 81 and a third slice denoted “SLICE 42” 82. The decoder may decode and reconstruct the three slices 80, 81, 82 in parallel. Each of the slices may be transmitted in scan line order in a sequential manner. At the beginning of the decoding and/or reconstruction process for each slice, context models are initialized or reset and blocks in other slices are marked as unavailable for both entropy decoding and block reconstruction. The context model generally represents the state of the entropy encoder and/or decoder. Thus, for a block, for example, the block labeled 93, in “SLICE #1,” blocks (for example, blocks labeled 91 and 92) in “SLICE #0” may not be used for context model selection or reconstruction. Whereas, for a block, for example, the block labeled 95, in “SLICE 41,” other blocks (for example, blocks labeled 93 and 94) in “SLICE #1” may be used for context model selection or reconstruction. Therefore, entropy decoding and block reconstruction proceeds serially within a slice. Unless slices are defined using a flexible block ordering (FMO), blocks within a slice are processed in the order of a raster scan.

Flexible block ordering defines a slice group to modify how a picture is partitioned into slices. The blocks in a slice group are defined by a block-to-slice-group map, which is signaled by the content of the picture parameter set and additional information in the slice headers. The block-to-slice-group map consists of a slice-group identification number for each block in the picture. The slice-group identification number specifies to which slice group the associated block belongs. Each slice group may be partitioned into one or more slices, wherein a slice is a sequence of blocks within the same slice group that is processed in the order of a raster scan within the set of blocks of a particular slice group. Entropy decoding and block reconstruction proceeds serially within a slice group.

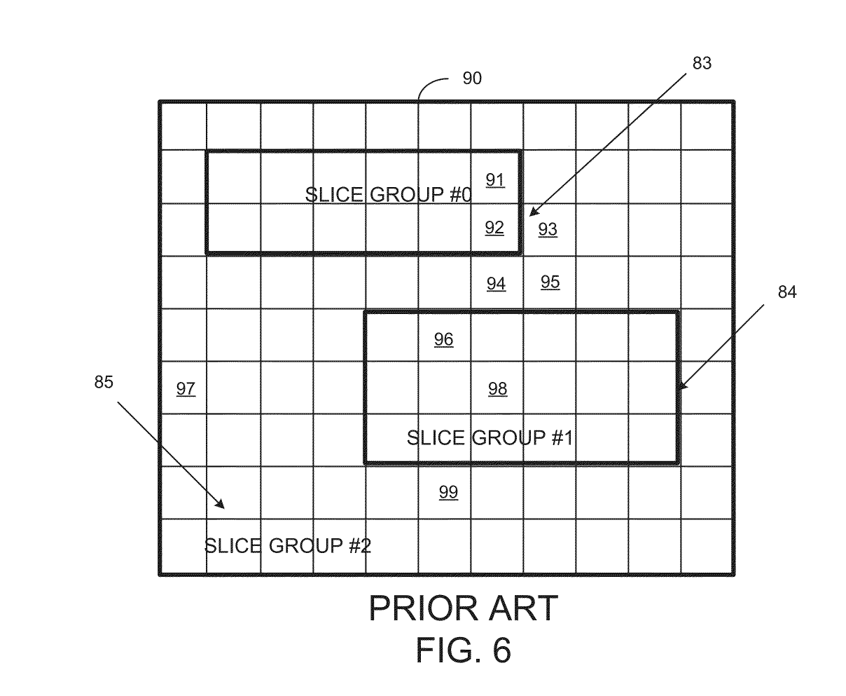

FIG. 6 depicts an exemplary block allocation into three slice groups: a first slice group denoted “SLICE GROUP #0” 83, a second slice group denoted “SLICE GROUP #1” 84 and a third slice group denoted “SLICE GROUP 42” 85. These slice groups 83, 84, 85 may be associated with two foreground regions and a background region, respectively, in the picture 90.

The arrangement of slices, as illustrated in FIG. 5, may be limited to defining each slice between a pair of blocks in the image scan order, also known as raster scan or a raster scan order. This arrangement of scan order slices is computationally efficient but does not tend to lend itself to the highly efficient parallel encoding and decoding. Moreover, this scan order definition of slices also does not tend to group smaller localized regions of the image together that are likely to have common characteristics highly suitable for coding efficiency. The arrangement of slices, as illustrated in FIG. 6, is highly flexible in its arrangement but does not tend to lend itself to high efficient parallel encoding or decoding. Moreover, this highly flexible definition of slices is computationally complex to implement in a decoder.

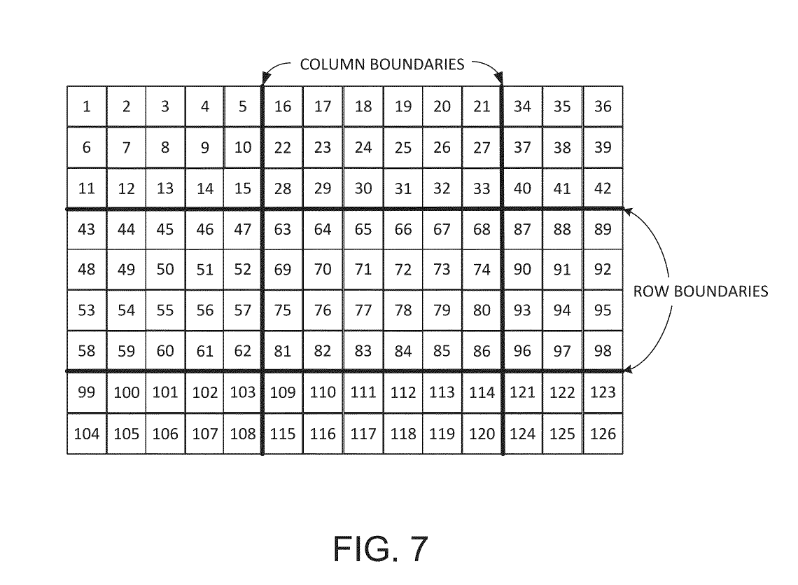

Referring to FIG. 7, a tile technique divides an image into a set of rectangular (inclusive of square) regions. The blocks (alternatively referred to as largest coding units or coding tree blocks in some systems) within each of the tiles are encoded and decoded in a raster scan order. The arrangement of tiles are likewise encoded and decoded in a raster scan order. Accordingly, there may be any suitable number of column boundaries (e.g., 0 or more) and there may be any suitable number of row boundaries (e.g., 0 or more). Thus, the frame may define one or more slices, such as the one slice illustrated in FIG. 7. In some examples, blocks located in different tiles are not available for intra-prediction, motion compensation, entropy coding context selection or other processes that rely on neighboring block information.

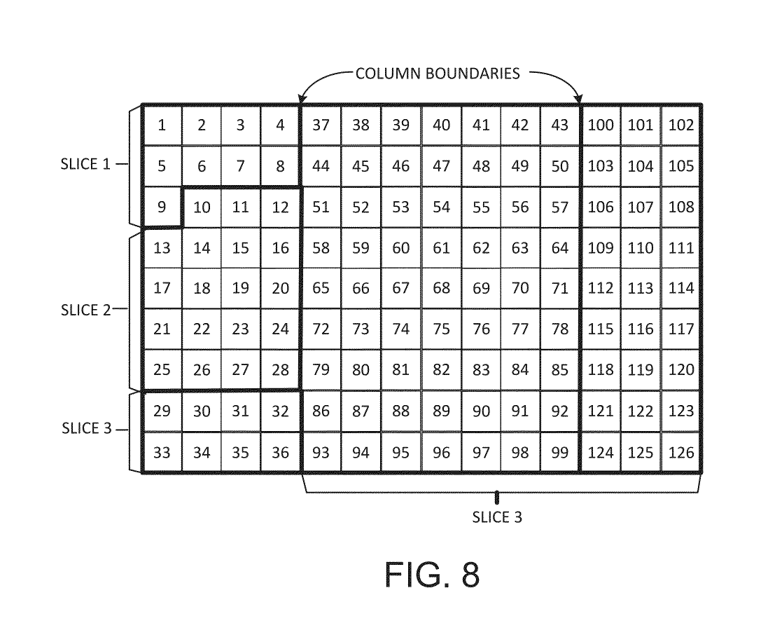

Referring to FIG. 8, the tile technique is shown dividing an image into a set of three rectangular columns. The blocks (alternatively referred to as largest coding units or coded tree blocks in some systems) within each of the tiles are encoded and decoded in a raster scan order. The tiles are likewise encoded and decoded in a raster scan order. One or more slices may be defined in the scan order of the tiles. Each of the slices are independently decodable. For example, slice 1 may be defined as including blocks 1-9, slice 2 may be defined as including blocks 10-28, and slice 3 may be defined as including blocks 29-126 which spans three tiles. The use of tiles facilitates coding efficiency by processing data in more localized regions of a frame.

In one example, the entropy encoding and decoding process is initialized at the beginning of each tile. At the encoder, this initialization may include the process of writing remaining information in the entropy encoder to the bit-stream, a process known as flushing, padding the bit-stream with additional data to reach one of a pre-defined set of bit-stream positions, and setting the entropy encoder to a known state that is pre-defined or known to both the encoder and decoder. Frequently, the known state is in the form of a matrix of values. Additionally, a pre-defined bit-stream location may be a position that is aligned with a multiple number of bits, e.g. byte aligned. At the decoder, this initialization process may include the process of setting the entropy decoder to a known state that is known to both the encoder and decoder and ignoring bits in the bit-stream until reading from a pre-defined set of bit-stream positions.

In some examples, multiple known states are available to the encoder and decoder and may be used for initializing the entropy encoding and/or decoding processes. Traditionally, the known state to be used for initialization is signaled in a slice header with an entropy initialization indicator value. With the tile technique illustrated in FIG. 7 and FIG. 8, tiles and slices are not aligned with one another. Thus, with the tiles and slices not being aligned, there would not traditionally be an entropy initialization indicator value transmitted for tiles that do not contain a first block in raster scan order that is co-located with the first block in a slice. For example referring to FIG. 7, block 1 is initialized using the entropy initialization indicator value that is transmitted in the slice header but there is no similar entropy initialization indicator value for block 16 of the next tile and it may use the entropy initialization indicator value that is transmitted in the slice header. Similarly, entropy initialization indicator information is not typically present for blocks 34, 43, 63, 87, 99, 109, and 121 for the corresponding tiles for the single slice (which has a slice header for block 1) and may use the entropy initialization indicator value that is transmitted in the slice header.

Referring to FIG. 8, in a similar manner for the three slices, an entropy initialization indicator value is provided in the slice headers for block 1 of slice 1, provided in the slice header for block 10 of slice 2, and provided in the slice header for block 29 of slice 3. However, in a manner similar to FIG. 7, there lacks an entropy initialization indicator value for the central tile (starting with block 37) and the right hand tile (starting with block 100). Without the entropy initialization indicator value for the middle and right hand tiles, it is problematic to efficiently encode and decode the blocks of the tiles in a parallel fashion and with high coding efficiency. As a general matter the encoder and/or decoder may partition a picture into one or more slices and/or one or more tiles. The tiles typically include a plurality of square coding blocks with sizes such as 4×4; 8×8; 16×16; 32×32; and 64×64. A group of coding blocks adjacent to one another may be grouped together to form what is generally referred to as a largest coding unit and/or a coding tree block. Typically there is more than one coding tree block (e.g., largest coding unit) within the slice. Typically there is more than one coding tree block (e.g., largest coding unit) within the tile.

Referring again to FIG. 7, the decoder knows the location of block 16 in the picture frame but due to entropy encoding is not aware of the positions of bits describing block 16 in the bitstream until block 15 is entropy decoded. This manner of decoding and identifying the next block maintains a low bit overhead, which is desirable. However, it does not facilitate tiles to be decoded in parallel. To increase the ability to identify a specific position in the bit-stream for a specific tile in a frame, so that the different tiles may be simultaneously decoded in parallel in the decoder without waiting for completion of the entropy decoding, a signal may be included in the bitstream identifying the location of tiles in the bit-stream. In an example, the signaling of the location of tiles in the bit-stream is provided in the header of a slice. In an example, if a flag indicates that the location of tiles in the bitstream is transmitted within the slice, then in addition to the location within the slice of the first block of each of the tile(s) within the slice it also may include the number of such tiles within the frame. Further, the location information may be included for only a selected set of tiles, if desired.

It is to be understood that in some cases the video coding may optionally not include tiles, and may optionally include the use of a wave front encoding and/or decoding pattern for the frames of the video. In this manner, one or more lines of the video (such as a plurality of groups of one or more rows of coded tree blocks, each of which group being representative of a wavefront substream may be encoded and/or decoded in a parallel fashion. In general, the partitioning of the video may be constructed in any suitable manner. Accordingly, the low bit rate entry point signaling techniques may likewise be applicable to other aspects of the bitstream, such as signaling the length of wavefront substreams.

Video coding standards often compress video data for transmission over a channel with limited frequency bandwidth and/or limited storage capacity. These video coding standards may include multiple coding stages such as intra prediction, transform from spatial domain to frequency domain, quantization, entropy coding, motion estimation, and motion compensation, in order to more effectively encode and decode frames. Many of the coding and decoding stages are unduly computationally complex or otherwise may not operate in an optimal manner.

The video coding and/or decoding technique, especially suitable for tiles, slices, and wavefronts may be any suitable technique, such as those disclosed in the High Efficiency Video Coding (HEVC) and its extensions such as, Scalable High Efficiency Video Coding (SHVC), and Multi-view High Efficiency Video Coding (MV-HEVC). The HEVC standard is described in the document “ITU-T Recommendation H 265, “High efficiency video coding,” SERIES H: AUDIOVISUAL AND MULTIMEDIA SYSTEMS Infrastructure of audiovisual services—Coding of moving video (April 2013),” which is incorporated by reference in its entirety herein. The text draft for MV-HEVC is given in the document “MV-HEVC Draft Text 7,” JCT3V-G1004, and “MV-HEVC Draft Text 8”, JCT3V-H1002_v5.doc, Valencia, May 2014, each of which is incorporated by reference in its entirety herein. The text draft for SHVC is given in the document “High Efficiency Video Coding (HEVC) Scalable Extension Draft 6,” JCTVC-Q1008_v3.doc, and “High Efficiency Video Coding (HEVC) Range Extension Draft 7”, JCTVC-Q1005_v9.doc, Valencia, May 2014, each of which is incorporated by reference in its entirety herein.

Suitable definitions for the aforementioned HEVC, SHVC, and MV-HEVC include the following:

* Multiplication, including matrix multiplication.

/ Integer division with truncation of the result toward zero. For example, 7/4 and −7/−4 are truncated to 1 and −7/4 and 7/−4 are truncated to −1.

÷ Used to denote division in mathematical equations where no truncation or rounding is intended.

x ? y:z If x is TRUE or not equal to 0, evaluates to the value of y; otherwise, evaluates to the value of z.

x>>y Arithmetic right shift of a two's complement integer representation of x by y binary digits. This function is defined only for non-negative integer values of y. Bits shifted into the MSBs as a result of the right shift have a value equal to the most significant bit (MSB) of x prior to the shift operation.

x<<y Arithmetic left shift of a two's complement integer representation of x by y binary digits. This function is defined only for non-negative integer values of y. Bits shifted into the LSBs as a result of the left shift have a value equal to 0.

Log 2(x) the base-2 logarithm of x

$$Min ( x , y ) = \{ \begin{matrix}x & ; & x <= y \\ y & ; & x > y\end{matrix} \\ Max ( x , y ) = \{ \begin{matrix}x & ; & x >= y \\ y & ; & x < y\end{matrix} \\ Clip 3 ( x , y , z ) = \{ \begin{matrix}x & ; & z < x \\ y & ; & z > y \\ z & ; & otherwise\end{matrix}$$

The following relational operators are defined as follows:
> Greater than.
>= Greater than or equal to.
< Less than.
<= Less than or equal to.
== Equal to.
!= Not equal to.
   When a relational operator is applied to a syntax element or variable that has been assigned the value “na” (not applicable), the value “na” is treated as a distinct value for the syntax element or variable. The value “na” is considered not to be equal to any other value.

The following arithmetic operators are defined as follows:
= Assignment operator.
++ Increment, i.e. x++ is equivalent to x=x+1; when used in an array index, evaluates to the value of the variable prior to the increment operation.
−− Decrement, i.e. x−− is equivalent to x=x−1; when used in an array index, evaluates to the value of the variable prior to the decrement operation.
+= Increment by amount specified, i.e. x+=3 is equivalent to x=x+3, and x+=(−3) is equivalent to x=x+(−3).
−= Decrement by amount specified, i.e. x−=3 is equivalent to x=x−3, and x−=(−3) is equivalent to x=x−(−3).

Ceil(x) corresponds to the smallest integer greater than or equal to x.

read_bits(n) reads the next n bits from the bitstream and advances the bitstream pointer by n bit positions. When n is equal to 0, read_bits(n) is specified to return a value equal to 0 and to not advance the bitstream pointer.

u(n) corresponds to unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first.

ue(v) corresponds to unsigned integer 0-th order Exp-Golomb-coded syntax element with the left bit first.

ae(v) corresponds to context-adaptive arithmetic entropy-coded syntax element.

The samples are processed in units of coding tree blocks. The array size for each luma coding tree block in both width and height is CthSizeY in units of samples. The width and height of the array for each chroma coding tree block are CtbWidthC and CtbHeightC, respectively, in units of samples. The variables CtbSizeY and CtbSizeC may be derived using syntax elements signaled in the sequence parameter set.

For a CABAC context, the variable pStateIdx corresponds to a probability state index and the variable valMps corresponds to the value of the most probable symbol.

The syntax element dependent_slice_segments_enabled_flag is signaled in picture parameter set. dependent_slice_segments_enabled_flag equal to 1 specifies the presence of the syntax element dependent_slice_segment_flag in the slice segment headers for coded pictures referring to the PPS. dependent_slice_segments_enabled_flag equal to 0 specifies the absence of the syntax element dependent_slice_segment_flag in the slice segment headers for coded pictures referring to the PPS.

The syntax element end_of_slice_segment_flag is signaled in slice segment data, end_of_slice_segment_flag equal to 0 specifies that another coding tree unit is following in the slice. end_of_slice_segment_flag equal to 1 specifies the end of the slice segment, i.e. that no further coding tree unit follows in the slice segment.

The syntax element dependent_slice_segment_flag is signaled in the slice segment header. dependent_slice_segment_flag equal to 1 specifies that the value of each slice segment header syntax element that is not present is inferred to be equal to the value of the corresponding slice segment header syntax element in the slice header. When not present, the value of dependent_slice_segment_flag is inferred to be equal to 0.

When wave front encoding and/or decoding pattern for the frames of the video is used then the slice segment header syntax element entropy_coding_sync_enabled_flag is signaled with its value set equal to 1.

Scaling list data is signaled in picture parameter set and is used in the derivation of values assigned to the elements of a 4-dimensional array ScalingFactor.

BitDepth_{Y} is the bit depth of the samples of the luma array.

BitDepth_{C} is the bit depth of the samples of the chroma arrays.

The syntax element extended_precision_processing_flag is signaled in Sequence parameter set range extensions. extended_precision_processing_flag equal to 1 specifies that an extended dynamic range is used for inter prediction interpolation and inverse transform processing. extended_precision_processing_flag equal to 0 specifies that the extended dynamic range is not used. When not present, the value of extended_precision_processing_enabled_flag is inferred to be equal to 0.

The variables CoeffMin_{Y}, CoeffMin_{C}, CoeffMax_{Y} and CoeffMax_{C} are derived as follows:

CoeffMin_{Y}=−(1<<(extended_precision_processing_flag ? Max(15, BitDepth_{Y}+6): 15))

CoeffMin_{C}=−(1<<(extended_precision_processing_flag ? Max(15, BitDepth_{C}+6): 15))

CoeffMax_{Y}=(1<<(extended_precision_processing_flag ? Max(15, BitDepth_{Y}+6): 15))−1

CoeffMax_{C}=(1<<(extended_precision_processing_flag ? Max(15, BitDepth_{C}+6): 15))−1

CuPredMode[xTbY][yTbY] is the prediction mode of the coding unit for a corresponding location (xTbY, yTbY).

MODE_INTRA corresponds to intra-coding mode.

MODE_INTER corresponds to inter-coding mode.

The transform coefficient levels are represented by the arrays TransCoeffLevel[x0][y0][cIdx][xC][yC]. The array indices x0, y0 specify the location (x0, y0) of the top-left luma sample of the considered transform block relative to the top-left luma sample of the picture. The array index cIdx specifies an indicator for the colour component; it is equal to 0 for Y, 1 for Cb, and 2 for Cr. The array indices xC and yC specify the transform coefficient location (xC, yC) within the current transform block. When the value of TransCoeffLevel[x0][y0][cIdx][xC][yC] is not specified, it is inferred to be equal to 0.

The variable PicSizeInCtbsY corresponds to the number of coding tree blocks in luma component of the picture.

The variable CtbAddrInRs corresponds to coding tree block address in raster scan order.

The variable CtbAddrInTs corresponds to coding tree block address in tile scan order.

The list CtbAddrRsToTs[ctbAddrRs] specifies the conversion from a coding tree block address in raster scan to coding tree block address in tile scan.

The list TileId[ctbAddrTs] for ctbAddrTs ranging from 0 to PicSizeInCtbsY−1, inclusive, specifies the conversion from a coding tree block address in tile scan to a tile ID.

pic_width_in_luma_samples specifies the width of each decoded picture in units of luma samples. The variable PicWidthInCtbsY corresponds to Ceil(pic_width_in_luma_samples÷CtbSizeY).

The variable PredictorPaletteSize specifies the size of the palette table predictor.

The variable PreviousPaletteSize specifies the size of the previously coded palette table.

The variable PredictorPaletteEntries specifies the entries within the palette table predictor.

In particular, the aforementioned HEVC, SHVC, and MV-HEVC include the following flag to specify wavefronts and dependent slices. Dependent slices allow data associated with a particular wavefront entry point or tile to be carried in a separate NAL unit, and thus potentially make that data available to a system for fragmented packetization with lower latency than if it were all coded together in one slice. A dependent slice for a wavefront entry point can only be decoded after at least part of the decoding process of another slice segment has been performed. A plurality of dependent slices together form a slice.

The syntax element entropy_coding_sync_enabled_flag, may be signaled in the picture parameter set. entropy_coding_sync_enabled_flag equal to 1 specifies that a specific synchronization process for context variables is invoked before decoding the coding tree unit which includes the first coding tree block of a row of coding tree blocks in each tile in each picture referring to the PPS, and a specific storage process for context variables is invoked after decoding the coding tree unit which includes the second coding tree block of a row of coding tree blocks in each tile in each picture referring to the PPS, entropy_coding_sync_enabled_flag equal to 0 specifies that no specific synchronization process for context variables is required to be invoked before decoding the coding tree unit which includes the first coding tree block of a row of coding tree blocks in each tile in each picture referring to the PPS, and no specific storage process for context variables is required to be invoked after decoding the coding tree unit which includes the second coding tree block of a row of coding tree blocks in each tile in each picture referring to the PPS.

It may be a requirement of bitstream conformance that the value of entropy_coding_sync_enabled_flag shall be the same for all PPSs that are activated within a coded video sequence (CVS).

When entropy_coding_sync_enabled_flag is equal to 1 and the first coding tree block in a slice is not the first coding tree block of a row of coding tree blocks in a tile, it is a requirement of bitstream conformance that the last coding tree block in the slice shall belong to the same row of coding tree blocks as the first coding tree block in the slice.

When entropy_coding_sync_enabled_flag is equal to 1 and the first coding tree block in a slice segment is not the first coding tree block of a row of coding tree blocks in a tile, it is a requirement of bitstream conformance that the last coding tree block in the slice segment shall belong to the same row of coding tree blocks as the first coding tree block in the slice segment.

When tiles are not enabled and entropy coding sync enabled flag is equal to 1, each subset of slice segment data corresponding to entry points shall consist of all coded bits of all coding tree units in the slice segment that include luma coding tree blocks that are in the same luma coding tree block row of the picture, and the number of subsets shall be equal to the number of coding tree block rows of the picture that contain coding tree units that are in the coded slice segment.

When tiles are enabled and entropy_coding_sync_enabled_flag is equal to 1, each subset of slice segment data corresponding to entry points shall consist of all coded bits of all coding tree units in the slice segment that include luma coding tree blocks that are in the same luma coding tree block row of a tile, and the number of subsets shall be equal to the number of luma coding tree block rows of a tile that contain coding tree units that are in the coded slice segment.

The initialization process of the CABAC parsing process is invoked when starting the parsing of one or more of the following:

the slice segment data syntax

the coding tree unit syntax and the coding tree unit is the first coding tree unit in a tile

the coding tree unit syntax, entropy_coding_sync_enabled_flag is equal to 1, and the associated luma coding tree block is the first luma coding tree block in a coding tree unit row

While parsing the slice segment data the storage process for context variables and Rice parameter initialization states is applied as follows:

When ending the parsing of the coding tree unit syntax, entropy_coding_sync_enable_flag is equal to 1, and either CtbAddrInRs PicWidthInCtbsY is equal to 1 or both CtbAddrInRs is greater than 1 and TileId[CtbAddrInTs] is not equal to TileId[CtbAddrRsToTs[CtbAddrInRs−2]], the storage process for context variables and Rice parameter initialization is invoked with TableStateIdxWpp, TableMpsValWpp, and TableStatCoeffWpp as outputs.

When ending the parsing of the general slice segment data syntax, dependent_slice_segments_enabled_flag is equal to 1 and end_of_slice_segment_flag is equal to 1, the storage process for context variables and Rice parameter initialization states is invoked with TableStateIdxDs, TableMpsValDs, and TableStatCoeffDs as outputs.

The initialization process of the CABAC parsing process is specified as follows:

Outputs of this process are initialized CABAC internal variables and the initialized Rice parameter initialization states StatCoeff.

The context variables of the arithmetic decoding engine are initialized as follows:
If the coding tree unit is the first coding tree unit in a tile, the following applies:
   The initialization process for context variables is invoked.
   The variables StatCoeff[k]60 are set equal to 0, for k in the range 0 to 3, inclusive.
Otherwise, if entropy_coding_sync_enabled_flag is equal to 1 and either CtbAddrInRs % PicWidthInCtbsY is equal to 0 or TileId[CtbAddrInTs] is not equal to TileId[CtbAddrRsToTs[CtbAddrInRs−1]], the following applies:
   The location (xNbT, yNbT) of the top-left luma sample of the spatial neighbouring block T is derived using the location (x0, y0) of the top-left luma sample of the current coding tree block as follows:

(xNbT, yNbT)=(x0+CtbSizeY, y0−CtbSizeY)
The availability derivation process for a block in z-scan order is invoked with the location (xCurr, yCurr) set equal to (x0, y0) and the neighbouring location (xNbY, yNbY) set equal to (xNbT, yNbT) as inputs, and the output is assigned to availableFlagT.
The synchronization process for context variables is invoked as follows:
   If availableFlagT is equal to 1, the synchronization process for context variables and Rice parameter initialization states is invoked with TableStateIdxWpp, TableMpsValWpp, and TableStatCoeffWpp as inputs.
   Otherwise, the following applies:
      The initialization process for context variables is invoked.
      The variables StatCoeff[k] are set equal to 0, for k in the range 0 to 3, inclusive.
Otherwise, if CtbAddrInRs is equal to slice segment address and dependent_slice_segment_flag is equal to 1, the synchronization process for context variables and Rice parameter initialization states is invoked with TableStateIdxDs, TableMpsValDs, and TableStatCoeffDs as inputs.
Otherwise, the following applies:
   The initialization process for context variables is invoked.
   The variables StatCoeff[k] are set equal to 0, for k in the range 0 to 3, inclusive.

The initialization process for the arithmetic decoding engine is invoked

The storage process for context variables and Rice parameter initialization states may be as described below.

Inputs to this process are: The CABAC context variables indexed by ctxTable and ctxIdx. The Rice parameter initialization states indexed by k.

Outputs of this process are: The variables tableStateSync and tableMPSSync containing the values of the variables pStateIdx and valMps used in the initialization process of context variables and Rice parameter initialization states that are assigned to all syntax elements in: General slice segment data syntax, Coding tree unit syntax, Sample adaptive offset syntax, Coding quadtree syntax, Coding unit syntax, Prediction unit syntax, pulse code modulation (PCM) sample syntax, Transform tree syntax, Motion vector difference syntax, Transform unit syntax, Residual coding syntax, except a subset of pre-determined syntax elements. The variables tableStatCoeffSync containing the values of the variables StatCoeff[k] used in the initialization process of context variables and Rice parameter initialization states.

For each context variable, the corresponding entries pStateIdx and valMps of tables tableStateSync and tableMPSSync are initialized to the corresponding pStateIdx and valMps.

For each Rice parameter initialization state k, each entry of the table tableStatCoeffSync is initialized to the corresponding value of StatCoeff[k].

The synchronization process for context variables and Rice parameter initialization states may be as described below.

The inputs to the process are: The variables tableStateSync and tableMPSSync containing the values of the variables pStateIdx and valMps used in the storage process of context variables that are assigned to all syntax elements in: General slice segment data syntax, Coding tree unit syntax, Sample adaptive offset syntax, Coding quadtree syntax, Coding unit syntax, Prediction unit syntax, PCM sample syntax, Transform tree syntax, Motion vector difference syntax, Transform unit syntax, Residual coding syntax, except a subset of pre-determined syntax elements. The variable tableStatCoeffSync containing the values of the variables StatCoeff[k] used in the storage process of context variables and Rice parameter initialization states.

Outputs of this process are: The initialized CABAC context variables indexed by ctxTable and ctxIdx. The initialized Rice parameter initialization states StatCoeff indexed by k.

For each context variable, the corresponding context variables pStateIdx and valMps are initialized to the corresponding entries pStateIdx and valMps of tables tableStateSync and tableMPSSync.

For each Rice parameter initialization state, each variable StatCoeff[k] is initialized to the corresponding entry of table tableStatCoeffSync.

The context variables of the arithmetic decoding engine are initialized as follows:

If the coding tree unit is the first coding tree unit in a tile, the initialization process for context variables is invoked.

Otherwise, if entropy_coding_sync_enabled_flag is equal to 1 and before decoding the coding tree unit which includes the first coding tree block of a row of coding tree blocks in each tile in each picture referring to the PPS, the following applies:
The location (xNbT, yNbT) of the top-left luma sample of the spatial neighbouring block T is derived using the location (x0, y0) of the top-left luma sample of the current coding tree block as follows: (xNbT, yNbT)=(x0+CtbSizeY, y0−CtbSizeY)
The availability for a block in z-scan order with the current location (x0, y0) and neighbouring location (xNbT, yNbT) is determined and assigned to availableFlagT.
The synchronization process for context variables is invoked as follows:
   If availableFlagT is equal to 1, the synchronization process for context variables is invoked with TableStateIdxWpp and TableMpsValWpp as inputs.
   Otherwise, the initialization process for context variables is invoked.

Otherwise, if first CTB in dependent slice, the synchronization process for context variables is invoked with TableStateIdxDs and TableMpsValDs as inputs.

Otherwise, the initialization process for context variables is invoked.

The dequantization and/or scaling process for the received video stream is a scaling process for the coefficients and may be described as below.

The inputs to the process may include, for example, the following:

a luma location (xTbY, yTbY) specifying the top-left sample of the current luma transform block relative to the top-left luma sample of the current picture,

a variable nTbS specifying the size of the current transform block,

a variable cIdx specifying the colour component of the current block,

a variable qP specifying the quantization parameter.

The outputs to the process may include, for example, a (nTbS)x(nTbS) array d of scaled transform coefficients with elements d[x][y].

The variables log 2TransformRange, bdShift, coeffMin and coeffMax are derived as follows:

If cIdx is equal to 0,

log 2TransformRange=extended_precision_processing_flag ? Max(15, BitDepth_{Y}+6): 15
bdShift=BitDepth_{Y}+Log 2)(nTbS)+10−log 2TransformRange
coeffMin=CoeffMin_{Y}
coeffMax=CoeffMax_{Y}

Otherwise,

log 2TransformRange=extended_precision_processing_flag ? Max(15, BitDepth_{C}+6): 15
bdShift=BitDepth_{C}+Log 2(nTbS)+10−log 2TransformRange
coeffMin=CoeffMin_{C}
coeffMax=CoeffMax_{C}

The list levelScale[ ] specified as levelScale[k]={40, 45, 51, 57, 64, 72} with k=0.5.

For the derivation of the scaled transform coefficients d[x][y] with x=0..nTbS−1, y=0..nTbS−1, the following applies:

The scaling factor m[x][y] is derived as follows:
If one or more of the following conditions are true, m[x][y] is set equal to 16:
   scaling_list_enabled_flag is equal to 0,
   transform_skip_flag[xTbY][yTbY] is equal to 1 and nTbS is greater than 4.
Otherwise, the following applies:
   m[x][y]=ScalingFactor[sizeId][matrixId][x][y]

Where sizeId is the size of the quantization matrix equal to (nTbS)x(nTbS) and matrixId is specified according to sizeId, prediction mode and color component sizeId, CuPredMode[xTbY][yTbY], and cldx, respectively. An example mapping is shown below:

TABLE (3)

| | | cIdx | |
|---|---|---|---|
| sizeId | CuPredMode | (colour component) | matrixId |
| 0, 1, 2, 3 | MODE_INTRA | 0 (Y) | 0 |
| 0, 1, 2, 3 | MODE_INTRA | 1 (Cb) | 1 |
| 0, 1, 2, 3 | MODE_INTRA | 2 (Cr) | 2 |
| 0, 1, 2, 3 | MODE_INTER | 0 (Y) | 3 |
| 0, 1, 2, 3 | MODE_INTER | 1 (Cb) | 4 |
| 0, 1, 2, 3 | MODE_INTER | 2 (Cr) | 5 |

The scaled transform coefficient d[x][] may be derived as follows:

d[x][y]=Clip3(coeffMin, coeffMax, ((TransCoeffLevel[xTbY][yTbY][cIdx][x][y]*m[x][y]*levelScale[qP%6]<<(qP/6))+(1<<(bdShift−1)))>>bdShift).

A screen capture tool facilitates a computer to record an image displayed on a visual display unit, such as a computer monitor. In a similar manner, for computer generated graphical content, the computer may record an image to be displayed on the visual display unit.

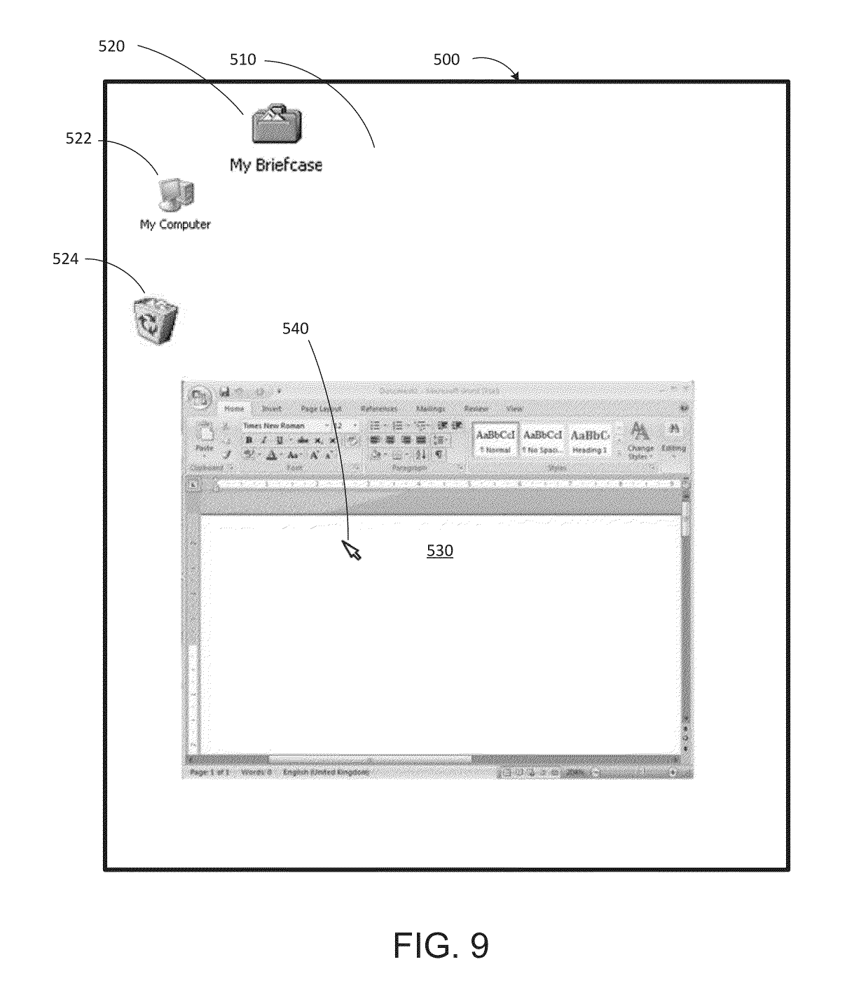

FIG. 9 illustrates a captured screen area 500 of a computer desktop environment. The captured screen area 500 shows the entire desktop, but could instead show only the window 530 or some other portion of the desktop. A cursor graphic 540 overlays the window 530, and several icon graphics 520, 522, 524 overlay the background 510. The captured screen area 500 could be part of a series. Through the series, such as a video sequence, much of the screen content in the captured screen area 500 would probably remain the same. Screen content such as the background 510 and icon graphics 520, 522, 524 usually does not change from frame to frame. On the other hand, the cursor graphic 540 often changes position and shape as the user manipulates a mouse or other input device, and the contents of the window 530 often change as a user types, adds graphics, etc. Like other forms of digital video, screen capture video consumes large amounts of storage and transmission capacity.

Screen capture images may contain a mixture of continuous tone content and palletized content. Continuous tone content includes, for example, photographs or other images with gradually varying colors or tones, and typically uses a range of image tones that appears substantially continuous to the human eye. Palletized content includes, for example, icons, toolbars, and command or notepad windows consisting of a flat color background and foreground text of a contrasting color. A color palette for palletized content typically includes a relatively small set of image colors or tones (e.g., 256 different 24-bit colors). Palletized content often includes areas of perceptually important fine detail—spatially localized, high frequency variations depicting text elements or other image discontinuities.

A series of captured screen areas typically result in a very high bitrate of storing the series or transmitting the series across a network. Compression techniques of captured screen areas are often used to reduce the bitrate. Lossless compression techniques may be used, but the resulting bitrate reduction tends to be limited. Lossy compression techniques can be used, where the resulting bitrate reduction tends to be greater but the quality of the video tends to suffer.

Applying lossy compression to palletized content tends to result in the loss of perceptually important fine detail For example, text and sharp edges may be blurred or distorted in the decompressed content. As a result, lossless encoding of palletized content is preferred in many circumstances. In some system which desire to trade quality for bitrate, screen capture video may undergo quantization while still being considered as palletized content. On the other hand, in some scenarios it is desirable to encode continuous tone content using only lossless compression if sufficient resources are available. Lossy compression can be used in some systems to effectively compress continuous tone content at a lower bitrate.

Video coders use a variety of different compression techniques. These compression techniques typically involve transforms, quantization, and entropy coding for individual frames, and motion estimation for a series of frames. The compression techniques often include run length encoding and CABAC coding.

Run length encoding is a compression technique used for camera video, audio, text, and other types of content. In general, run length encoding replaces a sequence (i.e., run) of consecutive symbols having the same value with the value and the length of the sequence. In run length decoding, the sequence of consecutive symbols is reconstructed from the run value and run length. The results of run length encoding the run values and run lengths) can be coded using CABAC to further reduce bitrate.

In the run length encoding adapted to palletized screen capture content, the encoder encodes runs of color value symbols, above symbols, and/or escape symbols. For a given pixel in a row of a frame, a color value symbol can indicate the color value (e.g., the index to a color palette, or the color component value(s) in some color space) for the given pixel, an above symbol can reference the color value of the pixel just above the given pixel, or an escape symbol can signal the color value of the pixel directly. Some runs can be run length encoded only with the color value symbols for the runs. On the other hand, in some cases, a particular series of pixels might instead be encoded with the above symbol or the escape symbol.

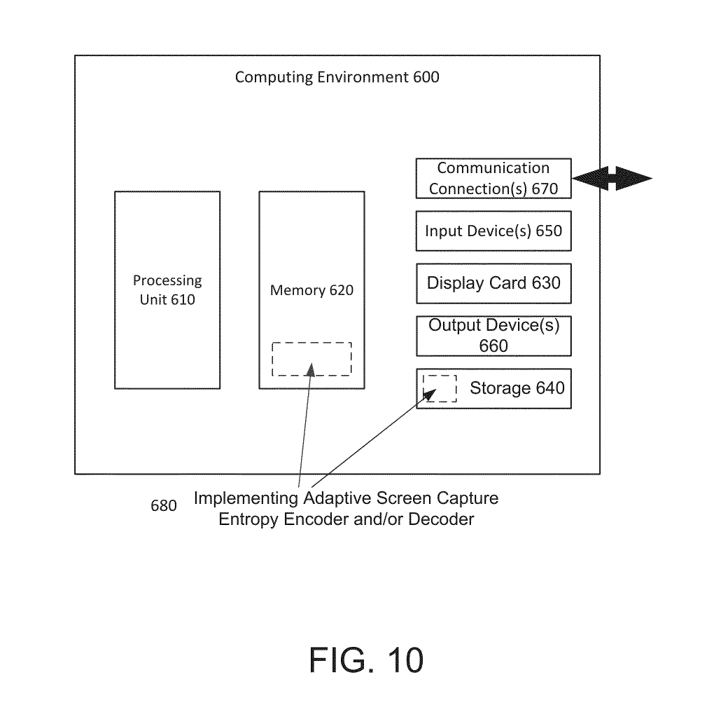

With reference to FIG. 10, a computing environment 600 includes at least one processing unit 610 and memory 620. The processing unit 610 executes computer-executable instructions and may be a real or a virtual processor. In a multi-processing system, multiple processing units execute computer-executable instructions to increase processing power. The memory 620 may be volatile memory (e.g., registers, cache, RAM), non-volatile memory (e.g., ROM, EEPROM, flash memory, etc.), or some combination of the two. The memory 620 stores software 680 implementing an adaptive screen capture entropy encoder and/or decoder.

The computing environment 600 also includes a display card 630. The display card 630 (alternatively called the video card, graphics card, graphics output device, display adapter, video graphics adapter, etc.) delivers output to a visual display unit such as a computer monitor. The display card 630 includes a frame buffer that stores pixel information for display on a screen. The frame buffer is often some type of RAM on the display card 630, but can instead be some other kind of memory and/or not physically located on the display card itself The display card 630 can include a graphics processor, graphics accelerator, and/or other specialized display hardware.

Typically, operating system software (not shown) provides an operating environment for other software executing in the computing environment 600, and coordinates activities of the components of the computing environment 600. In addition, display driver software allows access to various features of the display card 630. The display driver software can work in conjunction with one or more layers of operating system software through which access to the features of the display card 630 is exposed. For example, through such features, a screen capture tool might retrieve pixel information from the frame buffer of the display card 630 for screen content currently displayed on a screen of a visual display unit.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600.

The storage 640 may be removable or non-removable, and includes magnetic disks, magnetic tapes or cassettes, CD-ROMs, CD-RWs, DVDs, or any other medium which can be used to store information and which can be accessed within the computing environment 600. The storage 640 stores instructions for the software 680 implementing an adaptive screen capture entropy encoder and/or decoder. The input device(s) 650 may be a touch input device such as a keyboard, mouse, pen, or trackball, a voice input device, a scanning device, sound card, television (TV) tuner and/or video input card, or other device that provides input to the computing environment 600.

The output device(s) 660 may be a visual display unit, printer, speaker, CD-writer, or other device that provides output from the computing environment 600. A visual display unit presents screen content based upon output delivered from the display card 630.

The communication connection(s) 670 enable communication over a communication medium to another computing entity. The communication medium conveys information such as computer-executable instructions, compressed captured screen area information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, radio frequency (RF), infrared, acoustic, or other carrier.

Within a video bitstream, a palette coding technique may be enabled or disabled by using a “palette enabled flag” in a sequence parameter set. This may be signaled when the sps_extension_flag is equal to 1. The sequence parameter set (SPS) may be a syntax structure containing syntax elements that apply to zero or more entire coded video sequences as determined by the content of a syntax element found in the picture parameter set referred to by a syntax element found in each slice segment header. The picture parameter set (PPS) is a syntax structure containing syntax elements that apply to zero or more entire coded pictures as determined by a syntax element found in each slice segment header. The palette_enabled_flag equal to 1 specifies that the palette mode may be used for a block of samples, e.g. intra blocks, while the palette_enabled_flag equal to 0 specifies that the palette mode is not applied. When the palette_enabled_flag is not present, the value of the palette_enabled_flag is inferred to be equal to zero.

In an example, the use of palette coding for a block of pixels may be signaled using a flag. In an example, the use of palette coding for a block of pixels may be inferred b decoder using past data of the bit stream.

Within a video bitstream, the palette coding technique may be enabled or disabled by a “palette_mode_flag” for each coding unit. The palette mode within each coding unit may be signaled when the “palette_enabled_flag” is enabled (==1) and intra mode (CuPredMode [x0][y0]==MODE_INTRA (e.g., intra mode coding of the coding unit). The palette_mode_flag [x0][y0] equal to 1 specifies that the current coding unit is coded using the palette mode, while if the palette_mode_flag [x0][y0] equal to 0 specifies that the current coding unit is not coded using the palette mode. The array indices x0, y0 specify the location (x0, y0) of the top left luma sample of the considered coding block relative to the top left luma sample of the picture. By reference to coder, it is intended to include both the encoder and the decoder.

In an example palette coding may be used for non-intra modes (e.g. inter mode). In an example palette coding may be used for non-intra modes (e.g. inter mode) in addition to the intra mode.

Within a video bitstream, the palette coding may be indicated by a “palette_mode_flag” being enabled (i.e., palette_mode_flag is equal to 1). This indicates a palette table is being used and the palette table is generated for the coding unit and each pixel value of the coding unit is coded using the palette table.

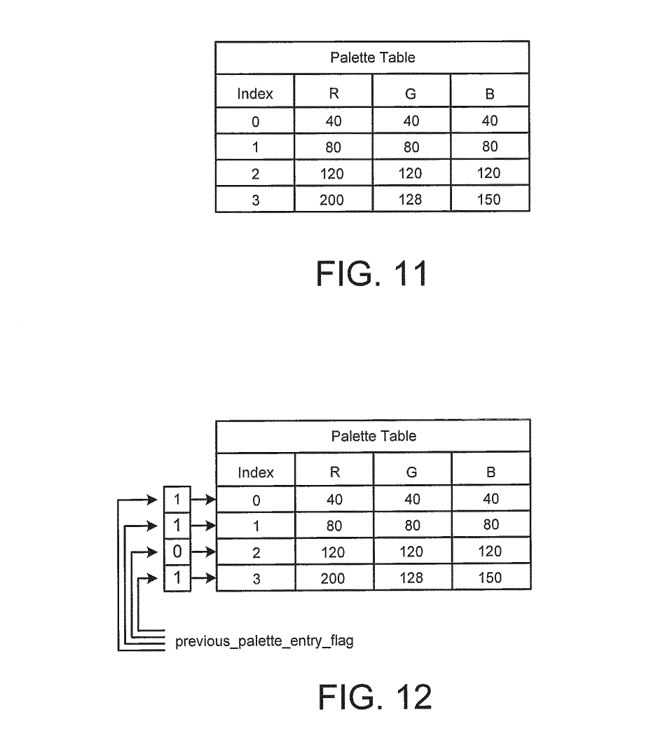

Referring to FIG. 11, an exemplary palette table is illustrated for sets of red (R), green (G), and blue (B) pixels, each set of three pixels indicating a particular pixel color. For each of the sets of red, green, and blue pixel values an index value may be assigned. The palette table may indicate the pixel's color in any manner together with any manner of indicating an index. Typically there are pairs of an index and pixel values. For example, the entries of the palette table may be derived using a histogram of the representative pixel values e.g. quantized pixel values, of the current coding unit in the encoder. In this manner, the system may use pixel values that are quantized to increase the coding efficiency. Based upon the palette table, the representative pixel values of a coding unit are coded and decoded in a suitable manner.

The palette table may be generated for a particular coding unit and the pixels of the coding unit encoded using the generated palette table. Rather than signaling a separate palette table in the bitstream for each subsequent coding unit, it is more efficient to predict, at least a part of, if not all of the subsequent palette table entries from the previous palette table entries. Those portions of the subsequent palette table that are not predicted based upon the previous palette table may be updated in the bitstream to include new entries in the subsequent palette table. The subsequent palette table may be referred to as a predicted palette table.

Referring to FIG. 12, by way of example the predicted palette table may be based upon a set of flags (e.g., a 1 dimensional table), such as a “previous_palette_entry_flag” for each of the entries in the index. For example, a previous_palette_entry_flag[i]=1 (or otherwise inferred) for i-th index value indicates to maintain the i-th palette table entries from the previous palette table. For example, a previous_palette_entry_flag[i]=0 (or otherwise inferred) for i-th index value indicates to not include the i-th palette table entries from the previous palette table. In an example, the previous_palette_entry_flag[i] is coded for all of the index values of the previous palette table, although some of the entries may be inferred, if desired. Additional palette table entries may be added to the predicted palette table to form an updated palette table for the subsequent coding unit. The previous_palette_entry_flag[i] equal to 1 specifies that the i-th palette entry from the previous used palette is copied, while the previous_palette_entry_flag[i] equal to 0 specifies that the i-th palette entry from the previously used palette is not copied.

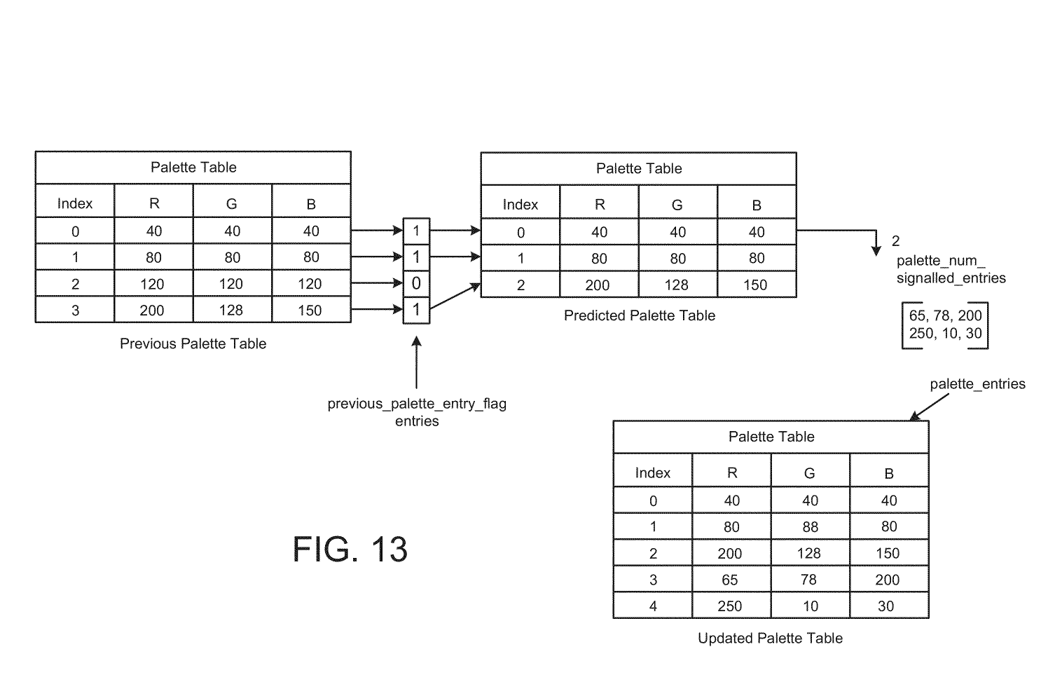

Referring to FIG. 13, a previous palette table is illustrated together with a set of flags of previous_palette_entry_flag[i], one for each of the indexes. As illustrated, the set of flags [1 1 0 1] may represent, index 0 maintain, index 1 maintain, index 2 do not maintain, and index 3 maintain. Based upon the set of flags a predicted palette table is illustrated, where any palette table entries that are not maintained are replaced by any subsequent indexes. In this manner, a re-indexing may be performed, if desired. For additional entries to be included in the re-indexed predicted palette table a corresponding syntax element may be included, such as “palette_num_signaled_entries”, to indicate the number of additional entries for the predicted palette table. For each of the palette_num_signaled_entries a syntax element “palette_entries[cldx][j]” which specifies the j-th element in the palette for the color component cldx. For example, a new set of entries for palette_entries[cldx][j] {e.g., [[65, 78, 200] [250, 10, 30]]} may be signaled, based upon signaling palette_num_signaled_entries of 2. The result is an updated palette table, that includes the new set of entries, for the subsequent coding unit. The palette_num_signaled_entries specifies the number of entries in the palette that are explicitly signaled for the current coding unit, while when palette_num_signaled_entries is not present, it is interred to be equal to 0. The palette_entries [cIdx][j] specifies the j-th element in the palette for the color component cIdx. The variable palette_size is derived as the sum of number of palette table entries predicted from previous palette table and value of palette_num_signaled_entries.

The pixels in the coding unit may be coded in a raster scan order based upon the updated palette table using one of three modes.

The first mode may include an INDEX_MODE, where one color index is signaled, and all indices in the current line are set to the signaled color index. For example upon signaling the INDEX_MODE, the syntax may include a palette_index (e.g., identify the palette index) that is signaled followed by a value M (e.g., which may be referred to as palette run) which represents that the following M palette indexes are the same as the one signaled. This is a horizontal direction prediction. The palette_run specifies the number of consecutive locations, following the current location, with the same palette index.

The second mode may include a COPY_ABOVE_MODE, where the indices of the current line are copied from the above line. For example upon signaling the COPY_ABOVE_MODE, the syntax may include a value N (e.g., which may be referred to as palette run) which represents that the following N palette indexes are the same as their above neighbors, respectively. This is a vertical direction prediction.

The third mode may include an ESCAPE mode signaled, followed by a palette_escape_val, where the pixel value itself (which may or may not be quantized) is transmitted without being determined based upon a palette table. For example, upon signaling the ESCAPE mode, the following palette_escape_val syntax element may include the pixel value. The pixel value may be a quantized (or non-quantized) pixel value to be transmitted in the ESCAPE mode.

In a conforming bitstream the summation of all (palette_run+1) received in the coding unit and the number of escape pixels decoded shall equal the total number of pixels in the coding unit. In another example, for a conforming bitstream the number of pixel values decoded for a coding unit shall equal the total number of pixels in the coding unit.

A syntax element palette_run_type_flag may be coded to indicate the run type as follows.

If palette_run_type_flag is equal to 0 then the mode is INDEX_MODE. In this case the system signals the “index” information. If the Index is equal to the palette size then the system codes the quantized pixel values directly, otherwise the system signals the palette_run information.

palette_run_type_flag is equal to 1 then the mode is COPY_ABOVE_MODE. In this case, the system signals the palette_run information.

The ESCAPE mode is enabled when the following two conditions are satisfied. The first condition is if the palette_run_type_flag is equal to 0. The second condition is if the currently coded palette_index is equal to palette_size. The palette index is an index to the palette entries. The palette_size indicates the number of palette index entries.

In an example, the first row of each coding unit, the system element palette_run_type_flag is not transmitted but inferred to be 0 (i.e., INDEX_MODE) because there is no above line available from which the COPY_ABOVE_MODE can copy.

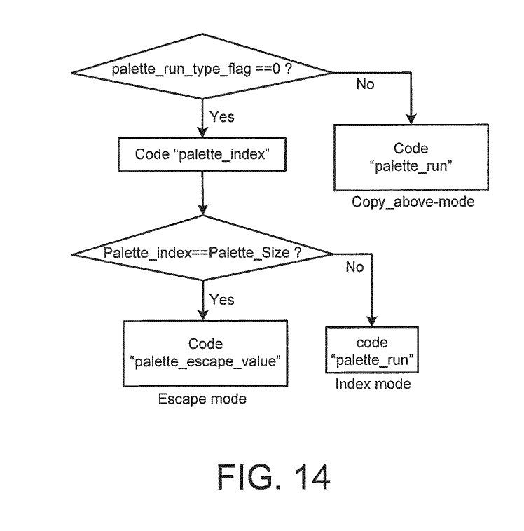

Referring to FIG. 14, an exemplary flow for the index map coding structure is illustrated. If the palette_run_type_flag is not 0 then the system codes the palette_run using the COPY_ABOVE_MODE. If the palette_run_type_flag is 0, then the system codes the palette_index. The system then determines if the palette_Index is the same as the palette_size, which if not true, then the system codes the palette_run in INDEX_MODE. If system determines that the palette_index is the same as the palette size, then the system codes the palette_escape_value in ESCAPE mode.

In an example palette coding may be performed independently for each color component of a CVS. In another example color components may be grouped together and each group performs palette coding, independently, for a CVS.

In an example palette coding may be performed independently for each color component within a subset of CVS e.g. subset of slices within a CVS, subset of pictures within a CVS. In another example color components may be grouped together and each group performs palette coding, independently, within a subset of CVS e.g. subset of slices within a CVS, subset of pictures within a CVS.

In an example a flag may be received by the decoder that indicates if a palette coded block of samples contains at least one escape coded sample value. In an example, such a flag may be named “palette_escape_val_present_flag” and will be referred to herein using this name, but it should be understood that this flag could be given any name. In an example this flag may be received by the decoder at the coding unit level. In an example, palette_escape_val_present_flag equal to 1 specifies that the current coding unit contains at least one escape coded sample, while escape_val_present_flag equal to 0 specifies that there are no escape coded samples in the current coding unit.

In an example the palette table size corresponding to a palette coded block of sample values, may be zero. In such an event, all the samples of the palette coded block of sample values are coded in escape mode.

In an example CurrentPaletteSize is set to a pre-determined value.

In an example CurrentPaletteSize is derived from past data received in the bitstream.

In an example, the syntax element palette_share_flag[x0][y0] (received in the bitstream) with a value equal to 1 specifies that the palette for the current coding unit is derived by copying the first PreviousPaletteSize entries from the palette table predictor. The array indices x0 and y0 specify the location (x0, y0) of the top-left luma sample of the considered coding block relative to the top-left luma sample of the picture.

In an example PreviousPaletteSize is a variable that keeps track of the palette table size of the previous block. In an example, the variable paletteNumPredictedEntries specifies the number of entries in the current palette table that are predicted (e.g. by reusing them) from the palette table predictor.

In an example, the syntax element palette_num_signaled_entries (received in the bitstream) specifies the number of entries in the current palette table that are signaled, e.g. signaled explicitly.

In an example CurrentPaletteSize is derived as follows:
The variable CurrentPaletteSize specifies the size of the current palette and is derived as follows:
   If palette_share_flag [x0][y0] is equal to 1, CurrentPaletteSize is set equal to PreviousPaletteSize
   Otherwise (pallete_share_flag [x0][y0] is equal to 0)

CurrentPaletteSize is set equal to paletteNumPredictedEntries+palette_num_signaled_entries.

In an example a variable CurrentPaletteSize is used to keep track of the palette table size corresponding to the current block of palette coded sample values. In an example, when CurrentPaletteSize is zero then all the samples of the palette coded block of sample values are coded in escape mode.

In an example when CurrentPaletteSize is equal to zero then palette_escape_val_present_flag may not be received by the decoder. In such an event, the decoder infers the value of palette_escape_val_present_flag. In an example, the decoder may infer a predetermined value for palette_escape_val_present_flag, e.g. 1. In an example, the decoder may infer a value for palette_escape_val_present_flag derived based on past data received in the bitstream, e.g. palette_mode_flag[x0][y0]. In an example, the decoder may infer a value for palette_escape_val_present_flag derived based on past data received in the bitstream, e.g. 0. An exemplary syntax and semantic where the palette_mode_flag syntax element may be received in the coding unit is shown in Table (4).

An exemplary syntax and semantic where the palette_escape_val_present syntax element may be received in the coding unit is shown in Table (5).

TABLE (4)

Descriptor

coding_unit( x0, y0, log2CbSize ) {

...

| | |
|---|---|
| palette_mode_flag[ x0 ][ y0 ] | ae(v) |

if( palette_mode_flag[ x0 ][ y0 ] )

palette_coding( x0, y0, nCbS )

...

}

TABLE (5)

Descriptor

palette_coding( x0, y0, nCbS ) {

...
if( CurrentPaletteSize != 0 )

| | |
|---|---|
| palette_escape_val_present_flag | ae(v) |

...

}

Here, log 2CbSize specifics the size of the current luma coding block, and nCbS is equal to (1<<log 2CbSize) and specifies the size of the current luma coding block palette_escape_val_present_flag equal to 1 specifies that the current coding unit contains at least one escape coded sample. escape_val_present_flag equal to 0 specifies that there are no escape coded samples in the current coding unit. When not present, the value of palette_escape_val_present_flag is inferred to be equal to 1.

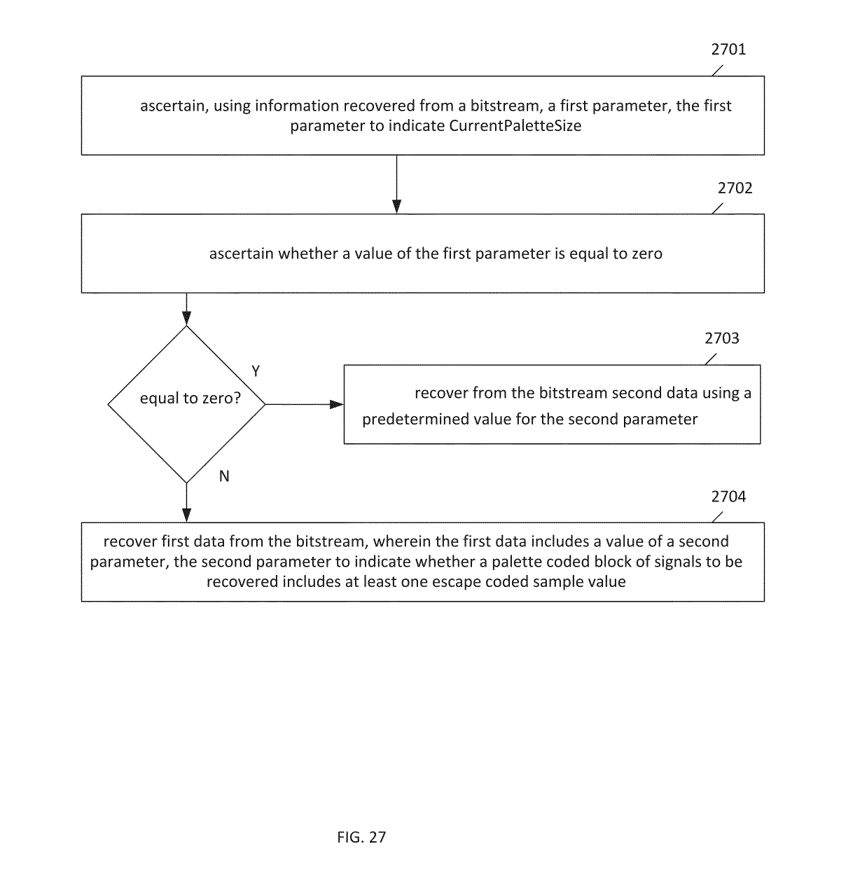

In FIG. 27, an example decoder may be configured to ascertain(block 2701), using information recovered from a bitstream, a first parameter, the first parameter to indicate CurrentPaletteSize; ascertain (block 2702) whether a value of the first parameter is equal to zero; recover (block 2703) first data from the bitstream in response to an ascertainment that the value of the first parameter is not equal to zero (in an example, the first data includes a value of a second to indicate whether a palette coded block of signals to be recovered includes at least one escape coded sample value); recover (block 2704) from the bitstream second data using a predetermined value for the second parameter in response to an ascertainment that the value of the first parameter is equal to zero. In an example, the predetermined value is equal to one. In an example, the decoder may be configured to recover the second data from the bitstream in escape mode. In an example, wherein the second data includes a pixel value, second data includes sample information, pixel information, or the like, or combinations thereof. In an example, the first data includes a palette_escape_value_present_flag.

It should be appreciated that the decoder may recover a picture from the bitstream and performing at least one of storing the picture in an electronic memory or causing the picture to be displayed on an electronic display. In an example, the values for the first and second parameter are sent for each block in a picture. The decoder may determine the values for the first and second parameters (for a block), and recover the block from the bitstream based on these values. The decoder may determine the values for the first and second parameters (for a next block), and recover the next block from the bitstream based on these values. This may be repeated until the end of the picture. At that point, the decoder may store the picture in a buffer and/or display the picture on a display.

In another example the semantic of palette escape val_present flag may be: palette_escape_val_present_flag equal to 1 specifies that the current coding unit contains at least one escape coded sample, escape_val_present_flag equal to 0 specifies that there are no escape coded samples in the current coding unit. When not present, the value of palette_escape_val_present_flag is inferred to be equal to palette_mode_flag[x0][y0].

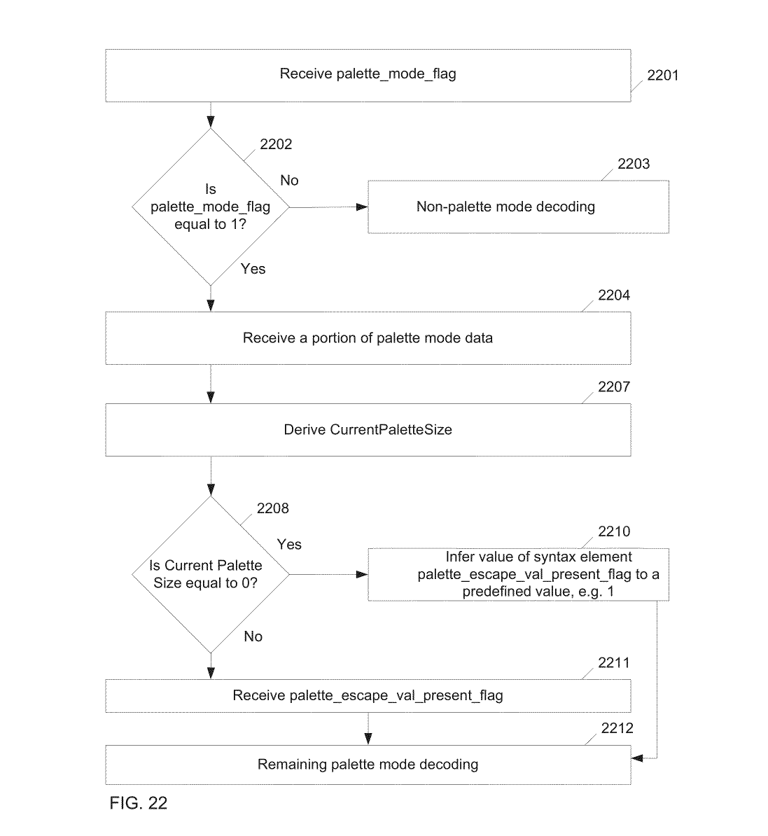

Referring FIG. 22, the decoder may receive a palette mode flag in block 2201. In diamond 2202, the decoder determines whether palette_mode_flag is equal to 1. If the decoder receives syntax element palette_mode_flag with value 1, then the corresponding block of sample values is decoded using palette mode, otherwise non-palette mode decoding is used in block 2203.

In palette mode decoding, the decoder receives a portion of the palette mode data (block 2204) and derives the value of the variable CurrentPaletteSize in block 2207. The decoder determines whether the derived value of the CurrentPaletteSize is equal to 0 in diamond 2208. If the derived value of the CurrentPaletteSize is equal to 0, then in block 2210 the decoder infers the value of syntax element palette_escape_val_present_flag, otherwise the decoder receives the syntax element palette_escape_val_present in block 2211. In an example, inferring the value of the syntax element includes setting a value of syntax element palette_escape_val_present_flag independently of the remaining information of the bitstream, e.g. independently of a next portion of the palette mode data. In an example, inferring the value of the syntax element includes setting a value of syntax element palette_escape_val_present_flag based on past data received by the decoder, e.g. based on the portion of the palette mode data or a previously received portion of the palette mode data, or combinations thereof. In an example, inferring the value of the syntax element includes setting a value of syntax element palette_escape_val_present_flag to a predefined value, e.g. 1.

The decoder then proceeds to the remaining steps corresponding to palette mode decoding (block 2212). In an example, remaining palette mode decoding (2212) includes a steps where the value of palette_escape_val_present_flag may be used to determine decoding process to be carried out next, for e.g. When palette_escape_val_present_flag is equal to 1 the decoder may receive quantization parameters used in scaling the values received for samples coded in escape mode, When palette escape_val_present_flag is equal to 0 no such quantization parameters are received.

In another example with respect to FIG. 22, the palette_escape_val_present_flag may always be received. Thus in this case palette_escape_val_present_flag may be always received without requiring and/or checking CurrentPaletteSize. Thus the diamond 2208 in FIG. 22 may not be required, thereby removing a check from the decoding process and leading to complexity reduction. In this case palette_escape_val_present_flag is always signaled and received even when CurrentPaletteSize is zero or non-zero value.

Additionally in another example before carrying out the steps outlined in FIG. 22, the decoder may receive a palette_mode_enabled_flag with value of 1. In some cases the palette_mode_enabled_flag may be received in a parameter set. In some cases the palette_mode_enabled_flag may be received in a sequence parameter set as shown in Table (6)

TABLE (6)

Descriptor

sps_scc_extensions( ) {

| | |
|---|---|
| ... | |
| palette_mode_enabled_flag | u(1) |
| if( palette_mode_enabled_flag ) { | |

| | |
|---|---|
| palette_max_size | ue(v) |
| palette_max_predictor_size | ue(v) |

}
...

}

With respect to Table (6)
palette_mode_enabled_flag equal to 1 may specify that the palette mode may be used tar a block of samples, e.g. infra blocks. palette_mode_enabled_flag equal to 0 may specify that the palette mode is not applied. When not present, the value of palette_mode_enabled_flag is in erred to be equal to 0.
palette_max_size specifies the maximum allowed palette size. When not present, the value of palette_max_size is inferred to be 0,
palette_max_predictor_size specifies the maximum predictor palette size. When not present, the value of palette_max_predictor size is inferred to be 0.

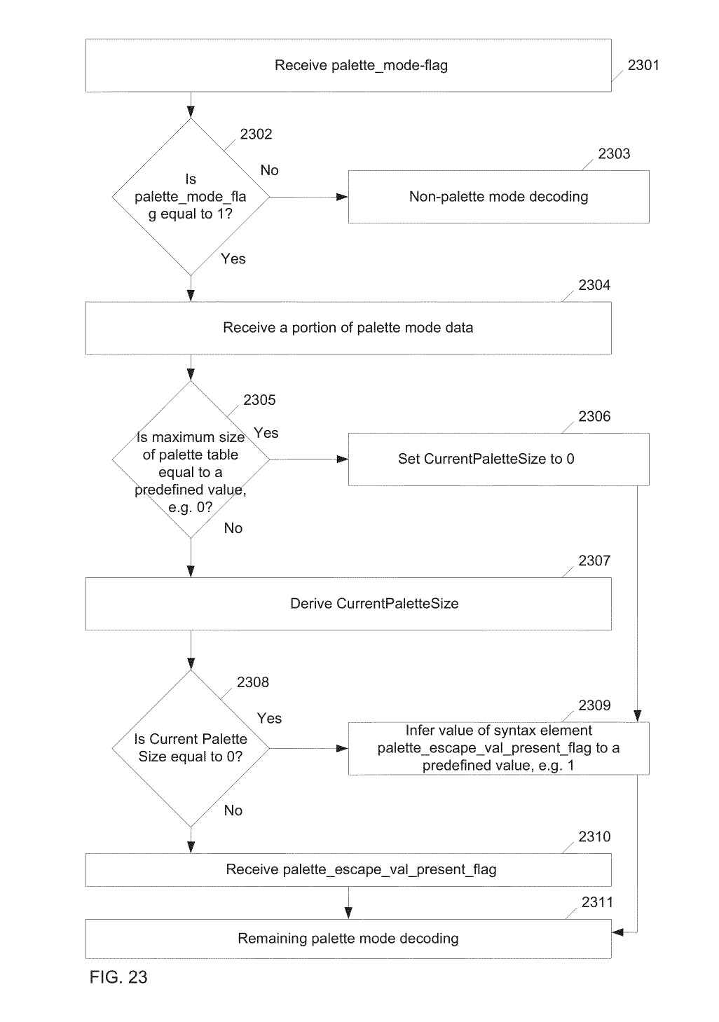

In another example, a decoder may perform some or all of the processes of FIG. 22 and additionally check the value of maximum size of palette table (e.g. palette_max_size) to be equal to a predefined value, e.g. or non-zero. FIG. 23 shows a process that the decoder may be configured to perform in such an example. In diamond 2305, the decoder determines whether the maximum size of palette table is equal to a predefined value, e.g. 0. In some cases, checking the value of maximum size of palette table is equal to the predefined value may avoid requiring computing CurrentPaletteSize, i.e. the process may advance to block 2306 where CurrentPaletteSize is set to 0. In this case, the value of palette_escape_val_present_flag may be inferred if the value of maximum size of palette table is equal to 0.

In another example the signaling in Table (6) may be changed to code some of the syntax elements after subtracting 1 from them. In particular syntax elements palette_max_size, palette_max_predictor_size may be signaled in this way. This can allow only certain values to be signaled for maximum palette table size and maximum palette table predictor size, at the same time it improves the coding efficiency. A modified Table (7) shows such signaling.

TABLE (7)

Descriptor

sps_scc_extensions( ) {

| | |
|---|---|
| ... | |
| palette_mode_enabled_flag | u(1) |
| if( palette_mode_enabled_flag ) { | |

| | |
|---|---|
| palette_max_size_minus1 | ue(v) |
| palette_max_predictor_size_minus1 | ue(v) |

}
...

}

With respect to Table (7)
palette mode enabled, flag equal to 1 may specifies that the palette mode may be used for a block of samples e.g. infra blocks. palette_mode_enabled_flag equal to 0 specifies that the palette mode is not applied. When not present, the value of palette_mode_enabled_flag is inferred to be equal to 0.
palette_max_size_minus1 plus 1 sped fries the maximum allowed palette size. When not present, the value of palette_max_size_minus_1 plus 1 is inferred to be 0.
palette max predictor size minus1 plus 1 specifies the maximum predictor palette size. When not present, the value of palette_max_predictor_size_minus_1 plus 1 is inferred to be 0.

In an example, corresponding to the syntax and semantics of Table (7), the decoder calculates the maximum size of palette table as (palette_max_size_minus1+1) and the maximum size of palette table predictor as (palette_max_predictor_size_minus1+1). Signaling of these elements in such a fashion not only saves the number of bits used within a bitstream for signaling the sizes, but also reduces the amount of data to be processed by the decoder, for e.g. when a value of 1 is signaled using ue(v) binarization for palette_max_size it will require that the decoder process two bits, whereas when the same value of 1 is signaled using ue(v) binarization for palette_max_size_minus1 it will require that the decoder process one bit. Note, using palette_max_size_minus1 and palette_max_predictor_size_minus1 also prevents a bitstream from carrying values of 0 for the maximum palette table size and maximum palette table predictor size. In another example, the maximum size of palette table and the maximum size of palette table predictor may be signaled using syntax elements palette_max_size_minusXX and palette_max_predictor_size_minusYY, where the decoder calculates the maximum size of palette table as (palette_max_size_minusXX+XX) and the maximum size of palette table predictor as (palette_max_predictor_size_minusYY+YY), where XX and YY are integer values greater than or equal to 1 (In an example XX and YY may correspond to same values. In an example XX and YY may correspond to different values).

In an example the previous palette table and the current palette table predictor for the current block of pixels may be different.

In an example the palette table predictor may be generated at least in part by using entries within previous palette table predictor and previous palette table.

In an example the palette table predictor may be generated at least in part by multiplexing a subset of entries within previous palette table predictor and the previous palette table.

In an example the variables associated with the palette table predictor and the entries within a palette table predictor may be set to a predetermined set of values.

In an example the maximum size of a palette table may be signaled in the bitstream (e.g. sequence parameter set). In other words, the maximum size of a palette table may be received by a decoder in the bitstream. In an example the maximum size of a palette table may be derived using past data signaled in the bitstream, i.e. received by a decoder. In an example the maximum size of a palette table may be set to a predetermined value.

In an example the maximum size of a palette table predictor may be signaled in the bitstream (e.g. sequence parameter set), i.e. received by a decoder. In an example the maximum size of a palette table predictor may be derived using past data signaled in the bitstream, i.e. received by a decoder. In an example the maximum size of a palette table predictor may be set to a predetermined value.

An exemplary syntax and semantic where the maximum size of the palette table and the palette table predictor is received in the sequence parameter set is listed below:

TABLE (8)

Descriptor

sps_scc_extensions( ) {

| | |
|---|---|
| ... | |
| palette_mode_enabled_flag | u(1) |
| if( palette_mode_enabled_flag ) { | |

| | |
|---|---|
| palette_max_size | ue(v) |
| palette_max_predictor_size | ue(v) |

}
...

}

Where,
palette_mode_enabled_flag equal to 1 specifies that the palette mode may be used for a block of samples e.g. intra blocks. palette_mode_enabled_flag equal to 0 specifies that the palette mode is not applied. When not present, the value of palette_mode_enabled_flag is inferred to be equal to 0.
palette_max_size specifies the maximum allowed palette size. When not present, the value of palette_max_size is inferred to be 0.
palette_max_predictor_size specifies the maximum palette table predictor size. When not present, the value of palette_max_predictor_size is inferred to be 0.

In an example, the maximum size of the palette table predictor is always greater than or equal to the maximum size of the palette table. In such an event, a bit efficient way to signal maximum size of the palette table predictor is to subtract maximum size of the palette table from it and signal this difference. Note, this difference is always greater than or equal to 0. The decoder then receives the maximum size of the palette table predictor and the signaled difference and recovers the maximum size of the palette table predictor by adding this received difference value to the maximum size of the palette table.

An exemplary syntax and semantic for receiving “the maximum size of the palette table” and “the difference between the maximum size of the palette table and the maximum size of the palette table predictor” is listed below:

TABLE (9)

Descriptor

sps_scc_extensions( ) {

| | |
|---|---|
| ... | |
| palette_mode_enabled_flag | u(1) |
| if( palette_mode_enabled_flag ) { | |

| | |
|---|---|
| palette_max_size | ue(v) |
| delta_palette_max_predictor_size | ue(v) |

}
...

}

Where,
palette_mode_enabled_flag equal to 1 specifies that the palette mode may be used for a block of samples e.g. intra blocks. palette_mode_enabled_flag equal to 0 specifies that the palette mode is not applied. When not present, the value of palette_mode_enabled_flag is inferred to be equal to 0.
palette_max_size specifies the maximum allowed palette size. When not present, the value of palette_max_size is inferred to be 0.
delta_palette_max_predictor_size specifies the difference between the maximum palette table predictor size and the maximum allowed palette size “palette_max_size”. When not present, the value of delta_palette_max_predictor size is inferred to be 0.
The decoder derives the maximum palette table predictor size as the sum of values corresponding to palette_max_size and delta_palette_max_predictor size syntax elements.

In an example, when the maximum allowed palette table size takes on a value from a pre-determined set then the difference between the maximum palette table predictor size and the maximum allowed palette table size is not received in the bitstream by the decoder and is inferred to be a pre-determined value. The conditional signaling of the difference between the maximum palette table predictor size and the maximum allowed palette table size may result in improved coding efficiency.

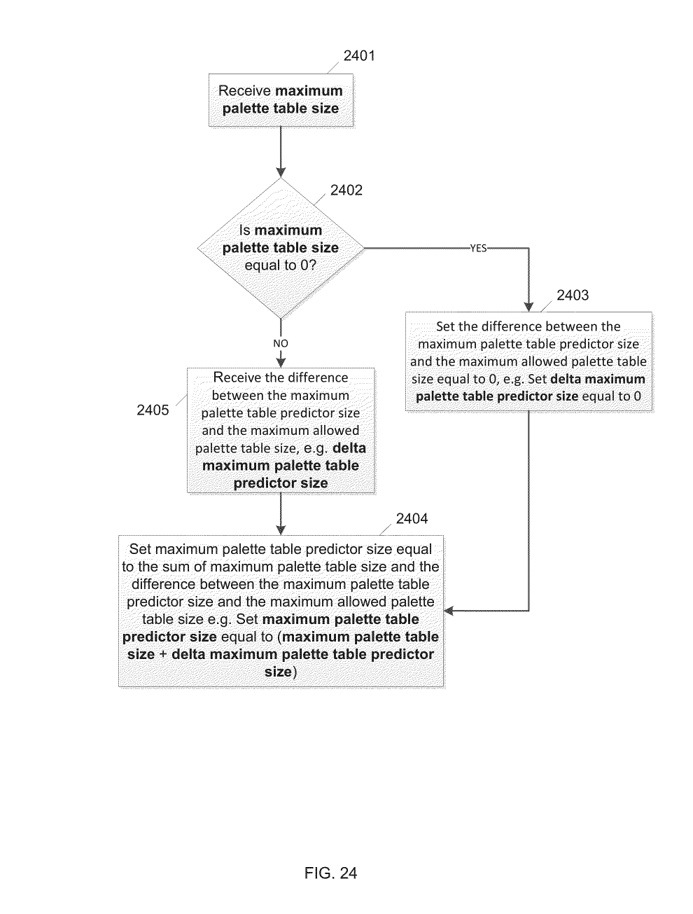

FIG. 24 illustrates an example where the maximum palette table allowed size is checked.

In block 2401, decoder 372 (FIG. 3) of electronic device 370 (FIG. 3) may be configured to recover a maximum palette table size from the bitstream 334 (FIG. 3). In diamond 2402, the decoder 372 may be configured to determine whether the maximum palette table size is equal to zero.

When the maximum allowed palette table size (e.g. palette_max_size) takes on a value zero then the difference (e.g. delta_palette_max_predictor_size) between the maximum palette table predictor size and the maximum allowed palette table size is not received in the bitstream and is inferred to be equal to zero (resulting in greater coding efficiency). The decoder derives the maximum palette table predictor size as the sum of values corresponding to maximum allowed palette table size and, the difference between the maximum palette table predictor size and the maximum allowed palette table size, syntax elements (e.g. palette_max_size+delta_palette_max_predictor size). For instance, in response to determining that the maximum palette table size is equal to zero, in diamond 2402, in block 2403 the decoder 372 may be configured to set the difference between the maximum palette table predictor size and the maximum allowed palette table size equal to zero. In an example, the decoder 372 may set delta maximum palette table predictor size equal to zero. In block 2404, the decoder 372 may he configured to set maximum palette table predictor size equal to the sum of maximum palette table size and the difference between the maximum palette table predictor size and the maximum allowed palette table size. For instance, the decoder 372 may be configured to set maximum palette table predictor size equal to the sum of maximum palette table size and delta maximum palette table predictor size.

In block 2405, the decoder 372 may be configured to recover the difference between the maximum palette table predictor size and the maximum allowed palette table size. For instance, the decoder 372 may be configured to recover the delta maximum palette table predictor size. The decoder 372 may be configured to perform the operation(s) of block 2404 after performing the operation(s) of block 2405.

An exemplary syntax and semantic for receiving the maximum size of the palette table and the difference between the maximum size of the palette table and the maximum size of the palette table predictor is listed below:

TABLE (10)

Descriptor

sps_scc_extensions( ) {

| | |
|---|---|
| ... | |
| palette_mode_enabled_flag | u(1) |
| if( palette_mode_enabled_flag ) { | |

| | |
|---|---|
| palette_max_size | ue(v) |
| if ( palette_max_size != 0 ) | |

| | |
|---|---|
| delta_palette_max_predictor_size | ue(v) |

}
...

}

Where,
palette_mode_enabled_flag equal to 1 specifies that the palette mode may be used for a block of samples e.g. intra blocks. palette_mode_enabled_flag equal to 0 specifies that the palette mode is not applied. When not present, the value of palette_mode_enabled_flag is inferred to be equal to 0.
palette_max_size specifies the maximum allowed palette size. When not present, the value of palette_max_size is inferred to be 0.
delta_palette_max_predictor_size specifies the difference between the maximum palette table predictor size and the maximum allowed palette size “palette_max_size”. When not present, the value of delta_palette_max_predictor_size is inferred to be 0.
   The decoder derives the maximum palette table predictor size as the sum of values corresponding to palette_max_size and delta_palette_max_predictor size syntax elements.

In an example, the syntax elements corresponding to palette enabled flag (e.g. palette_mode_enabled_flag), maximum allowed palette table size (e.g., palette_max_size), maximum allowed palette table predictor size (e.g. delta_palette_max_predictor_size) is received in the picture parameter set. Receiving these palette related syntax elements in the picture parameter set may result in greater flexibility with which pictures may have palette mode enabled or disabled.

In an example, the maximum size of the palette table predictor is always greater than or equal to the maximum size of the palette table. In such an event, the syntax element corresponding to the maximum size of the palette table predictor is restricted to the set of values greater than or equal to the maximum size of the palette table. In an example this restriction corresponds to a bitstream conformance requirement. In an example this restriction is a constraint on the semantics of the syntax element corresponding to the maximum size of the palette table predictor (for e.g., the value of syntax element palette_max_predictor_size shall be greater than or equal to value of syntax element palette_max_size).

In an example when the palette sharing mode is enabled the palette for the current coding unit is derived by copying the first PreviousPaletteSize entries from the palette table predictor.

In the examples herein, coding unit level determination(s) may be made. However, the disclosure is applicable to any block of pixels using palette coding. It should be appreciated by one of ordinary skill in the art that it may be possible and practical to make these determinations at another level than the coding unit level, e.g. the transform unit level, the prediction unit level, the slice level, the picture level, the sequence level, or the like.

The palette coding mode operates on block of pixels in the pixel value domain, while the dequantization and/or scaling of the blocks of pixels used during coding may be designed to operate in another domain, such as a frequency domain. As a result dequantization and/or scaling may associate weights. In an example these weights are dependent on the position of the pixel being decoded within the block of pixel under consideration. These weights may represent values to be multiplied by the corresponding pixel data during the dequantization and/or scaling process. Using dequantization and/or scaling coding operations that are simultaneously operating both in the pixel value domain and a different domain for the same picture are not necessarily compatible with one another, tending to result in image artifacts in the decoded image. To reduce the effects that occur when palette coding is used together with dequantization and/or scaling operations designed to operate in a different domain, it is desirable to include limitations when using the palette coding mode. For example, when a coding unit is being coded using a palette coding technique and (1) the transform block size belongs to a set of particular values (one such set of values may include all transform block sizes) and (2) the coding unit size belongs to a particular set of values (one such set of values may include all coding unit sizes), then it is desirable to modify the coding technique being used. One manner of modifying the coding technique being used is to use pre-determined weights for dequantization and/or scaling. In an example the weights correspond to scaling factors and are derived using scaling lists signaled in the bitstream, the modification would then override the signaled weights with pre-determined values whenever palette coding is used and the associated condition is satisfied.

In an example, this may correspond to setting all the elements of a scaling factor array m[x][y] to a value of 16 during the scaling process for transform coefficients. The use of this modified scaling factor array may be performed when the following conditions are encountered.

(1) the palette coding mode is being used for the current coding unit;

(2) the transform block size is greater than “x”, where x is a constant or x is a value that is determined using data signaled in the past within the bitstream (e.g., x=4);

(3) the coding unit size is greater than “y”, where y is a constant or y is a value that is determined using data signaled in the past within the bitstream (e.g., y=8).

In an example, only when using ESCAPE mode within palette coding, dequantizer capable of using weights are used. During dequantization and/or scaling such examples may use a flat scaling factor array for palette coding, with each element of the scaling factor array set to 16. In an example the scaling factor array corresponds to m[x][y].

It is to be understood that this coding technique may be used for other units of the coded bitstream, such as coded tree blocks (CTBs), transform units, coding units, or otherwise.

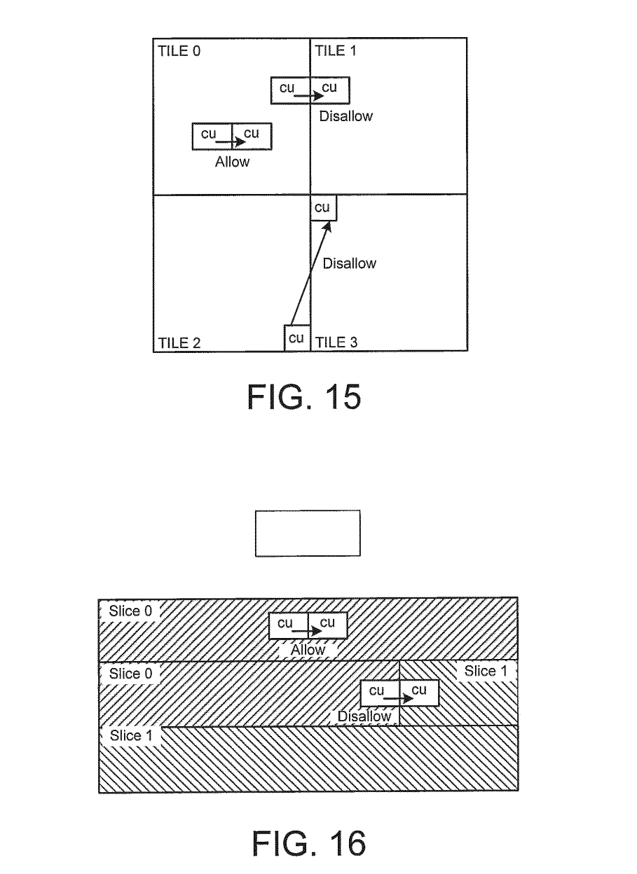

Referring to FIG. 15, the palette coding technique is based, at least in part, upon the prediction of the predicted palette table and/or updated palette table based upon a previous palette table, sometimes referred to as the palette table predictor. The arrows indicate the palette table prediction, and the tile may be composed of a significant number of coding units (e.g., cu). However, tiles which include coding units therein are each decodable in a manner independently of the other tiles. With tiles being decodable in a manner independently of the other tiles, it is desirable to indicate within the syntax that there is no prediction for palette coding permitted across the boundaries between tiles. In an example, the data and pixel values associated with the palette coded coding unit are flagged as unavailable for such boundaries. In an example, the palette table predictor is flagged as unavailable for such boundaries. In an example the palette table predictor is flagged as unavailable using the tile boundary information.

In an example, the palette table predictor is the previously coded palette table. In an example, flagging the palette table predictor as unavailable may be accomplished by setting the variables associated with the palette table predictor to pre-determined values. In an example flagging the palette table predictor as unavailable is accomplished by setting the variable indicating the palette table predictor's size to zero. In an example, flagging the palette table predictor as unavailable is carried out during CABAC initialization since the CABAC is always initialized at the start of a tile. In an example, the variable indicating the palette table predictor's size is set to zero during CABAC initialization since the CABAC is always initialized at the start of a tile.

The use of the term “flagging” may be as a result of signaling a flag within the bitstream, and may be achieved without signaling a flag within the bitstream.

Referring to FIG. 16, the palette coding technique is based, at least in part, upon the prediction of the predicted palette table and/or updated palette table based upon a previous palette table, sometimes referred to as the palette table predictor. However, slices which include coding units therein are each decodable in a manner independently of the other slices. With slices being decodable in a manner independently of the other slices, it is desirable to indicate within the syntax that there is no prediction for palette coding permitted across the boundaries between slices. In an example, the data and pixel values associated with the palette coded coding unit are flagged as unavailable for such boundaries. In an example, the palette table predictor is flagged as unavailable for such boundaries. In an example the palette table predictor is flagged as unavailable using the slice boundary information.

In an example, the palette table predictor is the previously coded palette table. In an example, flagging the palette table predictor as unavailable may be accomplished by setting the variables associated with the palette table predictor to pre-determined values. In an example flagging the palette table predictor as unavailable is accomplished by setting the variable indicating the palette table predictor's size to zero. In an example, flagging the palette table predictor as unavailable is carried out during CABAC initialization since the CABAC is always initialized at the start of a slice. In an example, the variable indicating the palette table predictor's size is set to zero during CABAC initialization since the CABAC is always initialized at the start of a slice.

In an example preventing palette table prediction across tile and slice boundary is achieved by modifying the initialization process of the CABAC parsing process as follows:

Outputs of this process are initialized CABAC internal variables, the initialized Rice parameter initialization states StatCoeff and the palette table predictor variable corresponding to it size previousPaletteSize.

The context variables of the arithmetic decoding engine are initialized as follows:
If the coding tree unit is the first coding tree unit in a tile, the following applies:
   The initialization process for context variables is invoked.
   The variables StatCoeff[k] are set equal to 0, for k in the range 0 to 3, inclusive.
   The variable previousPaletteSize is set equal to 0.
Otherwise, if entropy_coding_sync_enabled_flag is equal to 1 and either CtbAddrInRs % PicWidthInCtbsY is equal to 0 or TileId[CtbAddrInTs] is not equal to TileId[CtbAddrRsToTs[CtbAddrInRs−1]], the following applies:
   The location (xNbT, yNbT) of the top-left luma sample of the spatial neighbouring block T is derived using the location (x0, y0) of the top-left luma sample of the current coding tree block as follows:

(xNbT)=(x0+CtbSizeY, y0+CtbSizeY)
The availability derivation process for a block in z-scan order is invoked with the location (xCurr, yCurr) set equal to (x0, y0) and the neighbouring location (xNbY, yNbY) set equal to (xNbT, yNbT) as inputs, and the output is assigned to availableFlagT.
The synchronization process for context variables is invoked as follows:
   If availableFlagT is equal to 1, the synchronization process for context variables and Rice parameter initialization states is invoked with TableStateIdxWpp, TableMpsValWpp, and TableStatCoeffWpp as inputs.
   Otherwise, the following applies:
      The initialization process for context variables is invoked.
      The variables StatCoeff[k] are set equal to 0, for k in the range 0 to 3, inclusive.
      The variable previousPaletteSize is set equal to 0.
Otherwise, if CtbAddrInRs is equal to slice_segment_address and dependent_slice_segment_flag is equal to i, the synchronization process for context variables and Rice parameter initialization states is invoked with TableStateIdxDs, TableMpsValDs, and TableStatCoeffDs as inputs.
Otherwise, the following applies:
   The initialization process for context variables is invoked.
   The variables StatCoeff[k] are set equal to 0, for k in the range 0 to 3, inclusive.
   The variable previousPaletteSize is set equal to 0.

The initialization process for the arithmetic decoding engine is invoked.

In another example where palette tables corresponding to spatially adjacent are used as predictors, the prediction of palette table across slice and/or tile boundary is prevented by flagging the data and/or pixel values corresponding to the spatially adjacent blocks as unavailable.

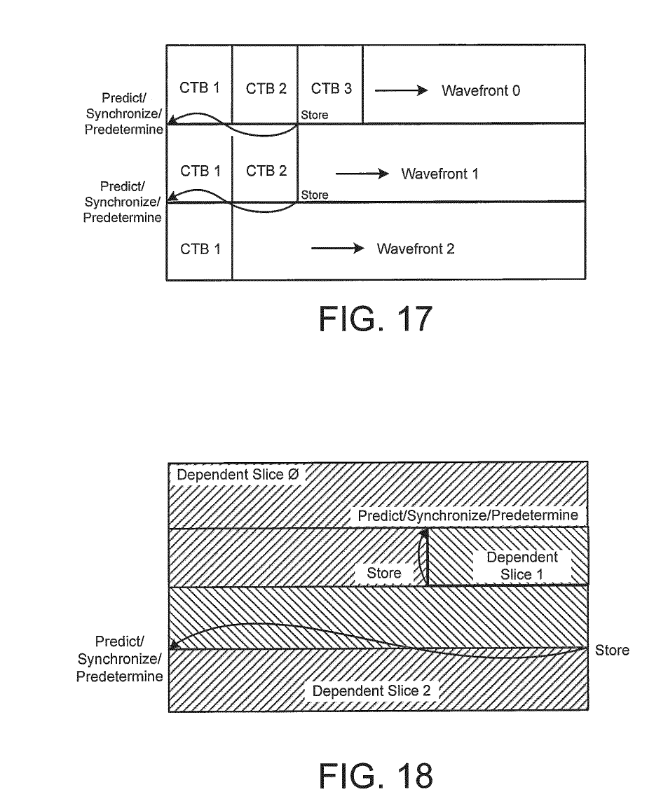

Referring to FIG. 17, the palette coding technique is based, at least in part, upon the prediction of the predicted palette table and/or updated palette table based upon a previous palette table, sometimes referred to as the palette table predictor. However, as a set of coded tree blocks of a plurality of wavefronts are decoded, which include coding units therein, a set of palette tables are generated, predicted, updated for each of the wavefronts. With the subsequent wavefronts starting the decoding process at a later time than the earlier wavefronts, some of the predicted palette tables and/or updated palette tables of an earlier wavefront may be made available for predicting and/or updating a palette table for a subsequent wavefront. In an example, the palette table of one wavefront is stored and used to synchronize (e.g., by being used as a palette table predictor) a subsequent wavefront. In an example, the subsequent wavefront is the wavefront in coding tree block row below. In an example, one wavefront stores a palette table after decoding the coding tree unit which includes the second coding tree block of a row of coding tree blocks, which is used to synchronize a subsequent wavefront, by setting as palette table predictor the stored palette table, before decoding the coding tree unit which includes the first coding tree block of a row of coding tree blocks. In another example, the palette coding technique may initialize to pre-determined values the variables associated with palette table predictor before decoding the first coding unit of the first coded tree block of each wavefront.

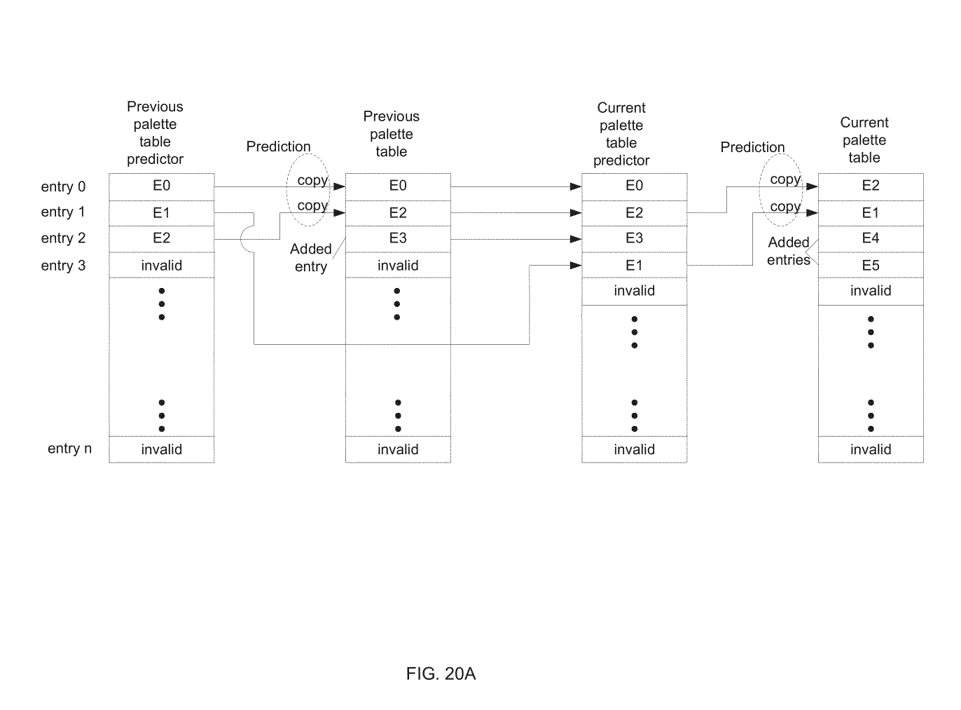

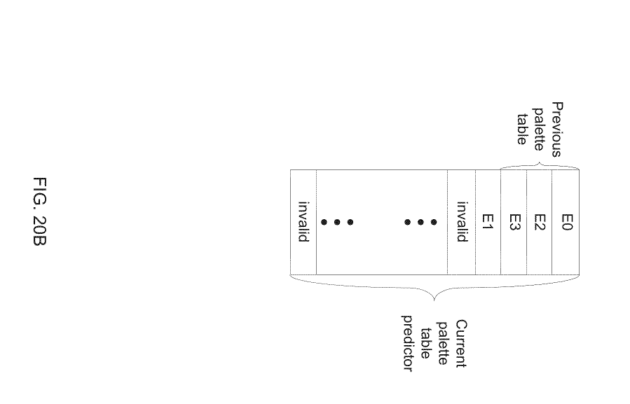

Referring to FIG. 20A, a previous palette table is illustrated as being predicted from a previous palette table predictor. As illustrated, the previous palette table may also be updated with additional entries. Unfilled entries in the previous palette table predictor and previous palette table may include invalid data. As illustrated, the current palette table predictor may then be generated using entries within previous palette table predictor and previous palette table. The current palette table may then be predicted using the current palette table predictor. As illustrated, in an example the prediction of a palette table from a palette table predictor may correspond to copying select entries.

Referring to FIG. 20B, the previous palette table and the current palette table predictor may use the same memory storage area because the entries within previous palette table and the current palette table predictor overlap. The sizes of the previous palette table and current palette table predictor may need to be stored in separate variables to identify which part of the table corresponds to previous palette table predictor and which corresponds to current palette table predictor. In an example, the variables may include PredictorPaletteSizeSync and PreviousPaletteSizeSync. In an example, these variables may be bounded. In an example, PredictorPaletteSizeSync may be equal to Min(MaxStorePaletteSize, PredictorPaletteSize) where MaxStorePaletteSize denotes the maximum size of palette table predictor to be stored. In an example, PreviousPaletteSizeSync may be equal to Min(MaxStorePaletteSize , PreviousPaletteSize) where MaxStorePaletteSize denotes the maximum size of palette table predictor to be stored.

In an example, the current palette table predictor is generated by copying the valid entries within the previous palette table and if more space is available within the current palette table predictor then the entries not used for prediction within the previous palette table predictor are appended to the current palette table predictor one at a time until no further space is available within the current palette table predictor. If after these steps no more still more space is available within the current palette table predictor then it may contain invalid data.

It is to be understood that palette tables and palette table predictors may include data that identify the number of valid entries within these tables.

It is to be understood that palette tables and palette table predictors may include data that identify the maximum number of entries allowed within these tables.

In an example the maximum number of entries allowed within a palette table and a palette able predictor may be different.

In an example the maximum number of entries allowed within a palette table and a palette able predictor may be same.

Referring to FIG. 17, in an example, the palette coding technique is based, at least in part, upon the prediction of a palette table using a palette table predictor. In an example, the palette table predictor may be generated at least in part, based on at least one previously coded palette table, e.g. a plurality of previously coded palette tables or a single previously coded palette table, but in another example the palette table predictor may be generated using pre-determined information. As a set of coded tree blocks of a plurality of wavefronts are decoded, which include coding units therein, a set of palette table predictors are generated, updated for each of the wavefronts. With the subsequent wavefronts starting the decoding process at a later time than the earlier wavefronts, some of the palette table predictors of an earlier wavefront, or a part thereof, may be made available for predicting and/or updating a palette table for a subsequent wavefront. In an example, the palette table predictor of one wavefront, or a part thereof, is stored and used to synchronize (e.g., by being used for prediction of a palette table) a subsequent wavefront.

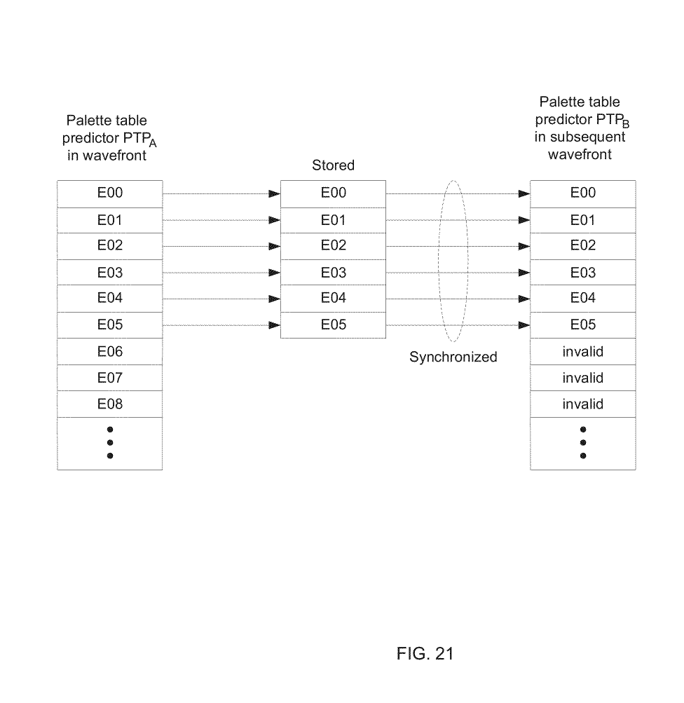

FIG. 21 illustrates an example where a part of palette table predictor PTP_{A} is stored and during synchronization in a subsequent wavefront, the stored entries are copied to generate a palette table predictor PTP_{B}. The remaining entries within palette table predictor PTP_{B} may contain invalid data. In an example the part of palette table predictor stored may correspond to one-half the maximum number of entries allowed within a palette table predictor. In an example the part of palette table predictor stored may correspond to one-fourth the maximum number of entries allowed within a palette table predictor. In an example the part of palette table predictor stored may correspond to a pre-determined number of entries within a palette table predictor. In an example, the part of the palette table predictor stored and synchronized in a subsequent wavefront may correspond to the maximum number of entries allowed within a palette table. In an example, the part of palette table predictor stored and synchronized in a subsequent wavefront may correspond to the larger of the following two values: (i) a predetermined number and (ii) one-half of the maximum number of entries allowed within a palette table predictor. In an example, the part of palette table predictor stored and synchronized in a subsequent wavefront may correspond to any other combination of the above listed numbers. In an example, the part of palette table predictor stored and synchronized in a subsequent wavefront may correspond to a value derived using past data received in the bitstream.

In an example, the size of the palette table predictor stored and synchronized in a subsequent wavefront may be received in the bitstream. In an example, the size of the palette table predictor stored and synchronized in a subsequent waveform may correspond to MaxStorePaletteSize, Min(MaxStorePaletteSize, PredictorPaletteSize), or the like, or combinations thereof. In yet another example, the entries chosen for storage and synchronization in a subsequent wavefront correspond to the first the size of the palette table predictor stored and synchronized in a subsequent wavefront entries of the palette table predictor.

In one example, the size of palette table predictor stored and synchronized in a subsequent wavefront may be bounded by the value of variable MaxStorePaletteSize. For example, referring to FIG. 20B, the size of the current palette table predictor being stored for subsequent wavefront synchronization is determined as the minimum of the following two values: (i) Size of current palette table predictor and (ii) MaxStorePaletteSize. In an example, the value of MaxStorePaletteSize may be derived using past data signaled in the bitstream, i.e. received by a decoder. In an example, the value of MaxStorePaletteSize may be signaled in the bitstream, i.e. received by a decoder.

In an example, when palette sharing mode is enabled, the palette for the current coding unit is derived by copying the first PreviousPaletteSize entries from the palette table predictor. In one example, PreviousPaletteSize corresponds to the size of the previous palette table. As a result, when the palette table predictor is being stored for synchronization with subsequent wavefront, the value of variable PreviousPaletteSize would be stored as well, say as PreviousPaletteSizeSync. If however the size of the table being stored is bounded to be a maximum of MaxStorePaletteSize, then the value stored for subsequent wavefront synchronization “PreviousPaletteSizeSync” is set to a minimum of the following two values: (i) PreviousPaletteSize and (ii) MaxStorePaletteSize.

In an example the palette table predictor PTP_{B} may include part of the palette table predictor PTP_{A} and predetermined palette table predictor values which may be signaled in the bitstream, i.e. received by a decoder. In an example, the subsequent wavefront is the wavefront in coding tree block row below. In an example, one wavefront stores a palette table predictor (e.g. to be used for prediction of palette table by next palette mode coded block of pixels) or a part thereof after decoding the coding tree unit which includes the second coding tree block of a row of coding tree blocks, which is used to synchronize a subsequent wavefront, by deriving as palette table predictor from the stored palette table predictor (e.g. by deriving the current palette table predictor from the stored palette table predictor), before decoding the coding tree unit which includes the first coding tree block of a row of coding tree blocks. In another example, the palette coding technique may initialize to pre-determined values the variables associated with palette table predictor before decoding the first coding unit of the first coded tree block of each wavefront.

In an example decoder pixels coded with ESCAPE mode within the current block of pixels (e.g. current coding unit) may be predicted using pixels coded with ESCAPE mode within the previous block of pixels (e.g. previous coding unit).

In an example, pixels coded with ESCAPE mode within the previous block of pixels may not be available for prediction if the pixel corresponds to a slice that is different than the slice corresponding to the current pixel under consideration.

In an example, pixels coded with ESCAPE mode within the previous block of pixels may not be available for prediction if the pixel corresponds to a tile that is different than the tile corresponding to the current pixel under consideration.

The palette coding technique is based, at least in part, upon the prediction of ESCAPE mode coded pixels. However, as a set of coded tree blocks of a plurality of wavefronts are decoded, which include coding units therein, a set of palette tables are generated, predicted, updated for each of the wavefronts. With the subsequent wavefronts starting the decoding process at a later time than the earlier wavefronts, some of the ESCAPE mode coded pixels of an earlier wavefront may be made available for predicting ESCAPE mode coded pixels of a subsequent wavefront. In an example, the ESCAPE mode coded pixels (e.g. to be used for prediction of ESCAPE mode pixels in the next palette mode coded block of pixels) of one wavefront is stored and used to synchronize (e.g., by being used as an ESCAPE mode coded pixel predictor) a subsequent wavefront. In an example, the subsequent wavefront is the wavefront in coding tree block row below. In an example, one wavefront stores ESCAPE mode coded pixels after decoding the coding tree unit which includes the second coding tree block of a row of coding tree blocks, which is used to synchronize a subsequent wavefront, by setting as ESCAPE mode coded pixel predictor the stored ESCAPE mode coded pixels (e.g. by deriving the current ESCAPE mode coded pixel predictor from the stored ESCAPE mode coded pixels), before decoding the coding tree unit which includes the first coding tree block of a row of coding tree blocks. In another example, the palette coding technique may initialize to pre-determined values the variables associated with ESCAPE mode coded pixel predictor before decoding the first coding unit of the first coded tree block of each wavefront.

Referring to FIG. 18, the palette coding technique is based, at least in part, upon the prediction of the predicted palette table and/or updated palette table based upon a previous palette table. However, as a set of coded tree blocks of a plurality of dependent slices are decoded, which include coding units therein, a set of palette tables are generated, predicted, updated for each of the dependent slices. With the subsequent dependent slices being temporally decoded at a later time than the earlier dependent slices, predicted palette tables and/or updated palette tables of earlier dependent slices may be made available for predicting and/or updating a palette table for subsequent dependent slices. In an example, the predicted palette table and/or updated palette table of one dependent slices is used to synchronize (e.g., by being used as a palette table predictor) a subsequent dependent slice. In another example, the palette coding technique may initialize to pre-determined values the variables associated with palette table predictor, before decoding the first coding unit for the first coded tree block of each dependent slice. In another example, the palette coding technique may store the current palette table at the end of a dependent slice and set it as a palette table predictor before decoding the first coding unit of the first coded tree block of the following dependent slice contained within the same slice.

Referring to FIG. 18, the palette coding technique is based, at least in part, upon the prediction of a palette table using a palette table predictor. In an example, the palette table predictor may be generated at least in part, based on at least one previously coded palette table, e.g. a plurality of previously coded palette tables or a single previously coded palette table, but in another example the palette table predictor may be generated using information besides any previously coded palette tables. However, as a set of coded tree blocks of a plurality of dependent slices are decoded, which include coding units therein, a set of palette table predictors are generated, and/or predicted, and/or updated for each of the dependent slices. With the subsequent dependent slices being temporally decoded at a later time than the earlier dependent slices, palette table predictors and/or updated palette table predictors of earlier dependent slices may be made available for predicting and/or updating a palette table for subsequent dependent slices. In an example, the palette table predictor and/or updated palette table predictor (e.g. to be used for prediction of palette table by next palette mode coded block of pixels) of one dependent slices is used to synchronize (e.g., by being used to derive a palette table predictor at the start of a dependent slice) a subsequent dependent slice. In another example, the palette coding technique may initialize to pre-determined values the variables associated with palette table predictor, before decoding the first coding unit for the first coded tree block of each dependent slice. In another example, the palette coding technique may store the current palette table predictor at the end of a dependent slice and set it as a palette table predictor before decoding the first coding unit of the first coded tree block of the following dependent slice contained within the same slice.

FIG. 21 illustrates an example where a part of palette table predictor PTP_{A} is stored and used during synchronization in a subsequent wavefront. In an example, the same storage and synchronization method is used for a dependent slice, where a part of palette table predictor PTP_{A} is stored for synchronization in a subsequent dependent slice.

It is anticipated that the approaches described above for determining the size of the stored palette table predictor for subsequent wavefront synchronization may be used for determining the size of the stored palette table predictor for subsequent dependent slice synchronization.

It is anticipated that the approaches described above for determining the variables associated with stored palette table predictor for subsequent wavefront synchronization may be used for determining the variables associated with stored palette table predictor for subsequent dependent slice synchronization. In a specific example, the variable includes the PreviousPaletteSizeSync.

In an example, to facilitate palette table prediction for wavefronts and dependent slices, the CABAC initialization is modified. Also modified are the storage and synchronization processes for context variables and rice parameter initialization, to, the storage and synchronization processes for context variables, palette table predictors and rice parameter initialization. Also modified is their corresponding invocation. These modifications result in the following:

While parsing the slice segment data the storage process for context variables and Rice parameter initialization states is applied as follows:

When ending the parsing of the coding tree unit syntax, entropy_coding_sync_enabled_flag is equal to 1, and either CtbAddrInRs % PicWidthInCtbsY is equal to 1 or both CtbAddrInRs is greater than 1 and TileId[CtbAddrInTs] is not equal to TileId[CtbAddrRsToTs[CtbAddrInRs−2]], the storage process for context variables, Palette table predictor, and Rice parameter initialization is invoked with TableStateIdxWpp, TableMpsValWpp, TablePreviousPaletteEntriesWpp, PreviousPaletteSizeWpp, and TableStatCoeffWpp as outputs.

When ending the parsing of the general slice segment data syntax, dependent_slice_segments_enabled_flag is equal to 1 and end_of_slice_segment_flag is equal o 1, the storage process for context variables, Palette table predictor and Rice parameter initialization states is invoked with TableStateIdxDs, TableMpsValDs, TablePreviousPaletteEntriesDs, PreviousPaletteSizeDs, and TableStatCoeffDs as outputs.

The modified initialization process of the CABAC parsing process is as follows:

Outputs of this process are initialized CABAC internal variables, the initialized Rice parameter initialization states StatCoeff and the palette table predictor variable corresponding to its contents, previousPaletteEntries, and to its size, previousPaletteSize.

The context variables of the arithmetic decoding engine are initialized as follows:
If the coding tree unit is the first coding tree unit in a tile, the following applies:
   The initialization process for context variables is invoked.
   The variables StatCoeff[k] are set equal to 0, for k in the range 0 to 3, inclusive.
Otherwise, if entropy_coding_sync_enabled_flag is equal to 1 and either CtbAddrInRs % PicWidthInCtbsY is equal to 0 or TileId[CtbAddrInTs] is not equal to TileId[CtbAddrRsToTs[CtbAddrInRs−1]], the following applies:
   The location (xNbT, yNbT) of the top-left luma sample of the spatial neighbouring block T is derived using the location (x0, y0) of the top-left luma sample of the current coding tree block as follows:

(xNbt, yNbT)=(x0+CtbSizeY, y0−CtbSizeY)
The availability derivation process for a block in z-scan order is invoked with the location (xCurr, yCurr) set equal to (x0, y0) and the neighbouring location (xNbY, yNbY) set equal to (xNbT, yNbT) as inputs, and the output is assigned to availableFlagT.
The synchronization process for context variables is invoked as follows:
   If availableFlagT is equal to 1, the synchronization process for context variables and Rice parameter initialization states is invoked with TableStateIdxWpp, TableMpsValWpp, TablePreviousPaletteEntriesWpp, PreviousPaletteSizeWpp, and TableStatCoeffWpp as inputs.
   Otherwise, the following applies:
      The initialization process for context variables is invoked.
      The variables StatCoeff[k] are set equal to 0, for k in the range 0 to 3, inclusive.
Otherwise, if CtbAddrInRs is equal to slice_segment_address and dependent_slice_segment_flag is equal to 1, the synchronization process for context variables and Rice parameter initialization states is invoked with TableStateIdxDs, TableMpsValDs, TablePreviousPaletteEntriesDs, PreviousPaletteSizeDs, and TableStatCoeffDs as inputs.
Otherwise, the following applies:
   The initialization process for context variables is invoked.
   The variables StatCoeff[k] are set equal to 0, for k in the range 0 to 3, inclusive.

The initialization process for the arithmetic decoding engine is invoked

The storage process for context variables, Palette table predictor and Rice parameter initialization states may be as described below.

Inputs to this process are: The CABAC context variables indexed by ctxTable and ctxIdx. The previous palette table indexed by cIdx and n, and the size of the previous index table. The Rice parameter initialization states indexed by k.

Outputs of this process are: The variables tableStateSync and tableMPSSync containing the values of the variables pStateIdx and valMps used in the initialization process of context variables and Rice parameter initialization states that are assigned to all syntax elements in: General slice segment data syntax, Coding tree unit syntax, Sample adaptive offset syntax, Coding quadtree syntax. Coding unit syntax, Prediction unit syntax, PCM sample syntax, Transform tree syntax, Motion vector difference syntax, Transform unit syntax, Residual coding syntax, except a subset of pre-determined syntax elements. The variables tablePreviousPaletteEntriesSync, PreviousPaletteSizeSync containing the values of the variables previousPaletteEntries[cIdx][n], previousPaletteSize used in the initialization process of context variables, Palette table predictor and Rice parameter initialization states. The variables tableStatCoeffSync containing the values of the variables StatCoeff[k] used in the initialization process of context variables, Palette table predictor and Rice parameter initialization states.

For each context variable, the corresponding entries pStateIdx and valMps of tables tableStateSync and tableMPSSync are initialized to the corresponding pStateIdx and valMps.

For each Previous palette table entry, where cIdx varies from 0 to (ChromaArrayType !=0 ? 2:0), inclusive, and n varies from 0 to previous PaletteSize-1, inclusive, each entry of the table tablePreviousPaletteEntriesSync is initialized to the corresponding value of previousPaletteEntries[cIdx][n].

For each Rice parameter initialization state k, each entry of the table tableStatCoeffSync is initialized to the corresponding value of StatCoeff[k].

The synchronization process for context variables, Palette table predictor and Rice parameter initialization states may be as described below.

The inputs to the process are: The variables tableStateSync and tableMPSSync containing the values of the variables pStateIdx and valMps used in the storage process of context variables that are assigned to all syntax elements in: General slice segment data syntax, Coding tree unit syntax, Sample adaptive offset syntax, Coding quadtree syntax, Coding unit syntax, Prediction unit syntax. PCM sample syntax, Transform tree syntax, Motion vector difference syntax, Transform unit syntax, Residual coding syntax, except a subset of pre-determined syntax elements. The variable tablePreviousPaletteEntriesSync and previousPaletteSizeSync containing the values of the variables previousPaletteEntries[cIdx][n] and previousPaletteSize used in the storage process of context variables, Palette table predictor and Rice parameter initialization states. The variable tableStatCoeffSync containing the values of the variables StatCoeff[k] used in the storage process of context variables, Palette table predictor and Rice parameter initialization states.

Outputs of this process are: The initialized CABAC context variables indexed by ctxTable and ctxIdx. The initialized Previous palette table entries indexed by cIdx and n, and Previous palette table size The initialized Rice parameter initialization states StatCoeff indexed by k.

For each context variable, the corresponding context variables pStateIdx and valMps are initialized to the corresponding entries pStateIdx and valMps of tables tableStateSync and tableMPSSync.

For each Previous palette table entry n, where cIdx varies from 0 to ChromaArrayType !=0 ? 2:0), inclusive, each variable previousPaletteEntries[cIdx][n] is initialized to the corresponding entry of table tablePreviousPaletteEntriesSync. The variable previousPaletteSize is initialized to previousPaletteSizeSync.

For each Rice parameter initialization state, each variable StatCoeff[k] is initialized to the corresponding entry of table tableStatCoeffSync.

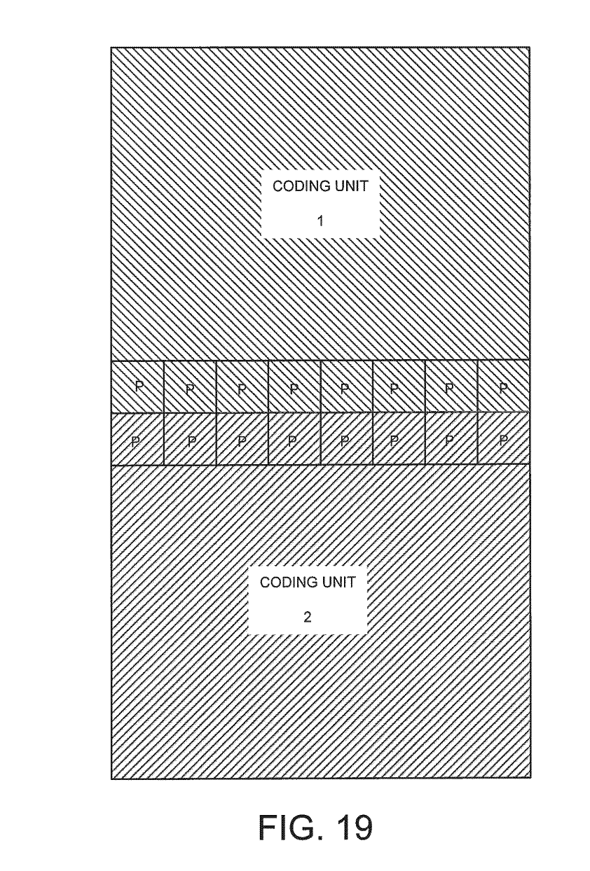

Referring to FIG. 19, it is desirable to permit the COPY_ABOVE _MODE to allow the palette_run_type_flag to be a copy above across coding unit boundaries. The palette_run_type_flag should not permit COPY_ABOVE_MODE across coding unit boundaries when those boundaries are also tile and/or slice boundaries. This limitation may be signaled by not permitting the palette_run_type_flag to take on the value of COPY_ABOVE_MODE in such a circumstance and/or flagging that the block across the tile and/or slice boundary is unavailable and/or setting unavailable pixels across the tile and/or slice boundary to a pre-determined value.

In the examples above the variable previousPaletteSize may be converted to a list that allows more than palette tables to be considered during palette coding for a coding unit. The above examples may in turn be appropriately modified.

In another example, to facilitate that only part of the palette table predictor is stored for wavefront (dependent slice would still store the entire palette table predictor), and using a pre-determined number 32 as the value of variable MaxStorePaletteSize, the CABAC initialization is modified. Also modified are the storage and synchronization processes for context variables and rice parameter initialization, to, the storage and synchronization processes for context variables, palette table predictors and rice parameter initialization. Also modified is their corresponding invocation. These modifications based on the document titled JCTVC-S1005 “HEVC Screen Context Coding draft text 2” (version 1 date Dec. 10, 2014 17:24:57), which is incorporated by reference in its entirety herein, result in the following:

In an example, while parsing the slice segment data the storage process for context variables is applied as follows:
When ending the parsing of the coding tree unit syntax entropy_coding_sync_enabled_flag is equal to 1 and either CtbAddrInRs % PicWidthInCtbsY is equal to 1 or both CtbAddrInRs is greater than 1 and TileId[CtbAddrInTs] is not equal to TileId[CtbAddrRsToTs[CtbAddrInRs−2]], MaxStorePaletteSize is set equal to 32 and the storage process for context variables, Rice parameter initialization states and palette prediction variables is invoked with TableStateIdxWpp, TableMpsValWpp, TableStatCoeffWpp, PredictorPaletteSizeWpp, PreviousPaletteSizeWpp and PredictorPaletteEntriesWpp as outputs.
When ending the parsing of the general slice segment data syntax, dependent_slice_segments_enabled_flag is equal to 1 and end_of_slice_segment_flag is equal to 1. MaxStorePaletteSize is set equal to PredictorPaletteSize and the storage process or context variables, Rice parameter initialization states and palette prediction variables is invoked with TableStateIdxDs, TableMpsValDs, TableStatCoeffDs, PredictorPaletteSizeDs, PreviousPaletteSizeDs and PredictorPaletteEntriesDs as outputs.
   The Storage process for context variables, Rice parameter initialization states and palette prediction variables may be described as follow:
   Inputs to this process are:

The CABAC context variables indexed by ctxTable and ctxIdx.

The Rice parameter initialization states indexed by k.

The palette prediction variables, PredictorPaletteSize, PreviousPaletteSize and PredictorPaletteEntries.

The variable MaxStorePaletteSize.

Outputs of this process are:

The initialized CABAC context variables indexed by ctxTable and ctxIdx.

The initialized Rice parameter initialization states StatCoeff indexed by k.

The palette prediction variables, PredictorPaletteSize, PreviousPaletteSize and PredictorPaletteEntries.
For each context variable, the corresponding context variables pStateIdx and valMps are initialized to the corresponding entries pStateIdx and valMps of tables tableStateSync and tableMPSSYnc.
For each Rice parameter initialization state, each variable StatCoeff[k] is initialized to the corresponding entry of table tableStatCoeffSync.
For palette prediction variables, PredictorPaletteSizeSync is initialized to Min(MaxStorePaletteSize, PredictorPaletteSize); PreviousPaletteSizeSync is initialized to Min(MaxStorePaletteSize, PreviousPaletteSize). For tablePredictorPaletteEntriesSync, each of the first PredictorPaletteSizeSync entries is initialized to the corresponding value of PredictorPaletteEntries.
Note: The synchronization process uses the stored values, sizes etc. for synchronization. Hence the change in number of entries stored does not need to be reflected on the synchronization process.

In other examples, the MaxStorePaletteSize in the above draft text may be of other values discussed herein. For example, MaxStorePaletteSize may be dependent on maximum number of entries allowed within a palette table predictor (e.g. palette_max_predictor_size>>1, Max(pre-determined number, palette_max_predictor_size>>1)), or dependent on maximum number of entries allowed within a palette table (e.g. palette_max_size+1), or may be a pre-determined number, or a number signaled in a bitstream (i.e. received by a decoder), or a combination of the above.

In an example, a palette table predictor initializer is received in a parameter set e.g. picture parameter set, sequence parameter set, video parameter set (VPS) or slice segment header. A palette table predictor initializer may include:
A presence flag indicating if data corresponding to the palette table predictor initializer is to be received in the parameter set
Bit depth indication for luma entries
Bit depth indication for chroma entries
Size (entry) indicating the number of palette entries within the palette table predictor initializer
A set of values corresponding to each palette entry for the different colour components
Or the like, or combinations thereof.

In an example, an indicator may be received by the decoder that identifies pre-determined values for the palette table predictor initializer. The entry(s) for which pre-determined values are identified by the indicator may not be received in the bitstream by the decoder.

In an example, an indicator may be received by the decoder that identifies pre-determined values for part of the palette table predictor initializer. The entry(s) for which pre-determined values are identified by the indicator may not be received in the bitstream by the decoder.

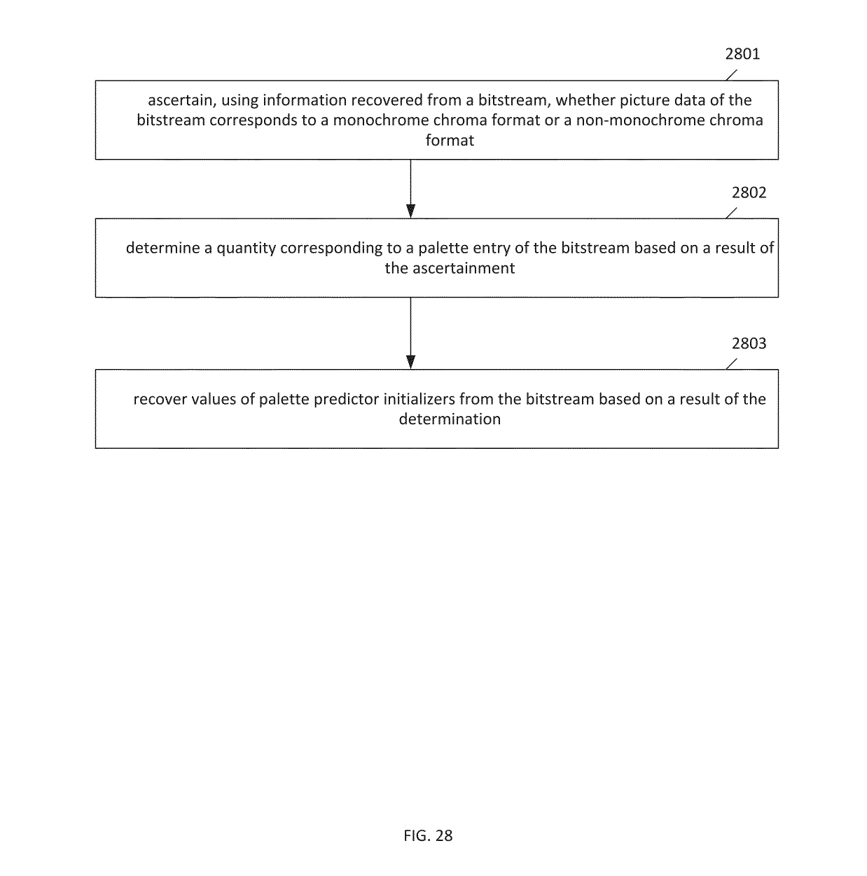

In an example the number of values received corresponding to each palette entry within the palette table predictor initializer for the different colour components may depend on the chroma format of the picture being decoded. In an example, for a monochrome picture (e.g. 4:0:0 or a picture where colour planes are coded separately) the number of values received corresponding to each palette entry within the palette table predictor initializer would be 1. This reduced signaling of syntax elements in the bitstream may result in improved coding efficiency. In an example, for a non-monochrome picture the number of values received corresponding to each palette entry within the palette table predictor initializer would be 3. In FIG. 28, an example decoder may be configured to ascertain (block 2801), using information recovered from a bitstream, whether picture data of the bitstream corresponds to a monochrome chroma format or a non-monochrome chroma format, to determine (block 2802) a quantity corresponding to a palette entry of the bitstream based on a result of the ascertainment; and to recover (block 2803) values of palette predictor initializers from the bitstream based on a result of the determination. A quantity of the palette predictor initializers may be determined by the num_palette_initializer_minus1 value signaling in the bitstream and the monochrome_palette_flag. The decoder may recover a picture from the bitstream and perform at least one of storing the picture in an electronic memory or causing the picture to be displayed on an electronic display after recovering the values of the palette predictor initializers. In an example, the decoder may be configured to determine a value of one for said quantity in response to ascertaining that the picture data of the bitstream corresponds to the monochrome chroma format. In an example, the decoder may be configured to determine a value of three for said quantity in response to ascertaining that the picture data of the bitstream corresponds to the non-monochrome chroma format.

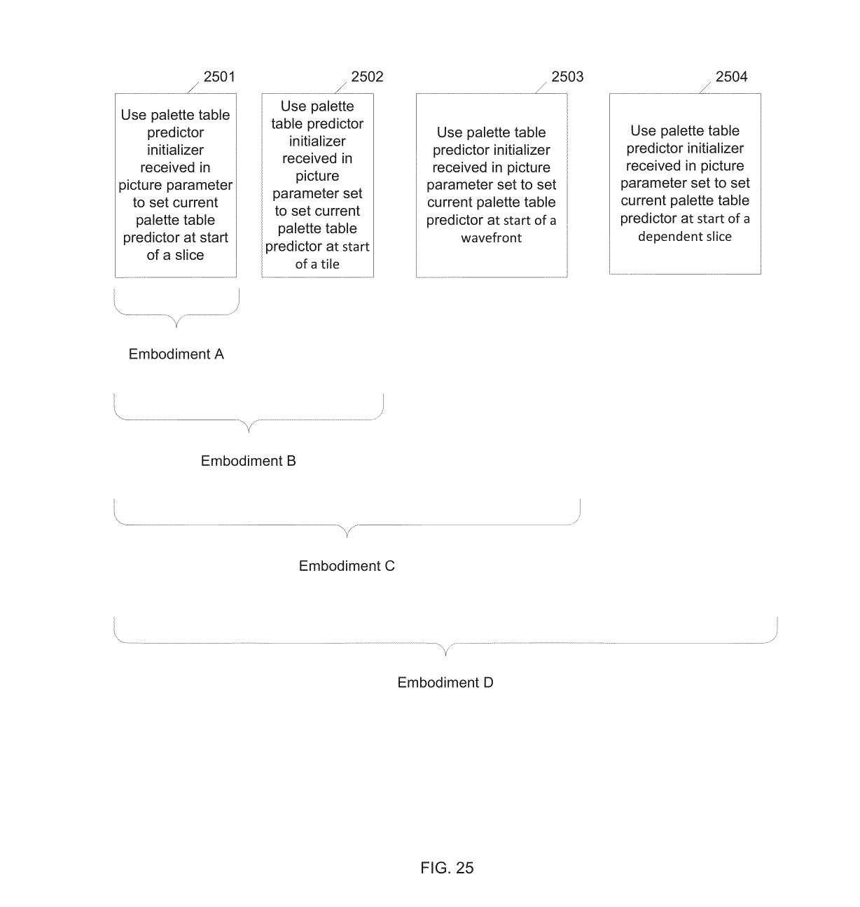

FIG. 25 illustrates examples of subsets of start of slice, start of tile, start of wavefront, and start of dependent slice. In example A, the palette table predictor initializer received in PPS is used to set the current palette table predictor at start of a slice (2501). In example B, the palette table predictor initializer received in ITS is used to set the current palette table predictor at start of a slice (2501) and at start of a tile (2502). In example C, the palette table predictor initializer received in PPS is used to set the current palette table predictor at start of a slice (2501) and at start of a tile (2502) and at start of a wavefront (2503). In example D, the palette table predictor initializer received in PPS is used to set the current palette table predictor at start of a slice (2501) and at start of a tile (2502) and at start of a wavefront (2503) and at start of dependent slice (2504). Note, the palette table predictor initializer may be received in any suitable location within the Bitstream instead of the PPS, e.g. SPS, Slice header. Note, other examples are envisioned where the received palette table predictor initializer is used to set the current palette table predictor for any of the subsets of: start of slice, start of tile, start of wavefront, and start of dependent slice.

An exemplary syntax and semantic for receiving a palette table predictor initializer in a picture parameter set is listed below:

TABLE (11)

| | | Descriptor |
|---|---|---|
| pps_scc_extensions( ) { | | |
| ... | | ... |
| | palette_predictor_initializer_present_flag | u(1) |
| | if( palette_predictor_initializer_present_flag ) { | |

| | |
|---|---|
| luma_bit_depth_entry_minus8 | ue(v) |
| chroma_bit_depth_entry_minus8 | ue(v) |
| palette_predictor_initializer_size_minus1 | ue(v) |
| for( i = 0; i <= | |
| palette_predictor_initializer_size_minus1; i++ ) | |

for( comp = 0; comp < 3; comp++ )

| | |
|---|---|
| palette_predictor_initializer[ i ][ comp ] | u(v) |

}

...
}

Where,
palette_predictor_initializer_present_flag equal to 1 specifies that the palette table predictor initializer is present in the current picture parameter set. palette_predictor_initializer_present_flag equal to 0 specifies that the palette table predictor initializer is not present in the current picture parameter set.
palette_predictor_initializer_size_minus1 specifies the number of entries in the palette table predictor initializer. The variable corresponding to the number of entries in the palette table predictor initializer, NumPalettePredictorEntries, is derived as follows:

NumPalettePredictorEntries=palette_predictor_initializer_size_minus1+1
In an example, it is a requirement of bitstream conformance that the value of NumPalettePredictorEntries shall be less than or equal to the maximum palette table predictor size of any picture that refers to this picture parameter set.
luma_bit_depth_entry_minus8 specifies the sample bit depth of the luma component of the entries of the palette table predictor initializer. The variable corresponding to the sample bit depth of the luma component of the entries of the palette table predictor initializer, BitDepthEntryY, is derived as follows:

BitDepthEntryY=8+luma_bit_depth_entry_minus8
In an example, it is a requirement of bitstream conformance that the value of BitDepthEntryY shall be equal to the bit depth of the luma components of any picture that refers to this picture parameter set.
chroma_bit_depth_entry_minus8 specifies the sample bit depth of the chroma components of the entries of the palette predictor initializer. The variable corresponding to the sample bit depth of the chroma components of the entries of the palette predictor initializer, BitDepthEntryC, is derived as follows:

BitDepthEntryC=8+chroma_bit_depth_entry_minus8
In an example, it is a requirement of bitstream conformance that the value of BitDepthEntryC shall be equal to the bit depth of the chroma components of any picture that refers to this picture parameter set.
palette_predictor_initializer[i][comp] contains i-th palette table predictor entry corresponding to the colour component comp. BitDepthEntryY specifies the number of bits of each luma entry. BitDepthEntryC specifies the number of bits for each chroma entry.

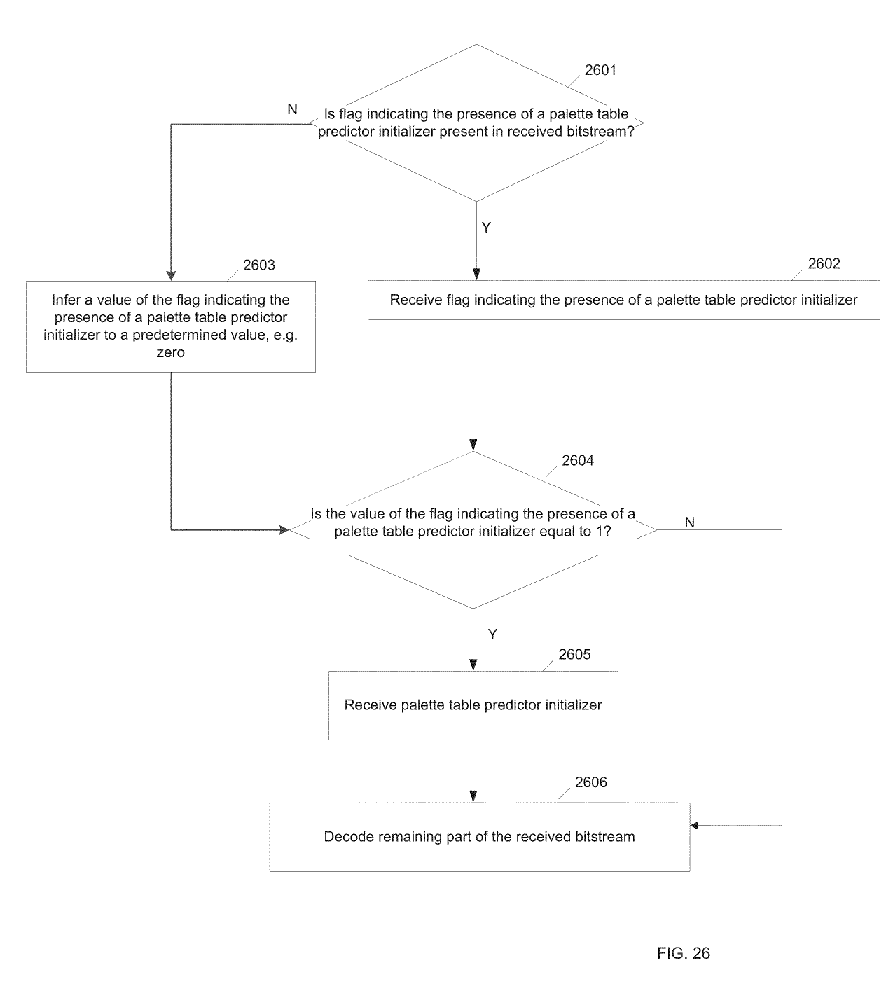

FIG. 26 illustrates an example where the presence of a palette table predictor initializer in a bitstream is checked.

In an example, the value of the flag that indicates the presence of a palette table predictor initializer (e.g. palette_predictor_initializer_present_flag) in a parameter set (e.g. PPS, SPS, VPS) or slice segment header is inferred to a pre-determined value (e.g. 0) when the flag is not received. In diamond 2601, the decoder 372 (FIG. 3) may be configured to determine whether a flag indicating the presence of a palette table predictor initializer is present in a received bitstream. In block 2603, the decoder 372 may infer a value of the flag indicating the presence of a palette table predictor initializer to a predetermined value, e.g., zero, which may result in improved coding efficiency, otherwise in block 2602 the decoder 372 may receive the flag indicating the presence of a palette table predictor initializer. In diamond 2604, the decoder 372 may determine whether the flag indicating the presence of a palette table predictor initializer is equal to a pre-determined value e.g. 1. In block 2605 the decoder 372 may receive the palette table predictor initializer. In block 2606, the decoder may decode the remaining part of the received bitstream.

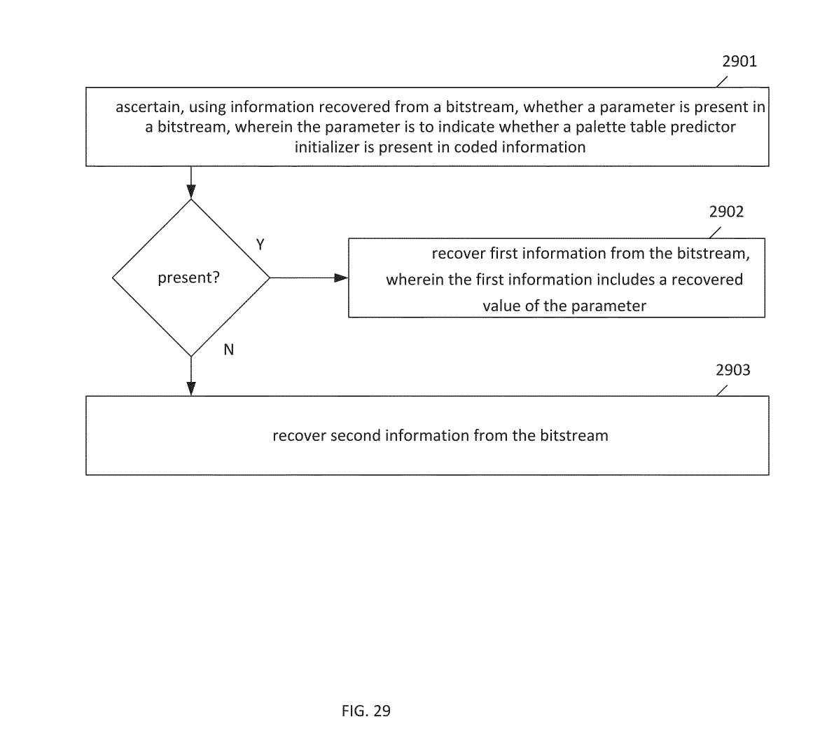

In FIG. 29, a decoder may be configured to ascertain (block 2901), using information recovered from a bitstream, whether a parameter is present in a bitstream, wherein the parameter is to indicate whether a palette table predictor initializer is present in coded information; recover (block 2902) first information from the bitstream in response to an ascertainment that the parameter is present in the bitstream (the first information may include a recovered value of the parameter); recover (block 2903) second information from the bitstream, wherein the second information is different than the first information in response to an ascertainment that the parameter is not present in the bitstream. The decoder may be perform at least one of storing the picture in an electronic memory or causing the picture to be displayed on an electronic display after recovering the first information.

In an example, the first information includes a recovered value of the parameter. In an example, the decoder may be configured to recover the second information using a predetermined value for the parameter. In an example, the decoder may be configured to recover sample information for an entire parameter set using the predetermined value for the parameter in response to the ascertainment that the parameter is not present in the bitstream. In an example, the parameter set includes at least one of a picture parameter set (PPS) or a sequence parameter set (SPS).

An exemplary syntax and semantic for inferring the value of flag indicating the presence of a palette table predictor initializer in a picture parameter set when the flag is not received is listed below:

TABLE (12)

| | Descriptor |
|---|---|
| pps_scc_extensions( ) { | |
| ... | ... |

if ( palette_mode_enabled_flag )

| | |
|---|---|
| palette_predictor_initializer_present_flag | u(1) |

}

...

Where,
palette_mode_enabled_flag equal to 1 may specify that the palette mode may be used for a block of samples e.g. intra blocks, palette_mode_enabled_flag equal to 0 may specify that the palette mode is not applied
palette_predictor_initializer_present_flag equal to 1 specifies that the palette table predictor initializer is present in the current picture parameter set. palette_predictor_initializer_present_flag equal to 0 specifies that the palette table predictor initializer is not present in the current picture parameter set. When not present, the value of palette_predictor_initializer_present_flag is inferred to be equal to 0.

In an example, a palette table predictor initializer is received in a parameter set (or slice segment header) only if the palette mode is enabled (for e.g. value of syntax element palette_mode_enabled_flag is equal to 1). When the palette table predictor initializer is not received in the bitstream it may improve coding efficiency.

An exemplary syntax and semantic for receiving a palette table predictor initializer in a picture parameter set only when palette mode is enabled, is listed below:

TABLE (13)

| | Descriptor |
|---|---|
| pps_scc_extensions( ) { | |
| ... | ... |

if (palette_mode_enabled_flag) {

| | |
|---|---|
| palette_predictor_initializer_present_flag | u(1) |
| if( palette_predictor_initializer_present_flag ) { | |

| | |
|---|---|
| luma_bit_depth_entry_minus8 | ue(v) |
| chroma_bit_depth_entry_minus8 | ue(v) |
| palette_predictor_initializer_size_minus1 | ue(v) |
| for( i = 0; i <= | |
| palette_predictor_initializer_size_minus1; | |
| i++ ) | |

for( comp = 0; comp < 3; comp++ )

| | |
|---|---|
| palette_predictor_initializer[ i ][ | u(v) |
| comp ] | |

}

}

...
}

In an example, there may be a requirement of bitstream conformance that when palette mode is disabled e.g. palette_mode_enabled flag is equal to 0) then the flag indicating the presence of palette table predictor initializer (e.g. palette_predictor_initializer_present_flag) in a parameter set (e.g. PPS, VPS, SPS) shall be equal to a pre-determined value (e.g. 0), indicating that the palette table predictor initializer is not present in the parameter set.

In an example, there may be a requirement of bitstream conformance that when palette mode is disabled (e.g. palette_mode_enabled flag is equal to 0) then the flag indicating the presence of palette table predictor initializer (e.g. palette_predictor_initializer_present_flag) in a slice segment header shall be equal to a pre-determined value (e.g. 0), indicating that the palette table predictor initializer is not present in the slice segment header.

In an example, a flag indicating the presence of a palette table predictor initializer is received only if the maximum allowed palette table predictor size is not equal to zero. In an example, when the flag indicating the presence of a palette table predictor initializer is not received its value is inferred to be equal to zero.

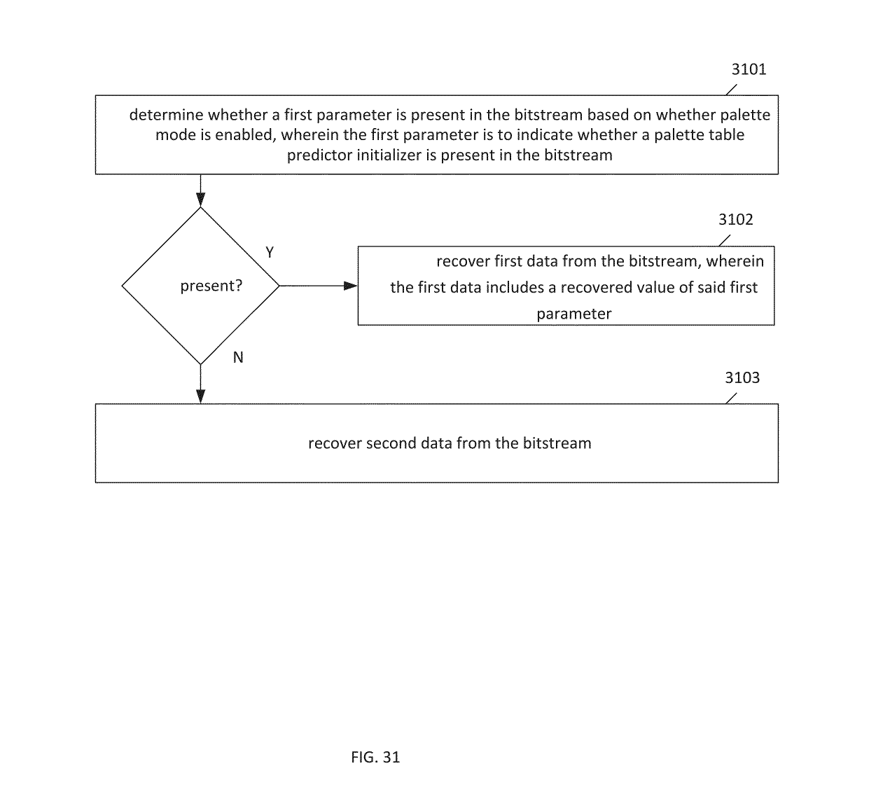

In an example, a palette table predictor initializer is received in a parameter set (or slice segment header) only if the maximum allowed palette table predictor size is not equal to pre-determined value(s) (e.g. 0). When the palette table predictor initializer is not received in the bitstream it may improve coding efficiency. In FIG. 31, a decoder may be configured to determine (block 3101) whether a first parameter is present in the bitstream based on whether palette mode is enabled, wherein the first parameter is to indicate whether a palette table predictor initializer is present in the bitstream; recover (block 3102) first data from the bitstream in response to a determination that the first parameter is present in the bitstream; recover (block 3103) second data from the bitstream in response to a determination that the first parameter is not present in the bitstream, wherein the second data is different than the first data. The decoder may be configured to recover a picture from the bitstream after recovering the first data, and recovering and performing at least one of storing the picture in an electronic memory or causing the picture to be displayed on an electronic display.

In an example, the first data includes a recovered value of said first parameter. In an example, said portion of the bitstream corresponds to at least one of a parameter set of the bitstream or slice segment header of the bitstream. In an example, the decoder may be configured to recover a second parameter from the bitstream, wherein the second parameter corresponds to palette mode enabled flag; ascertain that the palette mode is enabled for recovery of the portion of the bitstream based responsive to a value of the second parameter being equal to one.

An example syntax and semantic for receiving a palette table predictor initializer in a parameter set only if the maximum allowed palette table predictor size is not equal to 0, is listed below:

TABLE (14)

| | Descriptor |
|---|---|
| pps_scc_extensions( ) { | |
| ... | ... |

if (PaletteMaxPredictorSize != 0) {

| | |
|---|---|
| palette_predictor_initializer_present_flag | u(1) |
| if( palette_predictor_initializer_present_flag ) { | |

| | |
|---|---|
| luma_bit_depth_entry_minus8 | ue(v) |
| chroma_bit_depth_entry_minus8 | ue(v) |
| palette_predictor_initializer_size_minus1 | ue(v) |
| for( i = 0; i <= | |
| palette_predictor_initializer_size_minus1; | |
| i++ ) | |

for( comp = 0; comp < 3; comp++ )

| | |
|---|---|
| palette_predictor_initializer[ i ][ | u(v) |
| comp ] | |

}

}

...
}

Where, the variable PaletteMaxPredictorSize denotes the maximum allowed palette table predictor size.

In an example, there may be a requirement of bitstream conformance that when maximum allowed palette table predictor size is equal to a pre-determined value (e.g. 0) then the flag indicating the presence of palette table predictor initializer (e.g. palette_predictor_initializer_present_flag) in a parameter set (e.g. PPS, VPS, SPS) shall be equal to a pre-determined value (e.g. 0), indicating that the palette table predictor initializer is not present in the parameter set.

In an example, there may be a requirement of bitstream conformance that when maximum allowed palette table predictor size is equal to a pre-determined value (e.g. 0) then the flag indicating the presence of palette table predictor initializer (e.g. palette_predictor_initializer_present_flag) in a slice segment header shall be equal to a pre-determined value (e.g. 0), indicating that the palette table predictor initializer is not present in the slice segment header.

In an example, a flag indicating the presence of a palette table predictor initializer is received only if the maximum allowed palette table size is not equal to zero. In an example, when the flag indicating the presence of a palette table predictor initializer is not received its value is inferred to be equal to zero.

In an example, a palette table predictor initializer is received in a parameter set (or slice segment header) only if the maximum allowed palette table size (e.g. palette_max_size) not equal to pre-determined value(s) (e.g. 0). When the palette table predictor initializer is not received in the bitstream it may improve coding efficiency.

An example syntax and semantic for receiving a palette table predictor initializer in a parameter set only if the maximum allowed palette table size is not equal to 0, is listed below:

TABLE (15)

| | Descriptor |
|---|---|
| pps_scc_extensions( ) { | |
| ... | ... |

if (palette_max_size != 0) {

| | |
|---|---|
| palette_predictor_initializer_present_flag | u(1) |
| if( palette_predictor_initializer_present_flag ) { | |

| | |
|---|---|
| luma_bit_depth_entry_minus8 | ue(v) |
| chroma_bit_depth_entry_minus8 | ue(v) |
| palette_predictor_initializer_size_minus1 | ue(v) |
| for( i = 0; i <= | |
| palette_predictor_initializer_size_minus1; | |
| i++ ) | |

for( comp = 0; comp < 3; comp++ )

| | |
|---|---|
| palette_predictor_initializer[ i ][ | u(v) |
| comp ] | |

}

}

...
}

Where, palette_max_size denotes the maximum allowed palette table size.

In an example, there may be a requirement of bitstream conformance that when maximum allowed palette table size (e.g. palette_max_size) is equal to a pre-determined value (e.g. 0) then the flag indicating the presence of palette table predictor initializer (e.g. palette predictor _initializer_present_flag) in a parameter set (e.g. PPS, VPS, SPS) shall be equal to a pre-determined value (e.g. 0), indicating that the palette table predictor initializer is not present in the parameter set.

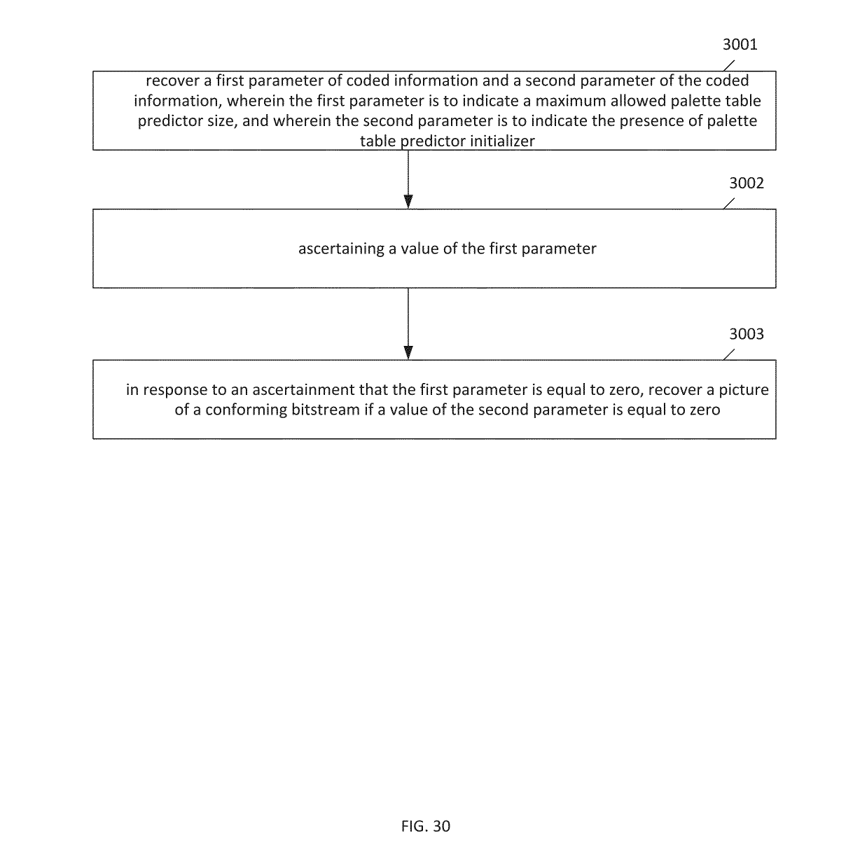

In FIG. 30, a decoder may be configured to recover (block 3001) a first parameter of coded information and a second parameter of the coded information, wherein the first parameter is to indicate a maximum allowed palette table predictor size, and wherein the second parameter is to indicate the presence of palette table predictor initializer; ascertain (block 3002) a value of the first parameter; recover (block 3003) a picture of a conforming bitstream if a value of the second parameter is equal to zero in response to an ascertainment that the first parameter is equal to zero. The decoder may be configured to performing at least one of storing the picture in an electronic memory or causing the recovered picture to be displayed on an electronic display after recovering the picture of the conforming bitstream.

In an example, there may be a requirement of bitstream conformance that when maximum allowed palette table size (e.g. palette_max_size) is equal to a pre-determined value (e.g. 0) then the flag indicating the presence of palette table predictor initializer (e.g. palette_predictor_initializer_present_flag) in a slice segment header shall be equal to a pre-determined value (e.g. 0), indicating that the palette table predictor initializer is not present in the slice segment header.

In an example, a palette table predictor initializer is received in a parameter set (or slice segment header) only if the following conditions are met:
Palette mode is enabled (e.g. palette_mode_enabled flag is equal to 1)
Maximum palette size is not equal to zero (e.g. palette_max_size is not equal to 0)
Maximum palette predictor size is not equal to zero.

In another example, a subset of the three conditions listed above need to be met before a palette table predictor initializer is received in a parameter set (or slice segment header). When the palette table predictor initializer is not received in the bitstream it may improve coding efficiency.

### EXAMPLES

In an example, a decoder stores a partial palette table predictor and synchronizes a subsequent dependent slice using partial palette table predictor. In an example, a size of partial palette table predictor stored is pre-determined. In an example, a size of partial palette table predictor stored is derived from past data signaled in the bitstream, i.e. received by a decoder.

The decoder may be configured to: select a subset of entries of a palette table predictor, wherein the palette table predictor is associated with a wavefront; store the selected subset of the entries of the palette table predictor in a memory device; and synchronize a subsequent wavefront using the stored selection, wherein the synchronization includes deriving a palette table predictor for the subsequent wavefront based on the entries of the stored selection. Deriving the palette table predictor for the subsequent wavefront may include: copy data of each entry of the stored selection into a corresponding entry of the palette table predictor for the subsequent wavefront.

The decoder may be configured to copy invalid data into any remaining entries of the palette predictor for the subsequent wavefront.

The decoder may be configured to identify a count of the corresponding entries having the data copied therein.

The decoder may be configured to select the subset of entries of the palette table predictor comprises selecting the subset of entries of the palette table predictor includes: determine a signaling value received in the bitstream; and select the subset of entries of the palette table predictor based on the determined signaled value.

The decoder may be configured to select the subset of entries of the palette table predictor comprises selecting the subset of entries of the palette table predictor based on a predetermined value.

In an example, decoder is provided. The decoder may be configured to select a subset of entries of a palette table predictor, wherein the palette table predictor is associated with at least one of a wavefront or a dependent slice; store the selected subset of the entries of the palette table predictor in a memory device; and synchronize a subsequent dependent slice using the stored selection, wherein the synchronization includes deriving a palette table predictor for the subsequent dependent slice based on the entries of the stored selection. In an example, deriving the palette table predictor for the subsequent dependent slice includes: copy data of each entry of the stored selection into a corresponding entry of the palette table predictor for the subsequent dependent slice.

In an example, selecting the subset of entries of the palette table predictor comprises selecting the subset of entries of the palette table predictor includes: determine a signaling value received in the bitstream; and select the subset of entries of the palette table predictor based on the determined signaled value.

In an example, selecting the subset of entries of the palette table predictor comprises selecting the subset of entries of the palette table predictor based on a predetermined value.

In an example, a decoder that receives the maximum size of the palette table, and receives the maximum size of the palette table predictor as the difference with respect to the maximum size of the palette table. The decoder is configured to calculate the maximum size of the palette table predictor as the sum of the received difference and maximum size of the palette table. In an example, the decoder operates according to a bitstream conformance requirement that restricts the value of the maximum size of the palette table predictor to be larger than the maximum size of the palette table. In an example, the decoder operates according to a semantic constraint that restricts the value of the maximum size of the palette table predictor to be larger than the maximum size of the palette table.

The decoder may be configured to recover a first value from a received bitstream, wherein the first value comprises a maximum size of a palette table; recover a second value from the received bitstream, wherein the second value comprises difference value; and deriving a third value based on the first and second values, wherein the third value comprises a maximum size of the palette table predictor.

In an example, deriving the third value based on the first and second values further comprises summing the first and second values.

In an example, the decoder is further configured to: determining whether the first value is equal to zero; recovering the second value from the received bitstream only in response to determining that the first value is not equal to zero; and in response to determining that the first value is equal to zero, infer the second value equal to zero.

In an example, a decoder is provided. The decoder may be configured to: recover information of a bitstream, wherein the recovered information includes a palette_mode_flag value; determine whether the palette_mode_flag value is equal to one; in response to determining that the palette_mode_flag value is equal to one, determining whether CurrentPaletteSize is equal to zero; in response to determining that CurrentPaletteSize is not equal to zero, set a value of palette_escape_val_present_flag based on remaining information of the bitstream; in response to determining that Current PaletteSize is equal to zero, set the value of syntax element palette_escape_val_present_flag independently of the remaining information of the bitstream.

In an example, setting the value of syntax element palette_escape_val_present_flag independently of the remaining information of the bitstream further comprises inferring the value of syntax element palette_escape_val_present_flag based on past data received by the decoder.

In an example, inferring the value of syntax element palette_escape_val_present_flag based on past data received by the decoder further comprises setting the value of syntax element palette_escape_val_present_flag to a predefined value.

In an example, the decoder is further configured to: in response to determining that the palette_mode_flag value is equal to one, determining whether a maximum size of a palette table is equal to a predefined value; in response to determining that the maximum size of the palette table is not equal to the predefined value, deriving the CurrentPaletteSize prior to determining whether the CurrentPaletteSize is equal to zero; in response to determining that the maximum size of the palette table is equal to the predefined value, setting the CurrentPaletteSize equal to zero and, responsive to setting the CurrentPaletteSize equal to zero, setting the value of syntax element palette_escape_val_present_flag independently of the remaining information of the bitstream.

In an example, setting the CurrentPaletteSize equal to zero and, responsive to setting the CurrentPaletteSize equal to zero, setting the value of syntax element palette_escape_val_present_flag independently of the remaining information of the bitstream bypasses at least one computing cycle associated with determining whether the CurrentPaletteSize is equal to zero.

In an example, determining whether CurrentPaletteSize is equal to zero in response to determining that the palette_mode_flag value is equal to one further comprises selectively determining whether CurrentPaletteSize is equal to zero, and wherein the decoder is further configured to: perform the selective determination only if a maximum size of a palette table is not equal to a predefined value.

In an example, the predefined value is equal to zero.

In an example, a decoder is provided. The decoder may be configured to determine whether a flag indicating the presence of a palette table predictor initializer is present in a received bitstream; in response to determining that the flag indicating the presence of a palette table predictor initializer is not present in a received bitstream, infer a value of the flag indicating the presence of the palette table predictor initializer to zero.

In an example, the decoder is further configured to: in response to determining that the flag indicating the presence of a palette table predictor initializer is present in a received bitstream, receive the flag indicating the presence of a palette table predictor initializer.

In an example, the decoder is further configured to: recover a palette mode enabled flag from the bitstream; determine whether the flag indicating the presence of a palette table predictor initializer is present in the receive bitstream only if the palette mode enabled flag is equal to one.

In an example, the decoder is further configured to: recover a palette mode enabled flag from the bitstream; determine whether the palette table predictor initializer is present in the receive bitstream only if the palette mode enabled flag is equal to one.

In an example, the decoder is further configured to: recover the maximum allowed palette table predictor size from the bitstream; determine whether the flag indicating the presence of a palette table predictor initializer is present in the receive bitstream only if the maximum allowed palette table predictor size is not equal to zero.

In an example, the decoder is further configured to: recover the maximum allowed palette table predictor size from the bitstream; determine whether the palette table predictor initializer is present in the receive bitstream only if the maximum allowed palette table predictor size is not equal to zero.

In an example, the decoder is further configured to: recover the maximum allowed palette table size from the bitstream; determine whether the flag indicating the presence of a palette table predictor initializer is present in the receive bitstream only if the maximum allowed palette table size is not equal to zero.

In an example, the decoder is further configured to: recover the maximum allowed palette table size from the bitstream; determine whether the palette table predictor initializer is present in the receive bitstream only if the maximum allowed palette table size is not equal to zero.

In an example, a memory device having instructions stored thereon is provided. The instructions may be to, in response to execution by a processing device, cause the processing device to perform operations including: recover a first parameter of coded information and a second parameter of the coded information, wherein the first parameter is to indicate a maximum allowed palette table predictor size, and wherein the second parameter is to indicate the presence of palette table predictor initializer; ascertain a value of the first parameter; in response to an ascertainment that the first parameter is equal to zero, recover a picture of a conforming bitstream if a value of the second parameter is equal to zero; and after a recovery of the picture of the conforming bitstream, perform at least one of store the picture in an electronic memory or cause the recovered picture to be displayed on an electronic display.

In an example, a memory device having instructions stored thereon is provided. The instructions may configured to, in response to execution by a processing device, cause the processing device to perform operations including:determine whether a first parameter is preset: in the bitstream based on whether palette mode is enabled, wherein the first parameter is to indicate whether a palette table predictor initializer is present in the bitstream; recover first data from the bitstream in response to a determination that the first parameter is present in the bitstream; after a recovery of the first data, recover a picture from the bitstream and perform at least one of store the picture in an electronic memory or cause the picture to be displayed on an electronic display; and recover second data from the bitstream in response to a determination that the first parameter is not present in the bitstream, wherein the second data is different than the first data.

In an example, the first data includes a recovered value of said first parameter.

In an example, said portion of the bitstream corresponds to at least one of a parameter set of the bitstream or slice segment header of the bitstream.

In an example, the operations are further operable to: recover a second parameter from the bitstream, wherein the second parameter corresponds to palette_mode_enabled_flag; and ascertain that the palette mode is enabled for recovery of the portion of the bitstream based responsive to a value of the second parameter being equal to one.

The programs which run on the apparatuses according to the present invention may be programs which cause a computer to function by controlling a central processing unit (CPU) to implement embodiments of the present invention. The programs or information handled by such programs may be temporarily stored in a volatile memory such as a random access memory (RAM) or a hard disk drive (HDD) or a non-volatile memory such as a flash memory, or other memory storage system.

Programs for implementing the functions of the invention may be recorded on a computer-readable recording medium. The functions may be implemented by causing a computer system to read the programs recorded on the recording medium and execute the programs. The “computer system” may be a computer system embedded in the apparatus, and may include an operating system or hardware such as peripheral devices. The “computer-readable recording medium” may be a semiconductor recording medium, an optical recording medium, a magnetic recording medium, a recording medium that dynamically stores the program for a short period of time, and any other recording medium which is computer-readable.

The features or functional blocks of the apparatuses used in the aforementioned embodiments may be implemented or executed in circuitry, for example, an integrated circuit or a plurality of integrated circuits. The circuitry designed to perform the functions stated in the present specification may include a general-purpose processor, a digital signal processor (DSP), an application-specific integrated circuit (ASIC), a field programmable gate array (FPGA), or other programmable logic device, discrete gate or transistor logic, discrete hardware components, or any combination thereof. The general-purpose processor may be a microprocessor, or may be any conventional processor, controller, microcontroller, or state machine. The above-described circuitry may be a digital circuit, or may be an analog circuit. In a case where an advanced semiconductor technology introduces a new integrated circuit technology for replacing the current integrated circuit, the invention may be implemented using such new integrated circuit technology.

What is claimed is:

1. A memory device having instructions stored thereon that, in response to execution by a processing device, cause the processing device to perform operations to:
ascertain, using information recovered from a bitstream, a first parameter, the first parameter to indicate CurrentPaletteSize;
ascertain whether a value of the first parameter is equal to zero;
in response to an ascertainment that the value of the first parameter is not equal to zero, recover first data from the bitstream, wherein the first data includes a value of a second parameter, the second parameter to indicate whether a palette coded block of signals to be recovered includes at least one escape coded sample value;
after a recovery of the first data, recover a picture from the bitstream and perform at least one of store the picture in an electronic memory or cause the picture to be displayed on an electronic display; and
in response to an ascertainment that the value of the first parameter is equal to zero, recover from the bitstream second data using a predetermined value for the second parameter;
wherein the second data different than the first data.

2. The memory device of claim 1, wherein the predetermined value is equal to one.

3. The memory device of claim 2, wherein the operations are further to:
recover the second data from the bitstream in escape mode.

4. The memory device of claim 2, wherein the second data includes a pixel value.

5. The memory device of claim 2, wherein the second data includes sample information.

6. The memory device of claim 1, wherein the second data includes pixel information.

7. The memory device of claim 2, wherein the first data includes a palette_escape_value_present_flag.

8. A memory device having instructions stored thereon that, in response to execution by a processing device, cause the processing device to perform operations comprising:
ascertain, using information recovered from a bitstream, whether picture data of the bitstream corresponds to a monochrome chroma format or a non-monochrome chroma format;
determine a quantity corresponding to a palette entry of the bitstream based on a result of the ascertainment; and
recover values of palette predictor initializers from the bitstream based on a result of the determination; and
after recovery of the values of the palette predictor initializers, recover a picture from the bitstream and perform at least one of store the picture in an electronic memory or cause the picture to be displayed on an electronic display.

9. The memory device of claim 8, wherein the operations are further operable to determine a value of one for said quantity in response to ascertainment that the picture data of the bitstream corresponds to the monochrome chroma format.

10. The memory device of claim 9, wherein the operations are further operable to determine a value of three for said quantity in response to an ascertainment that the picture data of the bitstream corresponds to the non-monochrome chroma format.

11. A memory device having instructions stored thereon that, in response to execution by a processing device, cause the processing device to perform operations comprising:
ascertain, using information recovered from a bitstream, whether a parameter is present n a bitstream, wherein the parameter is to indicate whether a palette table predictor initializer is present in coded information;
in response to an ascertainment that the parameter is present in the bitstream, recover first information from the bitstream;
after recovery of the first information, recover a picture of the bitstream and perform at least one of store the picture in an electronic memory or cause the picture to be displayed on an electronic display; and
in response to an ascertainment that the parameter is not present in the bitstream, recover second information from the bitstream, wherein the second information is different than the first information.

12. The memory device of claim 11, wherein the first information includes a recovered value of the parameter.

13. The memory device of claim 12, wherein the operations are further to recover the second information using a predetermined value for the parameter.

14. The memory device of claim 12, wherein the operations are further to:
recover sample information for an entire parameter set using the predetermined value for the parameter in response to the ascertainment that the parameter is not present in the bitstream.

15. The memory device of claim 14, wherein the parameter set includes at least one of a picture parameter set (PPS) or a sequence parameter set (SPS).
